(19) United States
(12) Patent Application Publication
(10) Pub. No.: US 2013/0265529 A1
(43) Pub. Date: Oct. 10, 2013

(54) OPTICAL FILM, POLARIZING PLATE AND IMAGE DISPLAY DEVICE USING THE SAME

(71) Applicant: FUJIFILM CORPORATION, Tokyo (JP)

(72) Inventors: Daiki WAKIZAKA, Minami-Ashigara-shi (JP); Kenichi FUKUDA, Minami-Ashigara-shi (JP); Tomohiko YAMAGUCHI, Minami-Ashigara-shi (JP)

(73) Assignee: FUJIFILM CORPORATION, Tokyo (JP)

(21) Appl. No.: 13/857,796

(22) Filed: Apr. 5, 2013

(30) Foreign Application Priority Data
Apr. 6, 2012 (JP) 2012-087816
Mar. 29, 2013 (JP) 2013-073193

(51) Int. Cl. G02B 5/30; G02B 1/10; G02F 1/1335

(52) U.S. Cl. CPC G02B 5/30; G02F 1/133528; G02B 1/105
USPC 349/96; 359/483.01; 428/142; 428/1.32

(57) ABSTRACT

There is provided an optical film including: a transparent support; an optically anisotropic layer on the outermost surface at one side of the transparent support; a hardcoat layer; and a low refractive index layer, wherein the hardcoat layer and the low refractive index layer are provided at the other side of the transparent support, the transparent support, the hardcoat layer, and the low refractive index layer contains an organic fine particles A having a specific particle size, an organic fine particles B having a specific particle size, and a binder such that a refractive index of 1.20 to 1.40 and average film thickness of 50 to 120 nm, a content of the inorganic fine particles B is appropriately controlled, and arithmetic mean roughness Ra of the optical film surface at a side having the low refractive index layer is a specific value.

### CROSS-REFERENCE TO RELATED APPLICATION(S)

The present application claims priority from Japanese Patent Application Nos. 2012-087816 filed on Apr. 6, 2012, and 2013-073193 filed on Mar. 29, 2013, the entire contents of which are incorporated herein by reference.

### BACKGROUND

1. Field

The present invention relates to an optical film having an optically anisotropic layer on one surface of a transparent support, and a hardcoat layer and a low refractive index layer on the other surface, and a polarizing plate and an image display device having the optical film Specifically, the present invention relates to an optical film suitably used as a surface film for liquid crystal devices, a polarizing plate including the optical film as a protective film, and a liquid crystal display device in which the optical film is arranged on the surface such that the hardcoat layer is positioned on the viewing side and the optically anisotropic layer is positioned on the polarizing plate side.

2. Description of the Related Art

A liquid crystal display device (LCD) is widely used because it is thin and light, and has low power consumption. The liquid crystal display device includes a liquid crystal cell and a polarizing plate. The polarizing plate is generally composed of a protective film and a polarizing film, and obtained by dyeing the polarizing film made of a polyvinyl alcohol film with iodine, stretching the film and laminating protective films on both sides. In a transparent liquid crystal display device, generally, the polarizing plate is attached on both sides of the liquid crystal cell, and furthermore, one or more sheets of optically-compensatory films (phase difference films) are disposed between two polarizing plates (liquid crystal cell side). Further, the optically-compensatory film may be used as the protective film in some cases. For example, an optically-compensatory film having an optically anisotropic layer in which a discotic compound is fixed while maintaining the alignment state is widely used.

Recently, for a highly functionalized liquid crystal display device, a stereoscopic image display device has been being developed, using a transparent liquid crystal display device. For example, Japanese Patent Application Laid-Open No. 2010-243705 discloses a time-division binocular stereoscopic transmission type liquid crystal display device in which a phase difference film (λ/4 plate) having an in-plane retardation of λ/4 is disposed outside a viewing side polarizing plate such that the angle formed by a slow axis of λ/4 plate and an absorption axis of the viewing side polarizing plate is at 45° based on a transmission type liquid crystal display device in which a liquid crystal cell is disposed inside two polarizing plates, thereby causing an emitted light to be circularly polarized, as a stereoscopically displaying method.

The phase difference film having an in-plane retardation of 214 includes a phase difference film using a stretched film and a phase difference film having an optically anisotropic layer formed on a transparent support by a curable liquid crystalline compound.

Among them, since the stretched film is generally fabricated by stretching in a longitudinal direction or in a width direction, the slow axis is parallel or orthogonal to the longitudinal direction.

In fabrication of a polarizing plate, when bonding a phase difference film and a polarizer, it is preferred that the phase difference film and the polarizer are bonded by roll-to-roll from the viewpoint of production efficiency.

Meanwhile, in a liquid crystal display device, a stretched film of polyvinyl alcohol is generally used as a polarizing film, and an absorption axis of a polarized light is parallel to the longitudinal direction.

Accordingly, in order to bond a phase difference film having a slow axis at 45° with respect to the polarization axis and a polarizer by roll-to-roll, a roll film of the phase difference film having a slow axis at 45° with respect to the polarization axis is required. Accordingly, the stretched film is not suitable for bonding by roll-to-roll.

In contrast, a phase difference film having an optically anisotropic layer formed by a curable liquid crystalline compound has a slow axis whose direction can be changed freely by controlling the alignment direction of the liquid crystalline compound by a method such as rubbing, and thus, is suitable for bonding by roll-to-roll.

Japanese Patent Application Laid-Open No. 2007-155970 discloses that an elliptically polarizing plate may be fabricated by fabricating a XJ4 plate in a shape of a roll film having a slow axis at 45° with respect to the longitudinal direction in which a polymerizable rod-like liquid crystalline compound is aligned using a triacetylcellulose film as a transparent support, and bonding the plate with a polarizer by roll-to-roll. The elliptically polarizing plate thus fabricated has a configuration of an optically anisotropic layer/alignment film/transparent support/polarizer/protective film. The liquid crystal cell is disposed on the optically aniotropic layer side, and the protective film is disposed on the viewing side of the display device.

Although not described in Japanese Patent Application Laid-Open No. 2007-155970, it would be understood that in the protective film which is disposed on the surface of the display device, a hardcoat film is usually used as a protective film for the purpose of imparting a function of scratch resistance.

Meanwhile, in the case of using the elliptically polarizing plate having the configuration as described in Japanese Patent Application Laid-Open No. 2007-155970 as a λ/4 plate in the time-division binocular stereoscopic transmission type liquid crystal display device of Japanese Patent Application Laid-Open No. 2010-243705, since the optically anisotropic layer is disposed on the viewing side of the display device, it is considered that a hardcoat film is preferably used on the outermost surface in order to impart a scratch resistance. When forming a hardcoat film (usually formed by disposing a hardcoat layer on a transparent support) on the surface of the optically anisotropic layer, a problem occurs that the member (polarizing plate) of the surface becomes thick due to the configuration of a hardcoat layer/transparent support/adhesive layer/optically anisotropic layer/alignment film/transparent support/polarizer/protective film.

In order to solve the problems, the present inventors have reviewed thinning of a surface member by using a common substrate for a hardcoat layer and an optically anisotropic layer, and have considered that the hardcoat layer may be disposed on one surface of a transparent support, and the optically anisotropic layer may be disposed on the other surface, thereby capable of omitting one of the transparent supports. That is, the present inventors have found out that the polarizing plate is able to be thin by having a configuration of a hardcoat layer/transparent layer/(alignment film/) optically anisotropic layer/polarizer/protective film.

However, among the above-mentioned configurations, in a configuration where a hardcoat layer having a smooth surface is installed, it is recognized that if the polarizing plate is stored in a long roll shape, the hardcoat surface and the optically anisotropic layer are attached.

An anti-glare film having an uneven surface in order to suppress a glare of an image and an antireflection film having a low refractive index layer installed on a hardcoat having a smooth surface are the current mainstream. In the above-mentioned configuration, an adhesion problem occurs only in the antireflection film having a smooth surface. The antireflection film having a smooth surface has a good denseness of black and is firmly popular, compared with the anti-glare film having an uneven surface. Accordingly, in the above-mentioned configuration, a technique is required to solve the adhesion problem.

### SUMMARY

To summarize, an object of the present invention is to provide an optical film capable of providing a polarizing plate which is able to impart phase difference and surface scratch resistance, satisfies a demand for thinning, and has an excellent denseness of black, in which the optical film has no adhesion problem even when wound in a long roll shape. Further, another object of the present invention is to provide a polarizing plate and a liquid crystal display device using the optical film having the above-mentioned characteristics.

First, the present inventors have reviewed thinning of a surface member by using a common substrate for a hardcoat layer and an optically anisotropic layer as described above, and then, have considered that the hardcoat layer may be disposed directly on the optically anisotropic layer, thereby capable of omitting a transparent support and an adhesive layer. That is, the present inventors have found out that the polarizing plate is able to be thin by having a configuration of a low refractive index layer/hardcoat layer/optically anisotropic layer/alignment film/transparent support/polarizer/protective film.

In the above-mentioned configuration, in order to improve the denseness of black while suppressing the glare, the low refractive index layer was formed directly or through another layer on the hardcoat layer.

Further, in this configuration, it has been found out that, by containing fine particles having a specific size in the low refractive index layer, the adhesion problem can be solved even when wound in a long roll shape while maintaining excellent properties such as phase difference, surface scratch resistance, glare of image and denseness of black, thereby completing the invention.

The object of the present invention is achieved by the following means.

(1) An optical film including: a transparent support; an optically anisotropic layer formed from a curable resin composition on the outermost surface at one side of the transparent support; a hardcoat layer; and a low refractive index layer, wherein the hardcoat layer and the low refractive index layer are provided at the other side of the transparent support, the transparent support, the hardcoat layer, and the low refractive index layer are positioned in this order, the low refractive index layer has a refractive index of 1.20 to 1.40 and average film thickness of 50 nm to 120 nm, the low refractive index layer contains an organic fine particles A having an average particle size of 30 nm to 65 nm, an organic fine particles B having an average particle size of more than 65 nm and 130 nm or less and a binder, a content of the inorganic fine particles B is 1.5% by mass to 15% by mass based on the total solid of the low refractive index layer, and arithmetic mean roughness Ra of the optical film surface at a side having the low refractive index layer is 0.030 μm or less as measured in accordance with JIS B0601-2001.

(2) The optical film according to (1), wherein the content of the inorganic fine particles B is 3.0% by mass to 10% by mass based on the total solid of the low refractive index layer.

(3) The optical film according to (1), wherein an average particle size of the inorganic fine particles B is 70 nm to 100 nm.

(4) The optical film according to (1), wherein the inorganic fine particles B are silica particles.

(5) The optical film according to (1), wherein the inorganic fine particles A are hollow silica particles.

(6) The optical film according to (1), wherein an average particle size of the inorganic fine particles A is 40 nm to 60 nm.

(7) The optical film according to (1), wherein the arithmetic mean surface roughness Ra of the optical film surface at the side having the low refractive index layer is 2 nm to 6 nm as measured by an atomic force microscope.

(8) The optical film according to (1), wherein the arithmetic mean roughness Ra of the optical film surface at the side having the low refractive index layer is 2.5 nm to 4 nm as measured by an atomic force microscope.

(9) The optical film according to (1), wherein at least one kind of the binder contained in the low refractive index layer is a fluorine containing polyfunctional monomer represented by the following Formula (I):

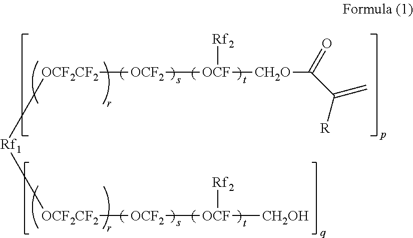

wherein Rf₁ represents a (p+q)-valent perfluoro saturated hydrocarbon group which may have an ether bond, Rf₂ represents a chained or cyclic monovalent fluorohydrocarbon group which at least contains a carbon atom and a fluorine atom, and may contain an oxygen atom or a hydrogen atom, p represents an integer of 3 to 10, q represents an integer of 0 to 7, and (p+q) represents an integer of 3 to 10, r represents an integer of 0 to 100, and each of s and t represents 0 or 1, R represents a hydrogen atom, a methyl group or a fluorine atom, and an arrangement order of (OCF₂CF₂), (OCF₂), and (OCFRf₂) is not particularly limited.

(10) The optical film according to (1), wherein an in-plain retardation of the optical film at 550 nm is 80 nm to 200 nm.

(11) The optical film according to (1), wherein the optically anisotropic layer is formed from a composition containing a liquid crystalline compound.

(12) The optical film according to (11), wherein the liquid crystalline compound is a discotic liquid crystalline compound.

(13) The optical film according to (11), wherein a solid content of the liquid crystalline compound in the composition is 93% by mass or more.

(14) The optical film according to (1), wherein the optical film is in a shape of a long roll, and a slow axis of an in-plane retardation is inclined clockwise or anti-clockwise at 5° to 85° with respect to a longitudinal direction of the optical film.

(15) A polarizing plate including: at least one protective film; and a polarizing film, wherein the at least one protective film is the optical film according to (1), and a surface of the optical film at a side having the optically anisotropic layer and the polarizing film are bonded.

(16) An image display device including at least one of the optical film according to (1).

(17) An image display device including the polarizing plate according to (15).

(18) A liquid crystal display device including; the optical film according to (1); a polarizing film; and a liquid crystal cell in this order from a viewing side, wherein the optical film is disposed such that the low refractive index layer is at the viewing side and the optically anisotropic layer is at the polarizing film side.

According to the present invention, it is possible to provide an optical film suitable for thinning of a polarizing plate or an image display device mounted with the polarizing plate, in which no problem occurs when wound in a roll shape, the productivity is high, the surface hardness is high, there is no glare of an image, the denseness of black is excellent, and the image quality of the mounting image display device mounted is excellent (the optical compensation is excellent, and no crosstalk occurs).

Further, the optical film of the present invention is suitable for a stereoscopic image display device based on a transmission type liquid crystal display device.

### DETAILED DESCRIPTION OF INVENTION

In the present specification, when the numerical values represent values of physical properties and characteristics, the description “(numerical value 1) to (numerical value 2)” refers to “(numerical value 1) or more and (numerical value 2) or less”. The description “(meth)acrylate” refers to “at least one of acrylate and methacrylate.” The same also applies for “(meth)acrylic acid”.

The optical film of the present invention is an optical film including: a transparent support; an optically anisotropic layer formed from a curable resin composition on the outermost surface at one side of the transparent support; a hardcoat layer; and a low refractive index layer, wherein the hardcoat layer and the low refractive index layer are provided at the other side of the transparent support, the transparent support, the hardcoat layer, and the low refractive index layer are positioned in this other, the low refractive index layer has a refractive index of 1.20 to 1.40 and average film thickness of 50 nm to 120 nm, the low refractive index layer contains an organic fine particles A having an average particle size of 30 nm to 65 nm, an organic fine particles B having an average particle size of more than 65 nm and 130 nm or less and a binder, a content of the inorganic fine particles B is 1.5% by mass to 15% by mass based on the total solid of the low refractive index layer, and arithmetic mean roughness Ra of the optical film surface at a side having the low refractive index layer is 0.030 or less as measured in accordance with JIS B0601-2001.

(Layers Laminatable on Transparent Support and Layer Configuration)

The optical film of the present invention may be provided with any necessary functional layers other than the hardcoat layer and the low refractive index layer to the surface on which the hardcoat layer and the low refractive index layer are laminated, with respect to the transparent support, depending on the purpose. For example, an antireflection layer (a layer for adjusting refractive index such as a medium refractive index layer and a high refractive index layer), an antistatic layer, an ultraviolet ray absorbing layer, antifouling layer and the like may be provided.

The optically anisotropic layer of the optical film of the present invention is an optically anisotropic layer formed of a curable resin composition. The optically anisotropic layer preferably contains a liquid crystalline compound. When containing a liquid crystalline compound, it is preferred that the layer adjacent to the optically anisotropic layer is an alignment film to align the liquid crystalline compound.

More preferred particular examples of the layer configuration of the optical film of the present invention will be described below, but not limited thereto as long as they do not depart from the spirit of the present invention.

The optically anisotropic layer according to the present invention may be an optically anisotropic layer in which a film having a certain phase difference is in-plane formed or an optically anisotropic layer having a pattern in which phase difference regions having different directions of slow axis or different amounts of phase difference from each other is in-plane formed regularly.

Optically anisotropic layer/(alignment film/)transparent support/hardcoat layer/low refractive index layer
Optically anisotropic layer/(alignment film/)transparent support/conductive layer/hardcoat layer/low refractive index layer
Optically anisotropic layer/(alignment film/) transparent support/hardcoat layer/conductive layer/low refractive index layer

Optically anisotropic layer/(alignment film/) transparent support/hardcoat layer/high refractive index layer/low refractive index layer

Optically anisotropic layer/(alignment film/) transparent support/conductive layer/hardcoat layer/high refractive index layer/low refractive index layer
Optically anisotropic layer/(alignment film/) transparent support/conductive layer/hardcoat layer/high refractive index layer/low refractive index layer
Optically anisotropic layer/(alignment film/) transparent support/hardcoat layer/conductive layer/high refractive index layer/low refractive index layer
Optically anisotropic layer/(alignment film/)/transparent support/hardcoat layer/high refractive index layer/conductive layer/low refractive index layer
Optically anisotropic layer/(alignment film/) transparent support/hardcoat layer/medium refractive layer/high refractive index layer/low refractive index layer
Optically anisotropic layer/(alignment film/) transparent support/conductive layer/hardcoat layer/medium refractive layer/high refractive index layer/low refractive index layer
Optically anisotropic layer/(alignment film/) transparent support/hardcoat layer/conductive layer/medium refractive layer/high refractive index layer/low refractive index layer
Optically anisotropic layer/(alignment film/) transparent support/hardcoat layer/medium refractive layer/conductive layer/high refractive index layer/low refractive index layer
Optically anisotropic layer/(alignment film/) transparent support/hardcoat layer/medium refractive layer/high refractive index layer/conductive layer/low refractive index layer

With respect to the materials used in each functional layer and detail of the layer configuration on the one side of the transparent support, those described in Paragraph Nos. [0018] to [0167], [0170] to [0183] and [0187] to [0243] of JP-A-2010-152311 can be used, but the invention should not be construed as being limited thereto.

Now, the respective layers of the optical film according to the invention are described below.

### <Transparent Support>

A transparent support is used in the optical film according to the invention. As the material for forming the transparent support according to the invention, a thermoplastic norbornene resin can be preferably used. As the thermoplastic norbornene resin, for example, Zeonex and ZeonoR produced by Zeon Corp. and ARTON produced by JSR Corp. are exemplified.

Also, as the material for forming the transparent support according to the invention, a cellulose polymer (hereinafter referred to as a cellulose acylate) which has been conventionally used as a transparent protective film of a polarizing plate and is typified by triacetyl cellulose is preferably used. As an example of the transparent support according to the invention, the cellulose acylate is mainly described in detail below, but it is apparent that the technical matter can also be applied to other polymer films.

In the optical film according to the invention, a cellulose acylate is preferably used. This is because that it can respond to every liquid crystal display mode by using a material capable of controlling optical anisotropy and an additive in case of using it in a liquid crystal display device.

As for the transparent support according to the invention, the thickness is preferably from 20 to 80 μm, and more preferably from 30 to 70 μm. In the case where the optical film according to the invention is wound in a roll form, when the thickness of the transparent support is too large, stress in a radius direction near the roll core becomes large to cause a so-called blocking phenomenon so that the optical film is liable to deform due to adherence.

<Haze of Optical Film>

The haze of optical film according to the invention is preferably less than 1%, more preferably less than 0.7%, and most preferably less than 0.5%. By controlling the haze to the range described above, optical scattering can be suppressed so that the decrease in contrast can be prevented in case of using the optical film according to the invention in a liquid crystal display device.

<Low Refractive Index Layer>

The refractive index of the low refractive index layer of the present invention is 1.20 to 1.45, more preferably 1.25 to 1.43, and still more preferably 1.30 to 1.40. By controlling the refractive index within this range, the anti-glare and the scratch resistance may be compatible with each other.

<Uneveness of Low Refractive Index Layer>

The arithmetic mean roughness Ra of the film surface at the side having the low refractive index of the present invention is 0.030 μm or less in accordance to JIS B0601-2001. If more than 0.030 μm, it is difficult to obtain a good denseness of black. Further, Ra is preferably 0.001 μm to 0.025 μm, and more preferably 0.002 μm to 0.020 μm. By controlling the roughness within this range, the denseness of black may be secured.

Further, from the viewpoint of reducing adhesion vestiges while suppressing white turbidity of coating films, the arithmetic mean surface roughness Ra of the film surface at the side having the low refractive index layer is preferably 2 nm to 6 nm, more preferably 2.5 nm to 5 nm, and most preferably 2.5 nm to 4 nm as measured by an AFM.

Here, the arithmetic mean surface roughness Ra may be calculated as an average of each value determined from an image obtained by measuring five fields-of-view having 10 μm square in a measurement point of 256×256 with an atomic force microscope (AFM: SPI 3800N manufactured by Seiko Instruments Inc.)

<Particles of Low Refractive Index Layer>

The optical film of the present invention contains plural kinds of inorganic fine particles having different average particle sizes in the low refractive index layer.

Hereinafter, detailed description will be made with respect to functions of the plural kinds of inorganic fine particles having different average particle sizes used in the present invention.

<Inorganic Fine Particles A>

In the present invention, the average particle size of the inorganic fine particles A contained in the low refractive index layer is 30 nm 65 nm, and more preferably 40 nm to 60 nm. The particles having an average particle size of 30 nm to 65 nm may be used mainly for the purpose of controlling the refractive index of the low refractive index layer. Therefore, it is preferred that the particles themselves have a low refractive index.

In the present invention, the average particle size may be determined by observing randomly selected particles with an electron microscope. In the present invention, the average particle size is defined as a particle size whose particle number becomes a peak when randomly selecting 400 particles contained in the low refractive index layer, and determining the particle size distribution of the particles (distribution of the number of particles to particle sizes).

When a plurality of peaks is present in the particle size distribution obtained by selecting 400 particles, it is considered that plural kinds of particles having different average particle sizes are contained. At this time, the plurality of peaks corresponds to each average particle size possessed by the plural kinds of particles.

Particles having different shape, material and the like (for example, particles in an indeterminate form, which is not spherical) are regarded as separate particles even though the particles have the same average particle size. In the case of the particles in an indeterminate form, which is not spherical, the particle size is expressed using a diameter corresponding to a sphere.

In addition, among particles obtained by the same preparation and synthesis, particles regarded as those having a peak of specifically large particle size, which is so-called coarse particles, are not accordant to the spirit of the present invention, and thus, they are not included in the particles of the present invention.

Particular examples of particles having a low refractive index include silica, magnesium fluoride and the like. Silica particles are preferred.

As silica particles, there may be used commercially available products such as Aerosil R972, R972V, R974, R812, 200, 200V, 300, R202, OX50 and TT600 (all manufactured by NIPPON AEROSIL Co., Ltd.), SNOWTEX (Nissan Chemical Industries, Ltd.), sicastar (Corefront Corporation) and Sluria (JGC C&C).

(Porous or Hollow Fine Particles)

In order to promote lowering the refractive index, it is preferred to use porous or hollow fine particles in at least one kind of inorganic fine particles contained in the low refractive index layer. It is particularly preferred that the inorganic fine particles A are porous or hollow fine particles. The porosity of these particles is preferably 10% to 80%, more preferably 20% to 60%, and most preferably 30% to 60%. It is preferred to set the porosity of the hollow fine particles within the above-mentioned range from the viewpoint of lowering the refractive index and maintaining the durability of the particles.

In the case where the porous or hollow particles are silica, the refractive index of the fine particles is preferably 1.10 to 1.40, more preferably 1.15 to 1.35, and most preferably 1.15 to 1.30. The refractive index as used herein refers to a refractive index of the whole particles but not a refractive index of only the sheath of silica forming silica particles.

The method for preparing porous or hollow silica is described in, for example, Japanese Patent Application Laid-Open No. 2001-233611 or Japanese Patent Application Laid-Open No. 2002-79616. In particular, particles having a cavity inside the cell are particularly preferably particles in which the pore of the cell is occluded. Meanwhile, the refractive index of the hollow silica particles may be calculated by the method described in Japanese Patent Application Laid-Open No. 2002-79616.

The content of the inorganic fine particles A contained in the low refractive index layer is preferably 20% by mass to 60% by mass, more preferably 25% by mass to 50% by mass, and most preferably 30% by mass to 45% by mass. If the content is excessively low, the effect of thinning the refractive index or improving the scratch resistance is reduced. If the content is excessively high, the amount of the binder that holds particles is decreased, and thus, the strength of the coating film is remarkably lowered, or a minute unevenness is formed on the surface of the low refractive index layer, thereby deteriorating appearance such as denseness of black or the integral reflectance.

In the present invention, the particles of the low refractive index layer may have a particle size distribution, and the coefficient of variation is preferably 60% to 5%, and more preferably 50% to 10%.

If the particle size of the inorganic fine particles A is excessively small, the ratio of voids is reduced, and thus, reduction in refractive index cannot be expected. If the particle size is excessively large, a minute unevenness is formed on the surface of the low refractive index layer, thereby deteriorating appearance such as denseness of black or the integral reflectance. The silica fine particles may be either crystalline or amorphous. Further, monodispersed particles are preferred. Although a spherical form is most preferred, the shape may be an indeterminate form.

In the present invention, the specific surface area of the hollow silica is preferably 20 m²/g to 300 m²/g, more preferably 30 m²/g to 120 m²/g, and most preferably 40 m²/g to 90 m²/g. The surface area may be determined by a BET method using nitrogen.

<Inorganic Fine Particles B>

Next, description will be made with respect to the inorganic fine particles B having an average particle size of 65 nm to 130 nm, used in the present invention.

The inorganic fine particles B as used in the present invention refers to inorganic fine particles having an average particle size of 65 nm to 130 nm contained in the low refractive index layer.

The low refractive index of the present invention contains the inorganic fine particles B in an amount of 1.5% by mass to 15% by mass, preferably 3.0% by mass to 10% by mass, and still more preferably 5.0% by mass to 10.0% by mass based on the total solid. The inorganic fine particles B have a function to form an unevenness on the low refractive index layer.

If the inorganic fine particles B are excessively little, it is not preferred in that the density of the unevenness is low, and thus, adhesion is caused by even portions other than the unevenness. If the inorganic fine particles B are excessively much, it is not preferred in that the surface looks white turbid. It is required to tightly dispose the inorganic fine particles A used for the purpose of controlling the refractive index, and further, to set the content of the inorganic fine particles B within a proper range.

In the present invention, the average particle size of the inorganic fine particles B is more preferably 65 nm to 110 nm, and particularly preferably 70 nm to 100 nm. By setting the average particle size, light scattering by large particles may be suppressed, thereby suppressing haze or white turbidity of the coating film.

Particular examples of the inorganic fine particles B include silica, magnesium fluoride and the like. Silica particles are preferred.

As silica particles, there may be used commercially available products such as Aerosil R972, R972V, R974, R812, 200, 200V, 300, R202, OX50 and TT600 (all manufactured by NIPPON AEROSIL Co., Ltd.), SNOWTEX (Nissan Chemical Industries, Ltd.), sicastar (Corefront Corporation) and Sluria (JGC C&C). Among them, SNOWTEX IPA-ST-ZL and MEK-ST-ZL are preferred.

(Surface Treatment Method of Inorganic Fine Particles)

In order to improve the dispersity in a coating composition for forming the low refractive index layer, it is preferred that at least one kind of inorganic fine particles contained in the low refractive index layer is subjected to surface treatment with a hydrolysate of organosilane and/or a partial condensate thereof. It is more preferred that the surface of the inorganic fine particles A is treated with a hydrolysate of organosilane and/or a partial condensate thereof, and it is more preferred to use either an acid catalyst or a metal chelate compound, or both when treating. Although the structure of organosilane is not particularly limited, organosilane having a (meth)acryloyl group at the end is preferred in that an excellent scratch resistance may be obtained by binding with a binder. As a specific compound, the compound as described in (Organosilane compound) below may be suitably used.

<Thickness of Low Refractive Index Layer>

In the optical film of the present invention, the thickness of the low refractive index layer laminated on one surface of the support is 50 nm to 120 nm, and preferably 70 nm to 110 nm. If the thickness is excessively thin, it is not preferred in that the color tone of the whole optical film is diminished, thereby considerably damaging the purpose of providing a high quality liquid crystal display device.

<Curable Composition>

In the optical film of the present invention, among the plurality of layers laminated on one surface of the transparent support, the low refractive index layer is formed of a curable composition containing the plural kinds of particles having different average particle sizes. The curable composition in the present invention is not particularly limited as long as the object of the present invention is achieved, and any curable compositions may be used.

Hereinafter, the binder in the present invention will be described.

As a binder forming material contained in the low refractive index material, a fluorine-containing copolymer formed by copolymerizing a fluorine-containing vinyl monomer with other copolymerizable component may be preferably used.

Examples of the fluorine-containing vinyl monomer include a fluoroolefin (for example, fluoroethylene, vinylidene fluoride, tetrafluoroethylene or hexafluoropropylene), a partially or fully fluorinated alkyl ester derivative of (meth)acrylic acid (for example, VISCOAT 6FM (trade name, produced by Osaka Organic Chemical Industry Ltd.) or R-2020 (trade name, produced by Daikin Industries, Ltd.), and a completely or partially fluorinated vinyl ether. Among them, a perfluoroolefin is preferred, and in view of refractive index, solubility, transparency, availability and the like, hexafluoropropylene is particularly preferred. When the composition ratio of the fluorine-containing vinyl monomer is increased, the refractive index can be reduced but the film strength decreases. In the invention, the fluorine-containing vinyl monomer is preferably introduced such that the copolymer has a fluorine content from 20 to 60% by weight, more preferably introduced such that the copolymer has a fluorine content from 25 to 55% by weight, and still more preferably introduced such that the copolymer has a fluorine content from 30 to 50% by weight.

As the other copolymerization component for copolymerizing with the fluorine-containing vinyl monomer, for example, monomers represented by (a), (b) and (c) shown below are preferably exemplified in order to impart crosslinking reactivity.

(a): A monomer previously having a self-crosslinkable functional group in its molecule, for example, glycidyl (meth)acrylate or glycidyl vinyl ether.

(b): A monomer having a carboxyl group, a hydroxy group, an amino group, a sulfo group or the like (for example, (meth)acrylic acid, methylol (meth)acrylate, a hydroxyalkyl (meth)acrylate, allyl acrylate, hydroxyethyl vinyl ether, hydroxybutyl vinyl ether, maleic acid or crotonic acid).

(c): A monomer having a group capable of reacting with the functional group of (a) or (b) described above and other crosslinkable functional group in its molecule (for example, a monomer which can be synthesized, for example, by a method of reacting acrylic chloride with a hydroxy group).

In the monomer of (c), the crosslinkable functional group is preferably a photopolymerizable group. Examples of the photopolymerizable group include a (meth)acryloyl group, an alkenyl group, a cinnamoyl group, a cinnamylideneacetyl group, a benzalacetophenone group, a styrylpyridine group, an α-phenylmaleimido group, a phenyl-azido group, a sulfonylazido group, a carbonylazido group, a diazo group, an o-quinonediazido group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group. The photopolymerizable group may be used not only one kind but also two or more kinds thereof. Among them, a (meth)acryloyl group or a cinnamoyl group is preferred, and a (meth)acryloyl group is particularly preferred.

Specific methods for preparing the fluorine-containing copolymer having a photo-polymerizable group include the methods set forth below, but the invention should not be construed as being limited thereto.

a. A method of esterification in which a (meth)acrylic chloride is reacted with a crosslinkable functional group-containing copolymer having a hydroxy group.

b. A method of urethanization in which a (meth)acrylate having an isocyanate group is reacted with a crosslinkable functional group-containing copolymer having a hydroxy group.

c. A method of esterification in which (meth)acrylic acid is reacted with a crosslinkable functional group-containing copolymer having an epoxy group.

d. A method of esterification in which a (meth)acrylate having an epoxy group is reacted with a crosslinkable functional group-containing copolymer having a carboxyl group.

The amount of the photopolymerizable group introduced can be appropriately adjusted and, for example, from the standpoint of stability of the coated surface state, decrease in the surface state failure occurred in case of exiting an inorganic particle together or improvement in the film strength, it is also preferred to leave a certain amount of a carboxyl group, a hydroxy group or the like.

As to the fluorine-containing copolymer useful for the invention, in addition to a repeating unit derived from the fluorine-containing vinyl monomer and a repeating unit having a (meth)acryloyl group in its side chain, other vinyl monomer may be appropriately copolymerized from various viewpoints, for example, adhesion property to a base material, Tg (contributing to film hardness) of polymer, solubility in a solvent, transparency, slipping property, dust preventing property or antifouling property. A plurality of the vinyl monomers may be combined according to the purpose. The amount of the vinyl monomer introduced in total is preferably in a range from 0 to 65% by mole, more preferably in a range from 0 to 40% by mole, particularly preferably in a range from 0 to 30% by mole, based on the copolymer.

The vinyl monomer which can be used in combination is not particularly limited and includes, for example, an olefin (for example, ethylene, propylene, isoprene, vinyl chloride or vinylidene chloride), an acrylate (for example, methyl acrylate, methyl acrylate, ethyl acrylate, 2-ethylhexyl acrylate or 2-hydroxyethyl acrylate), a methacrylate (for example, methyl methacrylate, ethyl methacrylate, butyl methacrylate or 2-hydroxyethyl methacrylate), a styrene derivative (for example, styrene, p-hydroxymethylstyrene or p-methoxystyrene), a vinyl ether (for example, methyl vinyl ether, ethyl vinyl ether, cyclohexyl vinyl ether, hydroxyethyl vinyl ether or hydroxybutyl vinyl ether), a vinyl ester (for example, vinyl acetate, vinyl propionate or vinyl cinnamate), an unsaturated carboxylic acid (for example, acrylic acid, methacrylic acid, crotonic acid, maleic acid or itaconic acid), an acrylamide (for example, N,N-dimethylacrylamide, N-tert-butylacrylamide or N-cyclohexylacrylamide), a meth-acrylamide (for example, N,N-dimethylmethacrylamide) and acrylonitrile.

The fluorine-containing copolymer particularly useful for the invention is a random copolymer of a perfluoroolefin with a vinyl ether or vinyl ester. In particular, the fluorine-containing copolymer preferably has a group capable of undergoing a crosslinking reaction by itself (for instance, a radical reactive group, for example, a (meth)acryloyl group, or a ring-opening polymerizable group, for example, an epoxy group or an oxetanyl group). The crosslinking reactive group-containing polymerization unit preferably accounts for from 5 to 70% by mole, particularly preferably from 30 to 60% by mole based on the total polymerization unit of the copolymer. Preferred examples of the polymer include those described in JP-A-2002-243907, JP-A-2002-372601, JP-A-2003-26732, JP-A-2003-222702, JP-A-2003-294911, JP-A-2003-329804, JP-A-2004-4444 and JP-A-2004-45462.

For the purpose of imparting antifouling property, a polysiloxane structure is preferably introduced into the fluorine-containing copolymer according to the invention. The method for introducing a polysiloxane structure is not limited and preferably includes a method of introducing a polysiloxane block copolymerization component by using a silicone macroazo initiator as described in JP-A-6-93100, JP-A-11-189621, JP-A-11-228631 and JP-A-2000-313709 and a method of introducing a polysiloxane graft copolymerization component by using a silicone macromer as described in JP-A-2-251555 and JP-A-2-308806. Particularly preferred compounds include the polymers described in Examples 1, 2 and 3 of JP-A-11-189621, and Copolymers A-2 and A-3 described in JP-A-2-251555. The content of the polysiloxane component in the fluorine-containing copolymer is preferably from 0.5 to 10% by weight, and particularly preferably from 1 to 5% by weight.

The molecular weight of the fluorine-containing copolymer which can be preferably used in the invention is preferably 5,000 or more, more preferably from 10,000 to 500,000, most preferably from 15,000 to 200,000, in terms of weight average molecular weight. Also, the improvements in coated surface state and scratch resistance may be made by using the fluorine-containing copolymers having different average molecular weights in combination.

(Compound Having a Polymerizable Unsaturated Bond)

As the binder forming material, it is also preferred to use a compound having a polymerizable unsaturated bond. The fluorine-containing copolymer and the compound having a polymerizable unsaturated bond may be used in combination as appropriate as described in Japanese Patent Application Laid-Open No. 1110-25388 and Japanese Patent Application Laid-Open No. 2000-17028. Further, a combination of a fluorine-containing copolymer and a polyfunctional fluorine-containing compound is also preferred, as described in Japanese Patent Application Laid-Open No. 2002-145952. Examples of the compound having a polymerizable unsaturated bond include a compound having a functional group such as a (meth)acryloyl group, a vinyl group, a styryl group and an allyl group. Among them, a (meth)acryloyl group is preferred. Particularly preferably, compounds containing two or more (meth)acryloyl group in one molecule as described below may be used. These compounds are preferred in that they have a great combined effect on scratch resistance or improvement in scratch resistance after chemical treatment, particularly when using a compound having a polymerizable unsaturated group in the main structure of the fluorine-containing copolymer.

As specific examples of the compound having a polymerizable unsaturated bond, a compound as described below in the curable monomer for a composition for forming a hardcoat used in a hardcoat layer may be used in common.

The polyfunctional monomer may be used in combination of two or more kinds thereof.

Polymerization of the monomers having an ethylenically unsaturated group may be performed in irradiation with ionized radiation or by heating in the presence of a photo radical or a thermal radical initiator.

It is preferred to use a photopolymerization initiator in the polymerization reaction of the polymerizable polyfunctional monomers. The photopolymerization initiator is preferably a photo radical polymerization initiator or photo cationic polymerization initiator, and particularly preferably a photo radical polymerization initiator.

(Fluorine-Containing Polyfunctional Monomer)

In the present invention, the curable composition is a fluorine-containing compound having three or more polymerizable groups, and preferably a fluorine-containing polyfunctional monomer in which the fluorine content is 35.0% by mass or more of the molecular weight of the fluorine-containing compound, and when the polymerizable groups are polymerized, the calculated value of the intercrosslink molecular weight is 300 or less.

The fluorine-containing polymerizable monomer is preferably a compound represented by the following Formula (1).

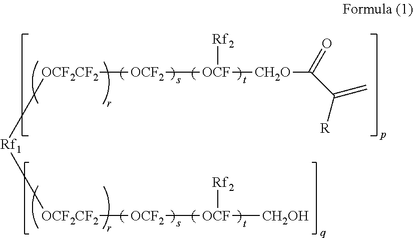

(In the formula, Rf₁ represents a (p+q)-valent perfluoro saturated hydrocarbon group which may have an ether bond. Rf₂ represents a chained or cyclic monovalent fluorohydrocarbon which at least contains a carbon atom and a fluorine atom, and may contain an oxygen atom or a hydrogen atom. p represents an integer of 3 to 10, q represents an integer of 0 to 7, and (p+q) represents an integer of 3 to 10. r represents an integer of 0 to 100, and each of s and t represents 0 or 1. R represents a hydrogen atom, a methyl group or a fluorine atom. An arrangement order of (OCF₂CF₂), (OCF₂), and (OCFRf₂) is not particularly limited)

Formula (1) will be described.

Rf₁ represents a (p+q)-valent perfluoro saturated hydrocarbon group which may have an ether bond (referred to as a fluorine-containing core). A representative fluorine-containing core may be exemplified by the following specific examples, but the present invention is not limited thereto.

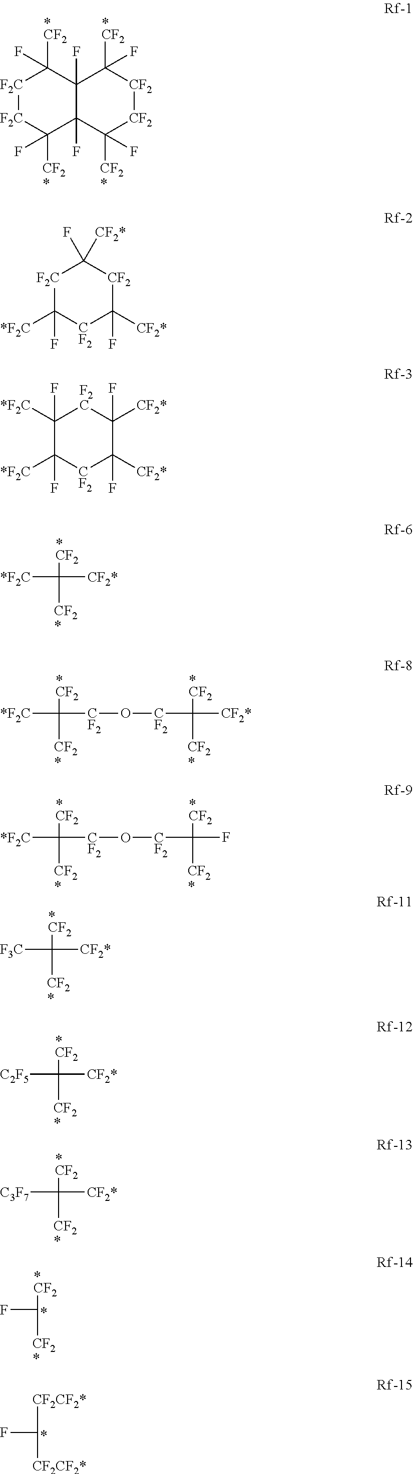

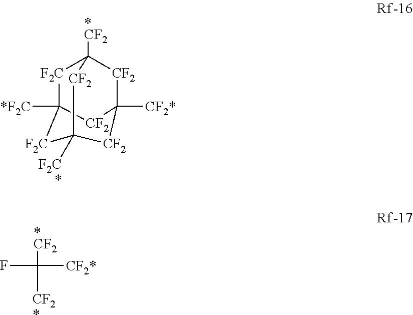

Among the specific examples, Rf-6, 8 to 15 and 17 are preferred. In the specific examples, * represents a position linked to a reactive functional group or a hydroxyl group. However, there may be a divalent linking group between the reactive functional group or the hydroxyl group and the fluorine-containing core.

The divalent linking group represents an alkylene group having 1 to 10 carbon atoms, an arylene group having 6 to 10 carbon atoms, —O—, —S—, —N(Ra)-, a group obtained by combining an alkylene group having 1 to 10 carbon atoms and —O—, —S— or —N(Ra)-, or a group obtained by combining an arylene group having 6 to 10 carbon atoms and —O—, —S— or —N(Ra)-. Ra represents a hydrogen atom or an alkyl group having 1 to 5 carbon atoms. In the case where the divalent linking group represents an alkylene group or an arylene group, the alkylene group and the arylene group which are represented by the divalent linking group are preferably substituted with a halogene atom, preferably a fluorine atom.

Rf₂ represents a chained or cyclic monovalent fluorohydrocarbon which at least contains a carbon atom and a fluorine atom, and may contain an oxygen atom or a hydrogen atom (may contain both of an oxygen atom and a hydrogen atom).

Rf₂ is preferably a chained or branched perfluoroalkyl group having 1 to 12 carbon atoms (for example, trifluoromethyl, perfluoroethyl, perfluoropropyl and the like) or a perfluorocycloalkyl group having 3 to 12 carbon atoms (for example, perfluoropentyl, perfluorocyclohexyl and the like), more preferably the above-mentioned perfluoroalyl group, and most preferably a trifluoromethyl group.

p represents an integer of 3 to 10, preferably 3 to 6, and more preferably 3 to 4.

q represents an integer of 0 to 7, preferably 0 to 3, and more preferably 0 to 1, and still more preferably 0.

(p+q) represents an integer of 3 to 10, preferably 3 to 6, and more preferably 3 to 4.

r represents an integer of 0 to 100, preferably 0 to 20, more preferably 1 to 5, and still more preferably 1. s represents 0 or 1, and more preferably 0. t represents 0 or 1.

R represents a hydrogen atom, a methyl group or a fluorine atom, preferably a hydrogen atom and a methyl group, and more preferably a hydrogen atom.

In Formula (I), the case where r=1 to 5, s=0 or 1, t=0 or 1, p=3 to 6 and q=0 is also a preferred aspect.

As other examples of the fluorine-containing polyfunctional monomer, specifically X-2 to 4, X-6, X-8 to 14 and X21 to 33 described in paragraphs [0023] to [0027] of Japanese Patent Application Laid-Open No. 2006-28409 may be preferably used.

Further, M-1 to M-16 described in paragraphs [0062] to [0065] of Japanese Patent Application Laid-Open No. 2006-284761 may be preferably used as well.

Since the inorganic fine particles B used in the low refractive index layer have a large particle size, undesirably large unevenness is formed on the surface of the coating film when agglomerated, and thus, white turibidy is prone to occur. By combining the fluorine-containing compound, the particles are hardly agglomerated, and thus, it is possible to suppress the white turbidity of the coating film while preventing the adhesion vestige. Furthermore, the low refractive index and the excellent scratch resistance may be compatible.

Among them, X-22 and M-1 are particularly preferred, and M-1 is most preferred from the viewpoint of compatibility of the scratch resistance and the low refractive index.

Moreover, compounds as shown below described in Paragraph Nos. [0135] to [0149] of WO 2005/059601 can also preferably used.

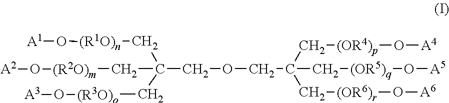

In formula (I), A¹ to A⁶ each independently represents an acryloyl group, a methacryloyl group, an α-fluoroacryloyl group or a trifluoromethacryloyl group, n, m, o, p, q and r each independently represents an integer from 0 to 2, and R¹ to R⁶ each independently represents an alkylene group having from 1 to 3 carbon atoms or a fluoroalkylene group having from 1 to 3 carbon atoms in which one or more hydrogen atoms are substituted with fluorine atoms.

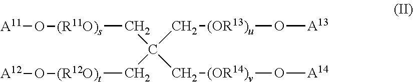

In formula (II), A¹¹ to A¹⁴ each independently represents an acryloyl group, a methacryloyl group, an α-fluoroacryloyl group or a trifluoromethacryloyl group, s, t, u and v each independently represents an integer from 0 to 2, and R¹¹ to R¹⁴ each independently represents an alkylene group having from 1 to 3 carbon atoms or a fluoroalkylene group having from 1 to 3 carbon atoms in which one or more hydrogen atoms are substituted with fluorine atoms.

Moreover, Compounds MA1 to MA20 shown below can also be preferably used.

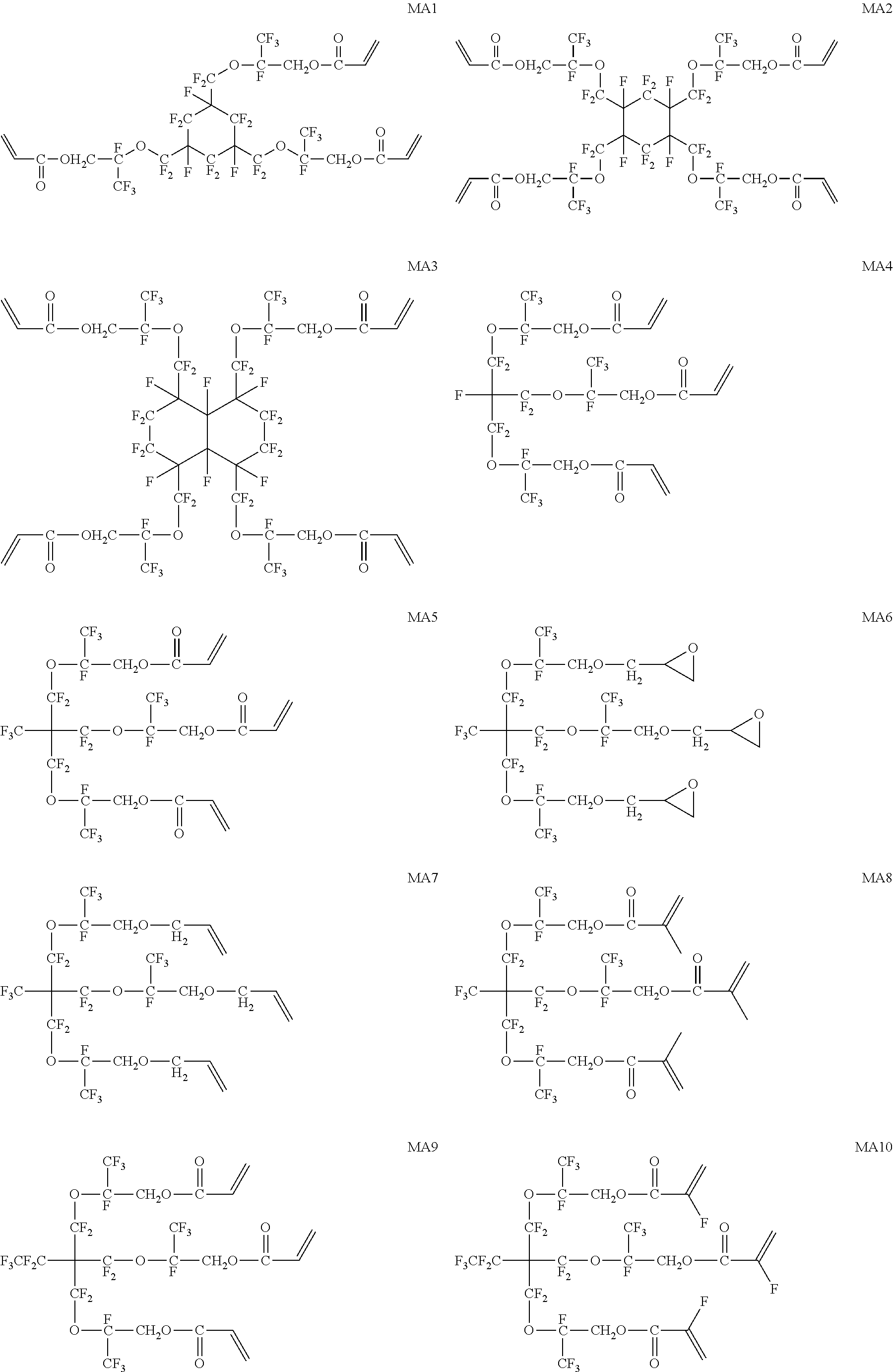

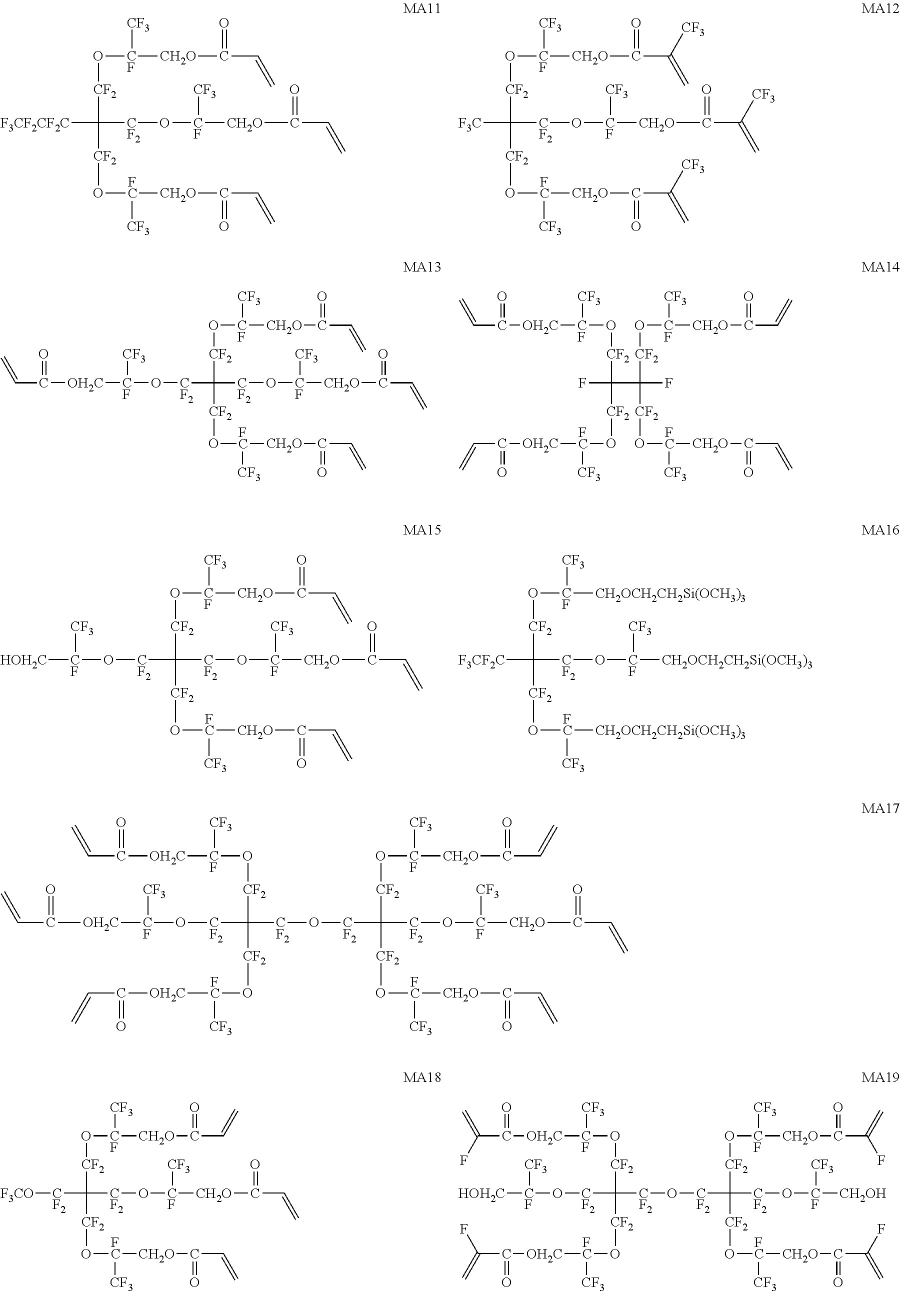

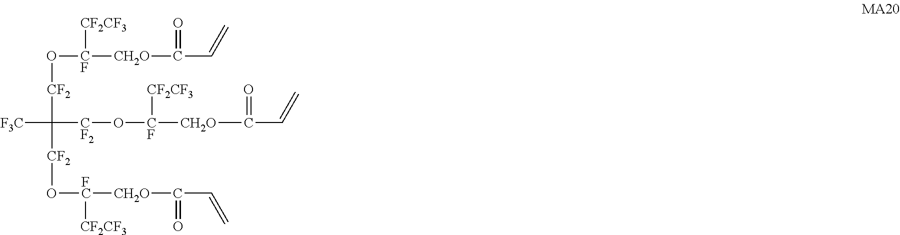

Furthermore, compounds described in Paragraph Nos. [0014] to [0028] of JP-A-2006-291077 can also preferably used.

### (Organosilane Compound)

At least one layer of the layers laminated on the one side of transparent support forming the optical film according to the invention preferably contains, in a coating solution forming the layer, at least one component of a hydrolysate of an organosilane compound and/or a partial condensate of the hydrolysate, a so-called sol component (which may be referred to as such hereinafter) from the standpoint of scratch resistance.

In particular, it is preferred to incorporate the sol component into the low refractive index layer of the optical film according to the invention in order to impart both the antireflection performance and the scratch resistance. The sol component becomes a part of a binder of the layer by coating the coating solution, followed by condensation by drying and heating processes to form a cured product. Further, in the case where the cured product has a polymerizable unsaturated bond, a binder having a three dimensional structure is formed upon irradiation with an active ray.

The organosilane compound is preferably a compound represented by formula 1 shown below.

(R¹)ₘ—Si(X)₄₋ₘ Formula 1

In formula 1, R¹ represents a substituted or unsubstituted alkyl group or a substituted or unsubstituted aryl group. The alkyl group is preferably an alkyl group having from 1 to 30 carbon atoms, more preferably an alkyl group having from 1 to 16 carbon atoms, and particularly preferably an alkyl group having from 1 to 6 carbon atoms. Specific examples of the alkyl group include a methyl group, an ethyl group, a propyl group, an isopropyl group, a hexyl group, a decyl group and a hexadecyl group. The aryl group includes, for example, a phenyl group and a naphthyl group, and preferably a phenyl group.

X represents a hydroxy group or a hydrolyzable group, for example, an alkoxy group (preferably an alkoxy group having from 1 to 5 carbon atoms including, for example, a methoxy group and an ethoxy group), a halogen atom (for example, Cl, Br or I), and a group represented by R²COO (where R² is preferably a hydrogen atom or an alkyl group having from 1 to 6 carbon atoms including, for example, CH₃COO and C₂H₅COO). X is preferably an alkoxy group, and particularly preferably a methoxy group or an ethoxy group.

m represent an integer from 1 to 3, and preferably 1 or 2.

When a plurality of X's are present, a plurality of X's may be the same or different from each other.

The substituent contained in R¹ is not particularly restricted. Examples of the substituent include a halogen atom (for example, fluorine, chlorine or bromine), a hydroxy group, a mercapto group, a carboxyl group, an epoxy group, an alkyl group (for example, methyl, ethyl, isopropyl, propyl or tert-butyl), an aryl group (for example, phenyl or naphthyl), an aromatic heterocyclic group (for example, furyl, pyrazolyl or pyridyl), an alkoxy group (for example, methoxy, ethoxy, isopropoxy or hexyloxy), an aryloxy group (for example, phenoxy), an alkylthio group (for example, methylthio or ethylthio), an arylthio group (for example, phenylthio), an alkenyl group (for example, vinyl or 1-propenyl), an acyloxy group (for example, acetoxy, acryloyloxy or methacryloyloxy), an alkoxycarbonyl group (for example, methoxycarbonyl or ethoxycarbonyl), an aryloxycarbonyl group (for example, phenoxycarbonyl), a carbamoyl group (for example, carbamoyl, N-methylcarbamoyl, N,N-dimethylcarbamoyl or N-methyl-N-octylcarbamoyl), and an acylamino group (for example, acetylamino, benzoylamino, acrylamino or methacrylamino). The substituents may further be substituted.

R¹ is preferably a substituted alkyl group or a substituted aryl group.

As the organosilane compound, an organosilane compound having a vinyl polymerizable substituent represented by formula 2 shown below, synthesized by using the compound of formula 1 as a staring material is also preferred.

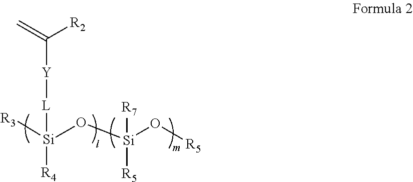

In formula 2, R₂ represents a hydrogen atom, a methyl group, a methoxy group, an alkoxycarbonyl group, a cyano group, a fluorine atom or a chlorine atom. The alkoxycarbonyl group includes, for example, a methoxycarbonyl group and an ethoxycarbonyl group. R₂ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, and particularly preferably a hydrogen atom or a methyl group.

Y represents a single bond, or *—COO—**, *—CONH—** or *—O—**, preferably a single bond, *—COO—** or *—CONH—**, more preferably a single bond or *—COO—**, and particularly preferably *—COO—**. * indicates the connecting site to ═C(R₂)—, and ** indicates the connecting site to L.

L represents a divalent connecting chain. Specifically, L includes a substituted or unsubstituted alkylene group, a substituted or unsubstituted arylene group, a substituted or unsubstituted alkylene group having therein a connecting group (for example, ether, ester or amido) or a substituted or unsubstituted arylene group having therein a connecting group, preferably a substituted or unsubstituted alkylene group, a substituted or unsubstituted arylene group or an alkylene group having therein a connecting group, more preferably an unsubstituted alkylene group, an unsubstituted arylene group or an alkylene group having therein an ether or ester connecting group, and particularly preferably an unsubstituted alkylene group or an alkylene group having therein an ether or ester connecting group. The substituent includes, for example, a halogen atom, a hydroxy group, a mercapto group, a carboxyl group, an epoxy group, an alkyl group and an aryl group. The substituent may further be substituted.

l represents a number satisfying the mathematical formula of l=100−m, and m represents a number from 0 to 50, preferably a number from 0 to 40, and particularly preferably a number from 0 to 30.

R₃ to R₅ each preferably represents a halogen atom, a hydroxy group, an unsubstituted alkoxy group or an unsubstituted alkyl group, more preferably a chlorine atom, a hydroxy group or an unsubstituted alkoxy group having from 1 to 6 carbon atoms, still more preferably a hydroxyl group or an alkoxy group having from 1 to 3 carbon atoms, and particularly preferably a hydroxyl group or a methoxy group.

R₆ represents a hydrogen atom or an alkyl group. The alkyl group is preferably, for example, a methyl group or an ethyl group. R₇ is preferably the group defined for R₁ in formula 1 or a hydroxy group, more preferably a hydroxy group or an unsubstituted alkyl group, still more preferably a hydroxy group or an alkyl group having from 1 to 3 carbon atoms, and particularly preferably a hydroxy group or a methyl group.

The compounds of formula 1 may be used in combination of two or more thereof. In particular, the compound of formula 2 is synthesized by using two kinds of compounds of formula 1 as the starting materials. Specific examples of the compound of formula 1 and the starting material for the compound represented by formula 2 are set forth below, but the invention should not be construed as being limited thereto.

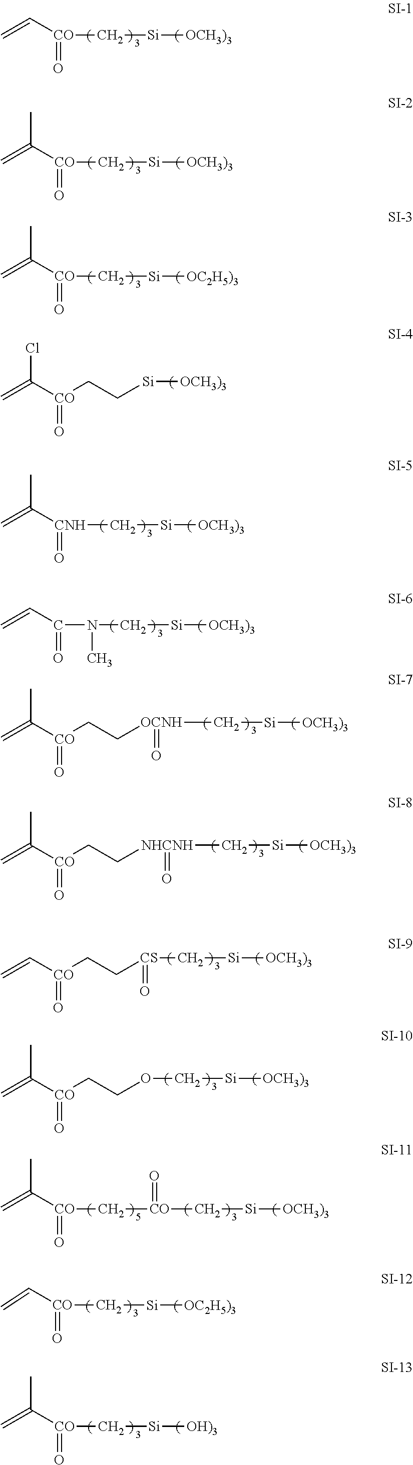

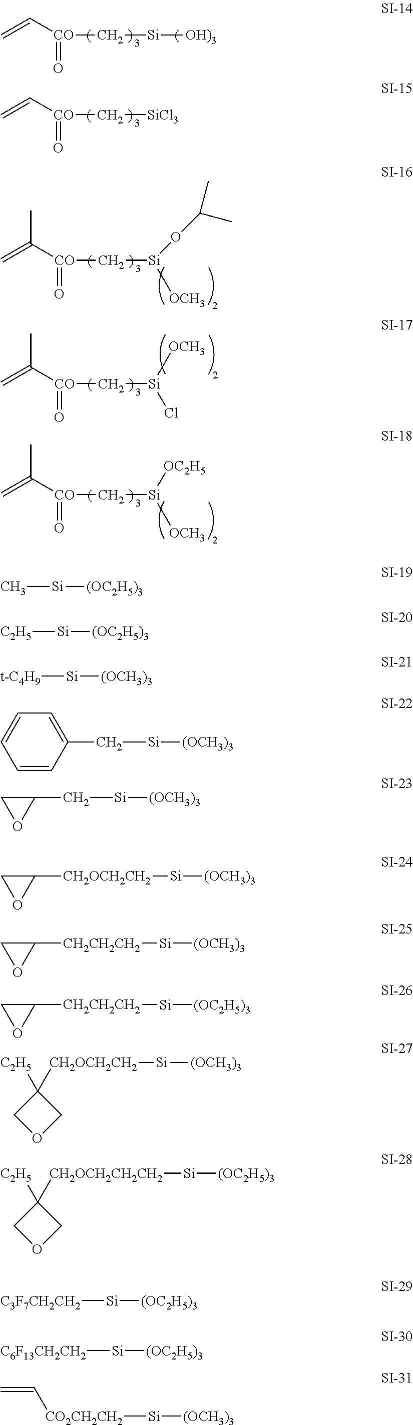

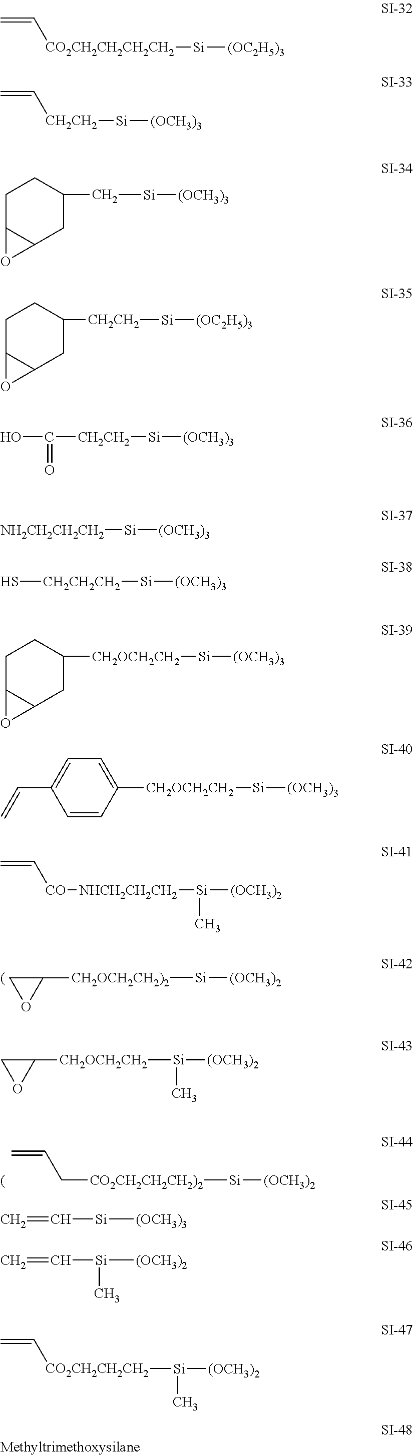

In order to obtain the intended effect of the invention, the content of the organosilane containing a vinyl polymerizable group in the hydrolysate of organosilane and/or partial condensate of the hydrolysate is preferably from 30 to 100% by weight, more preferably from 50 to 100% by weight, still more preferably from 70 to 95%, based on the total amount of the hydrolysate of organosilane and/or partial condensate of the hydrolysate.

At least any of the hydrolysate of organosilane and the partial condensate of the hydrolysate is preferably suppressed in volatility for stabilizing the coated product performance. Specifically, the amount of volatilization per hour at 105° C. is preferably 5% by weight or less, more preferably 3% by weight or less, and particularly preferably 1% by weight or less.

The sol component for use in the invention is prepared by hydrolysis of organosilane and/or partial condensation of the hydrolysis.

The hydrolysis condensation reaction is conducted by adding from 0.05 to 2.0 moles, preferably 0.1 to 1.0 mole of water per mole of the hydrolyzable group (X), and stirring the mixture in the presence of a catalyst for use in the invention at temperature from 25 to 100° C.

In at least any of the hydrolysate of organosilane and the partial condensate of the hydrolysate, the weight average molecular weight of any of a hydrolysate of organosilane containing a vinyl polymerizable group and a partial condensate of the hydrolysate is preferably from 450 to 20,000, more preferably from 500 to 10,000, still more preferably from 550 to 5,000, and yet more preferably from 600 to 3,000, when the components having a molecular weight of less than 300 are excluded.

The weight average molecular weight and molecular weight are molecular weights measured according to differential refractometer detection by means of a GPC analysis apparatus using columns of TSK GEL GMHxL, TSK GEL G4000 HxL and TSK GEL G2000 HxL (all trade names of the products produced by Tosoh Corp.) with a solvent THF and calculated in terms of polystyrene. The content is the area % of the peak within the molecular weight range described above when the peak area of the components having a molecular weight of 300 or more is taken as 100%.

The degree of dispersion (weight average molecular weight/number average molecular weight) is preferably from 3.0 to 1.1, more preferably from 2.5 to 1.1, still more preferably from 2.0 to 1.1, and particularly preferably from 1.5 to 1.1.

The hydrolysate of organosilane compound and partial condensate of the hydrolysate for use in the invention will be described in detail below.

The hydrolysis reaction of organosilane and the subsequent condensation reaction are ordinarily conducted in the presence of a catalyst. Examples of the catalyst include an inorganic acid, for example, hydrochloric acid, sulfuric acid or nitric acid, an organic acid, for example, oxalic acid, acetic acid, butyric acid, maleic acid, citric acid, formic acid, methanesulfonic acid or toluenesulfonic acid, an inorganic base, for example, sodium hydroxide, potassium hydroxide or ammonia, an organic base, for example, triethylamine or pyridine, a metal alkoxide, for example, triisopropoxy aluminum, tetrabutoxy zirconium, tetrabutyl titanate or dibutyl tin dilaurate, a metal chelate compound having as a center metal, a metal, for example, Zr, Ti or Al, and a F-containing compound, for example, KF or NH₄F.

The catalysts may be used individually or in combination of plural kinds thereof.

The hydrolysis reaction of organosilane and the subsequent condensation reaction can be carried out without a solvent or in a solvent. In order to uniformly mix the components, however, an organic solvent is preferably used. For example, an alcohol, an aromatic hydrocarbon, an ether, a ketone or an ester is preferably used.

The solvent which can dissolve the organosilane and catalyst is preferred. Also, it is preferred to use the organic solvent as a coating solution or a part of the coating solution from the standpoint of the process. The solvent which does not impair the solubility or dispersibility when mixed with other material, for example, a fluorine-containing polymer is preferred.

The reaction is conducted by adding 0.05 to 2 moles, preferably 0.1 to 1 mole of water per mole of the hydrolyzable group of organosilane and stirring the mixture at temperature from 25 to 100° C. in the presence of the catalyst and in the presence of or absence of the solvent.

To the coating solution for use in the invention, in addition to the composition containing the sol component and the metal chelate compound, at least any of a (3-diketone compound and a β-ketoester compound is preferably added.

It is preferred that the content of the hydrolysate of organosilane compound and partial condensate of the hydrolysate is small for the antireflective layer which is a relatively thin layer, and the content is large for the hardcoat layer which is a thick layer. In view of the expression of the effect, the refractive index, the shape and surface state of the layer and the like, the content is preferably from 0.1 to 50% by weight, more preferably from 0.5 to 30% by weight, most preferably from 1 to 15% by weight, based on the total solid content of the layer which contains the hydrolysate of organosilane compound and partial condensate of the hydrolysate.

The composition for forming the low refractive index layer used in the present invention preferably contains the photopolymerization initiator as described below in <Photopolymerization initiator>. The content of the photopolymerization initiator in the composition for forming the low refractive index layer according to the present invention is preferably 0.5% by mass to 8% by mass, and more preferably 1% by mass to 5% by mass based on the total solid in the composition for forming the low refractive index layer, for the reason of setting in a large amount sufficient to polymerize the polymerizable compound contained tin the composition for forming the low refractive index layer, and in a small amount sufficient not to excessively increase the initiation point.

A hardcoat layer is described below as the most preferred example of the layers laminated on one side of the transparent support in the optical film according to the invention.

### <Composition for Forming Hardcoat Layer>

In the invention, the term “hardcoat layer” means a layer which raises pencil hardness of the transparent support when formed on the transparent support. From a practical standpoint, the pencil hardness (HS K 5400) after laminating the hardcoat layer is preferably H or more, more preferably 2H or more, and most preferably 3H or more. The thickness of the hardcoat layer is preferably from 0.4 to 35 μm, more preferably from 1 to 30 μm, and most preferably from 1.5 to 20 p.m.

A composition for forming the hardcoat layer preferably contains a curable monomer, a photopolymerization initiator and a solvent. Although the solvent to be used is not particularly limited as far as it can dissolve the curable monomer and photopolymerization initiator to prepare the composition for forming the hardcoat layer, the solvent and curable monomer described below are preferably used.

### <Solvent>

The solvent for use in the hardcoat layer is preferably a mixture of at least one solvent selected from (S-1) and (S-2) and at least one solvent selected from (S-3), or a mixture of at least one solvent selected from (S-1) and at least one solvent selected from (S-2).

(S-1) A solvent dissolving the transparent support
(S-2) A solvent swelling the transparent support
(S-3) A solvent neither dissolving nor swelling the transparent support

The solvent (S-1) dissolving the transparent support means a solvent as defined below.

A 24 mm×36 mm size transparent support is immersed in a 15 cc bottle containing the solvent at room temperature (25° C.) for 60 seconds and removed from the bottle. The resulting solution is analyzed by gel permeation chromatography (GPC) and when a peak area of the transparent support component is 400 mV/sec or more, the solvent is defined as (S-1). Alternatively, a 24 mm×36 mm size transparent support is placed in a 15 cc bottle containing the solvent and the bottle is allowed to stand at room temperature (25° C.) for 24 hours. Then, the bottle is appropriately shaken and when the transparent support is completely dissolved to disappear, the solvent is defined as (S-1).

The solvent (S-2) swelling the transparent support means a solvent as defined below.

A 24 mm×36 mm size transparent support (having thickness of 80 μm) is placed vertically in a 15 cc bottle containing the solvent and is kept at 25° C. for 60 seconds. Then, the transparent support is observed with appropriate shaking and when bending or deformation of the transparent support is recognized, the solvent is defined as (S-2). The transparent support undergoes dimensional change in its swollen portion which is observed as the bending or deformation. With a solvent having no swelling ability, the change, for example, bending or deformation is not observed.

The solvent (S-3) neither dissolving nor swelling the transparent support means a solvent which does not fall into the solvents (S-1) and (S-2) described above.

In the case where the transparent support is a laminate having plural materials having different compositions, the material at the outermost position of the transparent support on the side on which the hardcoat layer is coated is used for the judgment of solvent.

Examples of the solvent having dissolving ability or swelling ability are set forth below taking a triacetyl cellulose film as an example of the transparent support.

The solvent (S-1) which dissolves the support includes, for example, methyl formate, methyl acetate, acetone, N-methylpyrrolidone, dioxane, dioxolane, chloroform, methylene chloride and tetrachloroethane.

The solvent (S-2) which swells the support includes, for example, methyl ethyl ketone (MEK), cyclohexanone, diacetonealcohol, ethyl acetate, ethyl lactate, dimethyl carbonate and ethyl methyl carbonate.

The solvent (S-3) which neither dissolve nor swell the support includes, for example, methyl isobutyl ketone (MIBK), toluene and xylene.

A mixing ratio of the solvents which can be used in the invention is described below.

One preferred embodiment of the solvent which can be used in the invention is a mixture of at least one solvent selected from (S-1) and (S-2) and at least one solvent selected from (S-3). Combination use of (S-1) and (S-3) or combination use of (S-2) and (S-3) is preferred. With these mixed solutions, the ratio of (S-1) or (S-2) in the entire solvent is preferably from 20 to 90% by weight, and more preferably from 30 to 80% by weight. In the embodiment of using this mixed solvent, (S-1) is preferably methyl acetate or acetone, and more preferably methyl acetate. Also, (S-2) is preferably methyl ethyl ketone, cyclohexanone, ethyl acetate, dimethyl carbonate or ethyl methyl carbonate, and more preferably methyl ethyl ketone, ethyl acetate or dimethyl carbonate.

Another preferred embodiment of the solvent which can be used in the invention is a mixture of at least one solvent selected from (S-1) and at least one solvent selected from (S-2). A ratio (by weight) of (S-1) to (S-2) is preferably from 90:10 to 10:90, more preferably from 80:20 to 20:80, and most preferably from 30:70 to 70:30.

The solvent for the hardcoat layer composition is preferably a solvent which has a high solubility for a fluorine-based orientation auxiliary agent present in a layer containing a liquid crystalline compound, and particularly preferably contains methyl acetate, methyl ethyl ketone or dimethyl carbonate. By using the solvent composition described above, a gradation region can be formed between the transparent support and the hardcoat layer wherein distribution of the compounds (transparent support components and hardcoat layer components) gradually changes from the transparent support side to the hardcoat layer side.

The term “hardcoat layer” as used herein means a portion wherein only the hardcoat layer components are contained and transparent support components are not contained, and the term “transparent support” as used herein means a portion which does not contain the hardcoat layer components.

From the standpoint of preventing interference unevenness, a thickness of the gradation region is preferably from 5 to 200%, more preferably from 5 to 150%, most preferably from 5 to 95%, based on the thickness of the hardcoat layer.

The reason why the gradation region described above is preferred is that the interference unevenness is difficult to occur, even when the difference in the refractive index between the transparent support and the hardcoat layer exists, due to the formation of gradation region having the thickness described above. Another reason is that, when the thickness of gradation region is smaller, the thickness of hardcoat layer becomes larger in proportion to the reduced thickness of gradation region so that good hardcoat property, for example, high hardness or low curling can be easily maintained.

The gradation region can be determined as a portion where both the transparent support components and the hardcoat layer components are detected by cutting the film with a microtome and analyzing the cross section by means of a time-of-flight secondary ion mass spectrometer (TOF-SIMS). The thickness of the gradation region can also be determined from the cross-section information of TOF-SIMS.

The total amount of solvent in the composition for forming the hardcoat layer according to the invention is preferably an amount such that the concentration of solid content in the composition is in a range from 1 to 70% by weight. The concentration of solid content is more preferably from 20 to 70% by weight, still more preferably from 40 to 70% by weight, yet more preferably from 45 to 65% by weight, still yet more preferably from 50 to 65% by weight, and most preferably from 55 to 65% by weight.

<Curable Monomer which May be Used in Composition for Forming Hardcoat Layer>

Description will be made below with respect to a preferred aspect of the curable monomer which may be used in a composition for forming the hardcoat layer of the present invention.

In the present invention, a compound having three or more functional groups in one molecule may be preferably used as a composition for forming the hardcoat layer. The compound having three or more functional groups in one molecule may function as a binder and a curing agent for the hardcoat layer, and thus, it is possible to enhance the hardness or scratch resistance of the coating film. The number of the functional groups in one molecule is preferably 3 to 20, more preferably 3 to 10, and still more preferably 3 to 6.

The compound having three or more functional groups in one molecule may be used in combination of two or more kinds in the composition for forming the hardcoat layer of the present invention.

Examples of the compound having three or more functional groups in one molecule may include a compound having polymerizable functional groups (polymerizable unsaturated double bond) such as a (meth)acryloyl group, a vinyl group, a styryl group and an allyl group. Among them, a compound having a (meth)acryloyl group and —C(O)OCH═CH₂ is preferred. Particularly preferably, the following compounds having three or more (meth)acryloyl groups in one molecule may be used.

Particular examples of the compound having a polymerizable functional group may include (meth)acrylate diesters of alkylene glycol, (meth)acrylic diesters of polyoxyalkylene glycol, (meth)acrylic diesters of polyhydric alcohol, (meth)acrylic diesters of an ethylene oxide or propylene oxide adduct, epoxy (meth)acrylates, urethane (meth)acrylates, polyester (meth)acrylates and the like.

Among them, esters of polyhydric alcohol and (meth)acrylic acid are preferred. Examples thereof may include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified tri(meth)acrylate phosphate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-chlorohexane tetramethacrylate, polyurethane polyacrylate, polyester polyacrylate, caprolactone-modified tris(acryloxyethyl)isocyanurate and the like.

As the compound having three or more functional groups in one molecule, any commercially available products may be used. For example, polyfunctional acrylate-based compounds having a (meth)acryloyl group include KAYARAD DPHA, DPCA-30 and PET30 manufactured by NIPPON KAYAKU Co., Ltd., and A-TMMT manufactured by Shin-Nakamura Chemical Co., Ltd. Further, polyurethane polyacrylate includes 15HA, U4HA, UA306H and EB5129 manufactured by Shin-Nakamura Chemical Co., Ltd.

The content of the compound having three or more functional groups in the composition for forming the hardcoat layer according to the present invention is preferably 40% by mass to 99% by mass, more preferably 45% by mass to 99% by mass, still more preferably 50% by mass to 99% by mass, and most preferably 55% by mass to 95% by mass based on the total solid in the composition for forming the hardcoat layer in order to impart a sufficient rate of polymerization, thereby imparting a hardness and the like.

Further, in the present invention, a urethane acrylate compound having three or more functional groups in one molecule may be used.

In the present invention, it is also preferred that the above-mentioned compound having three or more functional groups in one molecule is used in combination with a compound having two or less functional groups in one molecule. Examples of the compound having two or less functional groups in one molecule may include a compound having polymerizable functional groups (polymerizable unsaturated double bond) such as a (meth)acryloyl group, a vinyl group, a styryl group and an allyl group. Among them, a compound having a (meth)acryloyl group and —C(O)OCH═CH₂ is preferred. The compound having two or less functional groups in one molecule easily infiltrate into the transparent support. Therefore, by combining with the above-mentioned compound, it is easy to obtain effects of forming a gradation region, and further, removing the refractive index interface between the gradation layer and the hardcoat layer.

Specific examples of the compound having two or less functional groups per molecule include a (meth)acrylic acid diester, for example, neopentyl glycol diacrylate, 1,6-hexanediol di(meth)acrylate, ethylene glycol di(meth)acrylate or propylene glycol di(meth)acrylate; a polyoxyalkylene glycol (meth)acrylic acid diester, for example, polyethylene glycol di(meth)acrylate having 8 or less number of repeating ethylene units (e.g., diethylene glycol di(meth)acrylate or triethylene glycol di(meth)acrylate) or polypropylene glycol di(meth)acrylate having 6 or less number of repeating propylene units (e.g., dipropylene glycol di(meth)acrylate or tripropylene glycol di(meth)acrylate); a (meth)acrylic acid diester of polyhydric alcohol, for example, pentaerythritol di(meth)acrylate, 1,4-cyclohexane diacrylate or tricyclodecanedimethanol di(meth)acrylate; a (metha)acrylic acid diester of ethylene oxide adduct, for example, 2,2-bis{4-(methacryloxyethoxy)phenyl}propane or 2,2-bis{4-(acryloxydiethoxy)phenyl}propane; and a monofunctional (meth)acrylic acid ester, for example, isobornyl (meth)acrylate, octyl methacrylate, decyl (meth)acrylate, an aliphatic epoxy (meth)acrylate, ethoxylated phenyl (meth)acrylate, β-carboxyethyl (meth)acrylate, methoxypolyethylene glycol (meth)acrylate, phenoxypolyethylene glycol (meth)acrylate, 2-(meth)acryloyloxyethyl succinate, glycerin mono(meth)acrylate, 2-hydroxyethyl (meth)acrylate, cyclohexyl (meth)acrylate or lauryl (meth)acrylate.

As the compound having two or less functional groups in one molecule, any commercially available products may be used, and examples thereof may include BLEMMER E, BLEMMER PE-90, BLEMMER GMR, BLEMMER PME-100, BLEMMER PME-200, BLEMMER PME-400, BLEMMER PDE-200 and BLEMMER PDE-400 manufactured by NOF CORPORATION, ABE10, ABE300, A-200 and A-400 manufactured by Shin-Nakamura Chemical Co., Ltd., Biscoat #195 manufactured by OSAKA ORGANIC CHEMICAL INDUSTRY LTD., EB4858 manufactured by Daicel Corporation and the like.

The content of the compound having two or less functional groups in the composition for forming the hardcoat layer according to the present invention is preferably 0% by mass to 10% by mass based on the polyfunctional material contained in the hardcoat composition, more preferably 0.5% by mass to 9% by mass, and still more preferably 0.5% by mass to 8% by mass. By increasing the addition amount of the compound having two or less functional groups, curl is remarkably improved, but if the compound is added in excess, the pencil hardness is decreased in some cases. Accordingly, the above-mentioned range of the addition amount is preferred from the viewpoint of selecting a range where the curl is improved while the hardness is good.

However, deviation of ±5% from the optimal range of the addition amount may be acceptable in a monofunctional compound and a difunctional compound. This is because of the remarkable effect of making the curl when using a monofunctional compound, compared with using a difunctional compound.

A third preferred embodiment of the monomer for the hardcoat layer is characterized in that at least part of the monomer contained in the composition for forming the hardcoat layer is (Aa) shown below.

(Aa) A Polyethylene Oxide Compound Having One or More Photopolymerizable Groups and a structure of —(CH₂CH₂O)ₙ— (wherein n represents a number from 1 to 50)

### [Polyethylene Oxide Compound (Aa)]

The polyethylene oxide compound (Aa) having one or more photopolymerizable groups and a structure of —(CH₂CH₂O)ₙ— (wherein n represents a number from 1 to 50) which is contained in the composition for forming the hardcoat layer according to the invention will be described below.

The polyethylene oxide compound (Aa) has one or more photopolymerizable groups and has a structure of —(CH₂CH₂O)ₙ— (wherein n represents a number from 1 to 50).

From the standpoint of inhibiting bleed-out and not impairing the hardness of hardcoat layer, a number of the photopolymerizable groups which the polyethylene oxide compound (Aa) has is preferably from 10 to 2,000 g·mol⁻¹, more preferably from 50 to 1,000 g·mol⁻¹, still more preferably from 100 to 500 g·mol⁻¹, in terms of functional group equivalent weight. More specifically, the number of the photopolymerizable groups is preferably from 1 to 18, more preferably 2 or 3, and still more preferably 2.

The photopolymerizable group which the polyethylene oxide compound (Aa) has includes, for example, a (meth)acryloyl group, a (meth)acryloyloxy group, a vinyl group and an allyl group. From the standpoint of good reactivity with other compound having an unsaturated double bond, a (meth)acryloyloxy group is preferred, and an acryloyloxy group is more preferred.

In the polyethylene oxide compound (Aa), n represents a number of repeating units and is a number from 1 to 50. n is preferably from 1 to 30, and more preferably from 3 to 20.

In particular, in the case where the polyethylene oxide compound (Aa) has two photopolymerizable groups, n is preferably from 1 to 20, and more preferably from 3 to 15. In the case where the polyethylene oxide compound (Aa) has two photopolymerizable groups, it is preferred that when n is 20 or less because the hardness of hard coat layer is improved. Also, n is preferably 1 or more because of excellent curling reduction.

Also, in the case where the polyethylene oxide compound (Aa) has three photopolymerizable groups, n is preferably from 1 to 30, and more preferably from 5 to 20. This is believed to be that since the crosslinking density becomes higher than in the case where the polyethylene oxide compound (Aa) has two photopolymerizable groups, the optimal value of the ethylene oxide chain shifts to a longer side in order to reduce the curling.

As to the number of the —(CH₂CH₂O)ₙ— structures included in the polyethylene oxide compound (Aa), a smaller number is preferred from the standpoint that a longer polyethylene oxide chain is more advantageous for reducing the curling, when the total number of —(CH₂CH₂O)— structures per molecule is compared. The number is more preferably 6 or less, still more preferably 4 or less, and particularly preferably 1.

The molecular weight of the polyethylene oxide compound (Aa) is preferably 1,000 or less. It is preferred when the molecular weight is 1,000 or less, because the hardness of hardcoat layer is improved and the curl-reducing effect is large. This is believed to be that, when the molecular weight of the polyethylene oxide compound (Aa) is 1,000 or less, such polyethylene oxide compounds (Aa) are difficult to gather on the surface of the transparent support.

The polyethylene oxide compound (Aa) contains a photopolymerizable group and a structure of —(CH₂CH₂O)ₙ—, and may contain a structure other than these structures. Examples of such other structure include an alkylene group, an amido bond, a sulfonylamido bond, a thioamido bond, an ether bond, an ester bond and a urethane bond.

The polyethylene oxide compound (Aa) is preferably composed of the photopolymerizable group and the structure of —(CH₂CH₂O)ₙ—, because the curl-reducing effect can be most easily achieved.

The polyethylene oxide compound (Aa) may have a branched or straight structure. However, when a compound having a straight structure and a compound having a branched structure both of which contain the same number of the (CH₂CH₂O) structures per molecule are compared, the compound having a straight structure is preferred in view that the compound having a straight structure can more advantageously reduce the curling because the branched carbon moiety has no curl-reducing effect.

A particularly preferred structure of the polyethylene oxide compound (Aa) is a structure wherein photopolymerizable groups are connected to both terminals of one —(CH₂CH₂O)ₙ— structure, and a compound represented by formula (al) shown below is preferred.

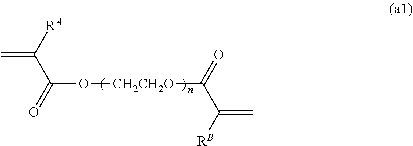

In formula (a1), R^{A} and R^{B} each independently represents a hydrogen atom or a methyl group. n has the same meaning as defined above and the preferred range thereof is also same as that described above. Specifically, a compound wherein n is approximately 9 is most preferred.

Specific examples of the polyethylene oxide compound (Aa) are set forth below, but the invention should not be construed as being limited thereto. The ethylene oxide is abbreviated as “EO”.

EO adduct of trimethylolpropane tri(meth)acrylate
EO adduct of pentaerythritol tetra(meth)acrylate
EO adduct of dimethylolpropane tetra(meth)acrylate
EO adduct of dipentaerythritol penta(meth)acrylate
EO adduct of dipentaerythritol hexa(meth)acrylate
Tris(2-hydroxyethyl)isocyanurate tri(meth)acrylate
EO-modified diglycerin tetra-acrylate

The polyethylene oxide compound (Aa) can be synthesized by methods described, for example, in JP-A-2001-172307 and Japanese Patent No. 4506237. As the polyethylene oxide compound (Aa), commercially available products may also be used. As the commercially available product, A-400 produced by Shin-Nakamura Chemical Co., Ltd., BLEMMER PP-500 and BLEMMER PME-1000 produced by NOF Corp., Viscoat V #360 produced by Osaka Organic Chemical Industry Ltd. and DGE-4A produced by Kyoeisha Chemical Co., Ltd.

From the standpoint of achieving excellent curl-reducing effect without reducing the hardness of hardcoat layer, the content of the polyethylene oxide compound (Aa) in the composition for forming the hardcoat layer according to the invention is preferably from 0 to 40% by weight, more preferably from 3 to 30% by weight, still more preferably from 5 to 20% by weight, based on the total solid content of the composition for forming the hardcoat layer.

### [Photopolymerization Initiator]

It is preferable that a photopolymerization initiator is contained in the composition for forming the hardcoat layer according to the invention.

Examples of the photopolymerization initiator include an acetophenone, a benzoin, a benzophenone, a phosphine oxide, a ketal, an anthraquinone, a thioxanthone, an azo compound, a peroxide, a 2,3-dialkyldione compound, a disulfide compound, a fluoroamine compound, an aromatic sulfonium, a lophine dimer, an onium salt, a borate salt, an active ester, a active halogen, an inorganic complex and a coumarin. Specific examples, preferred embodiments, commercially available products and the like of the photopolymerization initiator are described in Paragraph Nos. [0133] to [0151] of JP-A-2009-098658, and they can also be preferably used in the invention.

Various examples of the photopolymerization initiator are also described in Saishin UV Koka Gijutsu (Latest UV Curing Technology), page 159, Technical Information Institute Co., Ltd. (1991) and Kiyomi Kato, Shigaisen Koka System (Ultraviolet Ray Curing System), pages 65 to 148, Sogo Gijutsu Center Co., Ltd. (1989), and they are useful for the invention.

The content of the photopolymerization initiator in the composition for forming the hardcoat layer according to the invention is preferably from 0.5 to 8% by weight, more preferably from 1 to 5% by weight, based on the total solid content of the composition for forming the hardcoat layer for the reason that the content is set to be sufficiently large for polymerization of a polymerizable compound contained in the composition for forming the hardcoat layer and sufficiently small for preventing excessive increase of initiation point.

Examples of the solvent having dissolving ability or swelling ability are set forth below taking a triacetyl cellulose film as an example of the transparent support.

The solvent which dissolves the support includes, for example, methyl formate, methyl acetate, acetone, N-methylpyrrolidone, dioxane, dioxolane, chloroform, methylene chloride and tetrachloroethane.

The solvent which swells the support includes, for example, methyl ethyl ketone

(MEK), cyclohexanone, diacetonealcohol, ethyl acetate, ethyl lactate, dimethyl carbonate and ethyl methyl carbonate.

The solvent which neither dissolve nor swell the support includes, for example, methyl isobutyl ketone (MIBK), toluene and xylene.

The solvents are used in an appropriate combination in the composition for forming the hardcoat layer as far as the object and effect of the invention are not impaired.

In the composition for forming the hardcoat layer according to the invention, a leveling agent can be used in order to control the layer thickness unevenness of the hardcoat layer. Any leveling agent may be used as far as the object and effect of the invention are not impaired. As the leveling agent, fluoroaliphatic group-containing polymers described in Japanese Patent No. 4474114 are preferred. Fluoroaliphatic group-containing polymers different from the fluoroaliphatic group-containing polymers described in Japanese Patent 4,474,114 in that the ratio of fluoroaliphatic group-containing polymerization unit is in a range from 50 to 70% can also be used as the leveling agent.

A silicone-based compound is also possible to use as the leveling agent. As the silicone-based compound, a modified silicone is preferred. The functional group to be used for the modification includes, for example, a polyether group, a polyurethane group, an epoxy group, a carboxyl group, a (meth)acrylate group, a carbinol group, a hydroxy group, an alkyl group, an aryl group and an alkylene oxide group.

In the invention, the leveling agent is preferably aligned in a sufficient amount on the surface of the hardcoat layer in order to remove coating unevenness of the hardcoat layer. However, in the case of laminating an antireflective layer on the hardcoat layer, when the leveling agent contained in the hardcoat layer remains at the interface between the hardcoat layer and the antireflective layer, the adhesion property is deteriorated and the scratch resistance is seriously impaired. Therefore, it is important for the leveling agent to be rapidly extracted into the antireflective layer when the antireflective layer is laminated on the hardcoat layer and not to remain at the interface.

For the reason of imparting sufficient leveling property to reduce coating unevenness and, at the same time, controlling the amount at a sufficiently low level not to remain at the interface between the hardcoat layer and other layer, the content of the leveling agent in the composition for forming the hardcoat layer according to the invention is preferably from 0.0005 to 2.5% by weight, more preferably from 0.005 to 0.5% by weight, based on the total solid content of the composition for forming the hardcoat layer. It is not preferred when the content is larger than 0.5% by weight, because phase separation caused by the leveling agent may occur depending on the kinds of the curable monomer and solvent used and uniform hardcoat layer can not be formed.

### <Conductive Compound>

The hardcoat layer of the optical film according to the invention may contain a conductive compound for the purpose of imparting an antistatic property. In particular, by using a conductive compound having hydrophilicity, the surface localization property of the leveling agent is improved, the surface unevenness is prevented and the scratch resistance is further improved. In order to impart the hydrophilicity to the conductive compound, a hydrophilic group may be introduced into the conductive compound. The hydrophilic group preferably includes a cationic group, more preferably a quaternary ammonium salt group from the standpoint of exhibiting high conductivity and being relatively inexpensive.

The conductive compound for use in the invention is not particularly restricted and includes an ion conductive compound and an electron conductive compound. The ion conductive compound includes, for example, a cationic, anionic, nonionic or amphoteric ion conductive compound. The electron conductive compound includes an electron conductive compound which is a non-conjugated polymer or conjugated polymer formed by connecting aromatic carbon rings or aromatic hetero rings with a single bond or a divalent or higher valent connecting group. Of the compounds, a compound (cationic compound) having a quaternary ammonium salt group is preferred from the standpoint of high antistatic property, relatively inexpensive and ease localization to the transparent support side region.

As the compound having a quaternary ammonium salt group, any of a low molecular weight type and a high molecular weight type may be used, and a high molecular weight type cationic antistatic agent is preferably used because the fluctuation of antistatic property resulting, for example, from bleeding out is prevented. The high molecular weight type cationic compound having a quaternary ammonium salt group is used by appropriately selecting from known compounds and a polymer having at least one unit selected from the structural units represented by formulae (I) to (III) shown below is preferred from the standpoint of ease localization to the transparent support side region.

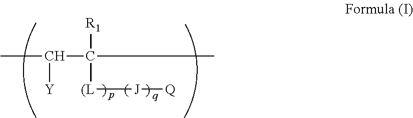

In formula (I), R₁ represents a hydrogen atom, an alkyl group, a halogen atom or a —CH₂COO⁻M⁺, Y represents a hydrogen atom or a —COO⁻M⁺, M⁺ represents a proton or a cation, L represents —CONH—, —COO—, —CO— or —O—, J represents an alkylene group, an arylene group or a group formed by combination of these groups, and Q represents a group selected from Group A shown below.

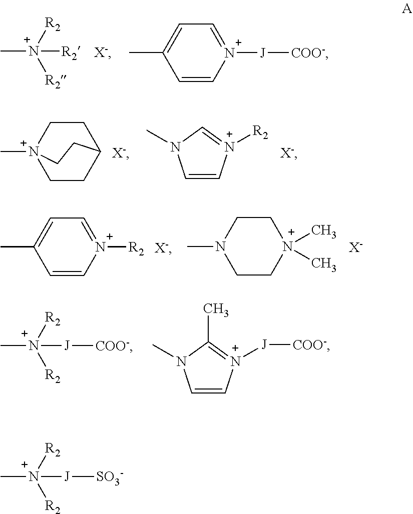

In the formulae above, R₂, R₂′ and R₂″ each independently represents an alkyl group, J represents an alkylene group, an arylene group or a group formed by combination of these groups, X⁻represents an anion, and p and q each independently represents 0 or 1.

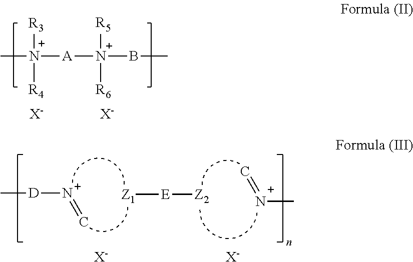

In formulae (II) and (III), R₃, R₄, R₅ and R₆ each independently represents an alkyl group, or R₃ and R₄ or R₅ and R₆ may be connected with each other to from a nitrogen-containing hetero ring. A, B and D each independently represents an alkylene group, an arylene group, an alkenylene group, an arylenealkylene group, —R₇COR₈—, —R₉COOR₁₀OCOR₁₁—, —R₁₂OCOR₁₃COOR₁₄—, —R₁₅—(OR₁₆)ₘ—, —R₁₇CONHR₁₈NHCOR₁₉—, —R₂₀OCONHR₂₁NHCOR₂₂— or —R₂₃NHCONHR₂₄NHCONHR₂₅—, E represents a single bond, an alkylene group, an arylene group, an alkenylene group, an arylenealkylene group, —R₇COR₈—, —R₉COOR₁₀OCOR₁₁—, —R₁₂OCOR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—, R₇, R₈, R₉, R₁₁, R₁₂, R₁₄, R₁₅, R₁₆, R₁₇, R₁₉, R₂₀, R₂₂, R₂₃, R₂₅ and R₂₆ each independently represents an alkyl group, R₁₀, R₁₃, R₁₈, R₂₁ and R₂₄ each independently represents a connecting group selected from an alkylene group, an alkenylene group, an arylene group, an arylenealkylene group and alkylenearylele group, m represents a positive integer from 1 to 4, X⁻ represents an anion, Z₁ and Z₂ each represents a nonmetallic atomic group necessary for forming a 5-membered or 6-membered ring together with the —N═C— group and may be connected to E in the form of a quaternary salt of ≡N⁺[X⁻]—, and n represents an integer from 5 to 300.

The groups in formulae (I) to (III) are described in detail below.

The halogen atom includes a chlorine atom and a bromine atom and is preferably a chlorine atom. The alkyl group is preferably a branched or a straight-chain alkyl group having from 1 to 4 carbon atoms, and more preferably a methyl group, an ethyl group or a propyl group. The alkylene group is preferably an alkylene group having from 1 to 12 carbon atoms, more preferably a methylene group, an ethylene group or a propylene group, and particularly preferably an ethylene group. The arylene group is preferably an arylene group having from 6 to 15 carbon atoms, more preferably a phenylene group, a diphenylene group, a phenylmethylene group, a phenyldimethylene group or a naphthylene group, and particularly preferably a phenymethylene group. These groups may have a substituent. The alkenylene group is preferably an alkylene group having from 2 to 10 carbon atoms and the arylenealkylene group is preferably an arylenealkylene group having from 6 to 12 carbon atoms. These groups may have a substituent. The substituent which may be present on each group includes, for example, a methyl group, an ethyl group and a propyl group.

In formula (I), R₁ is preferably a hydrogen atom.

Y is preferably a hydrogen atom.

J is preferably a phenymethylene group.

Q is preferably a group represented by formula (VI) shown below selected from Group A wherein R₂, R₂′ and R₂″ each independently represents a methyl group.

X⁻represents, for example, a halide ion, a sulfonic acid anion or a carboxylic acid anion, preferably a halide ion, and more preferably a chloride ion.

p and q is each preferably 0 or 1, and more preferably p is 0 and q is 1.

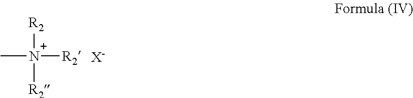

In formulae (II) and (III), R₃, R₄, R₅ and R₆ each preferably represents a substituted or unsubstituted alkyl group having from 1 to 4 carbon atoms, more preferably a methyl group or an ethyl group, and particularly preferably a methyl group. A, B and D each independently preferably represents a substituted or unsubstituted alkylene group having from 2 to 10 carbon atoms, an arylene group, an alkenylene group or an arylenealkylene group, and more preferably a phenyldimethylene group.

X⁻represents, for example, a halide ion, a sulfonic acid anion or a carboxylic acid anion, preferably a halide ion, and more preferably a chloride ion.

E preferably represents a single bond, an alkylene group, an arylene group, an alkenylene group or an arylenealkylene group. The 5-membered or 6-memebered ring formed by Z₁ or Z₂ together with the —N═C— group includes, for example, a diazoniabicyclooctane ring.

Specific examples of the compound having a structural unit represented by any one of formulae (I) to (III) are set forth below, but the invention should not be construed as being limited thereto. Of the suffixes (m, x, y, z, r and numeral numbers) shown in the specific examples, m represents a number of repeating units of each unit, and x, y, z and r each represents a molar ratio of each unit.

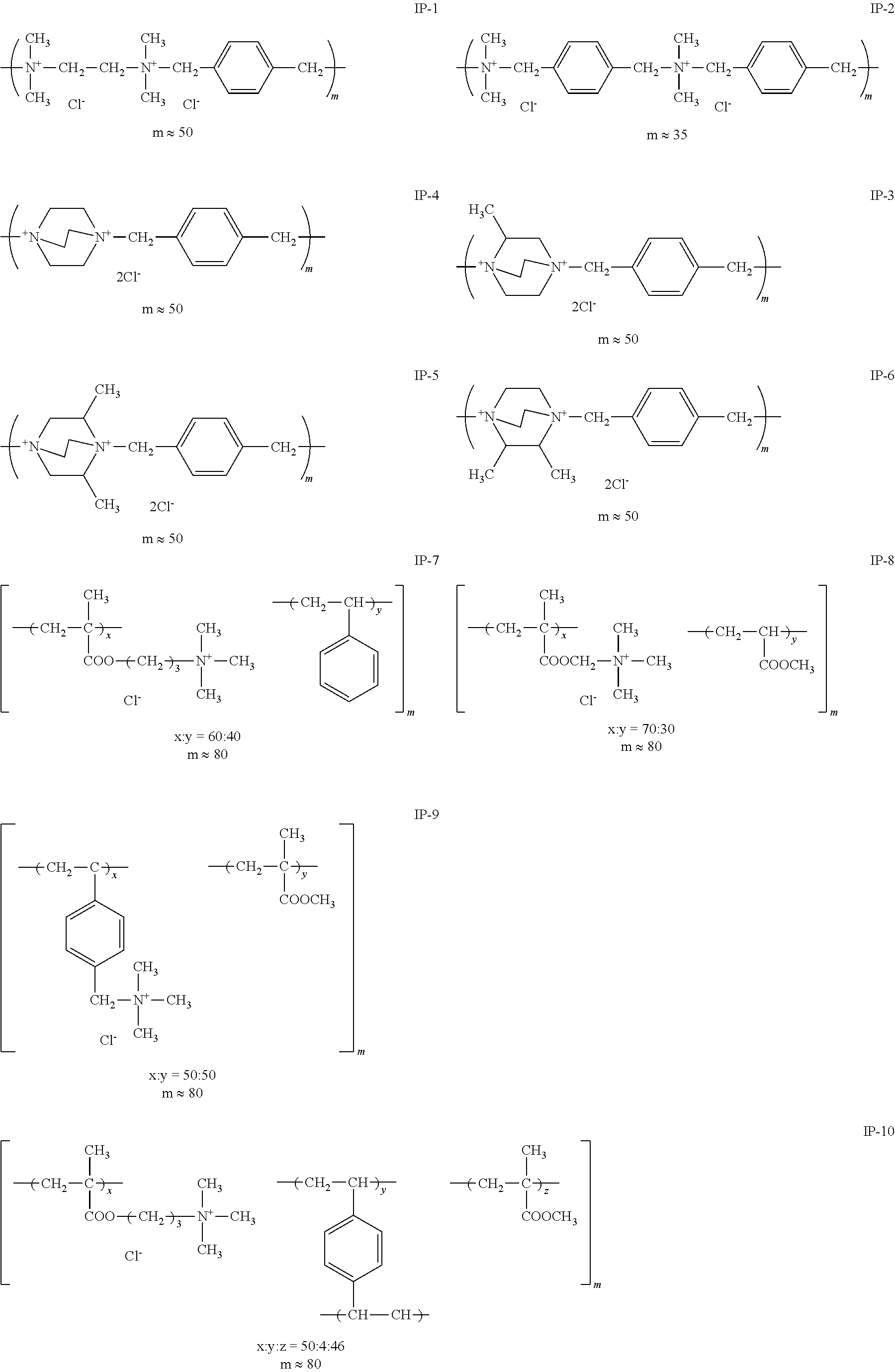

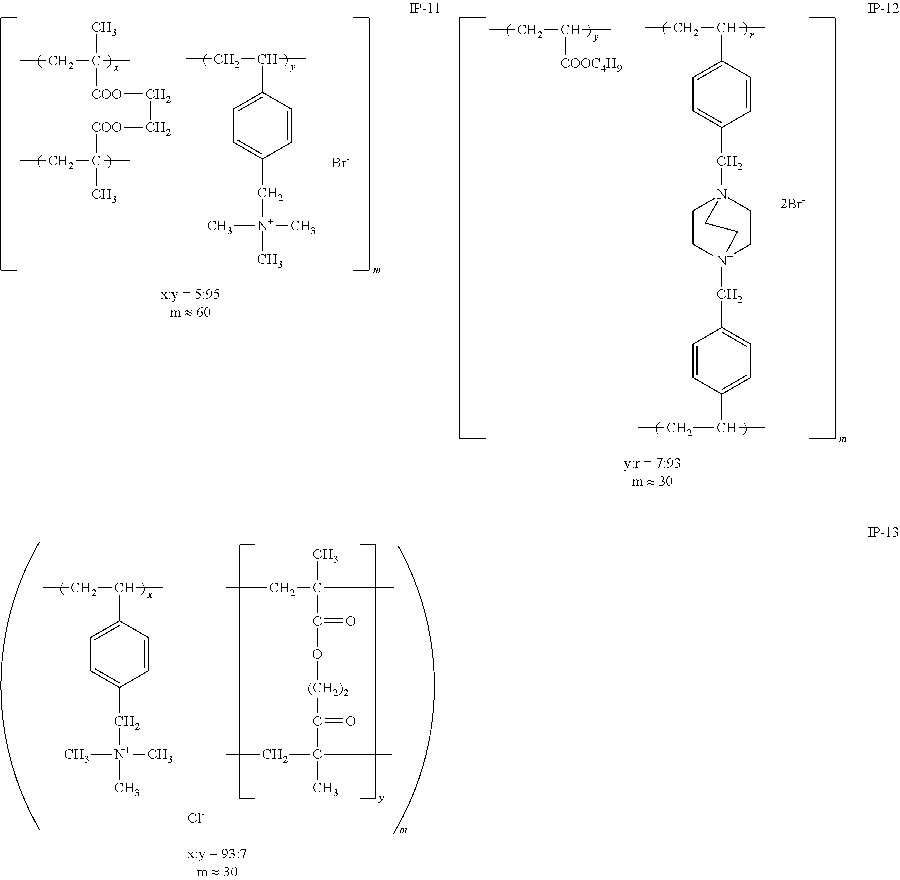

The conductive compounds illustrated above may be used individually or in combination of two or more thereof. The antistatic compound having a polymerizable group in a molecule of an antistatic agent is more preferred because it can also increase the scratch resistance (film strength) of the antistatic layer.

The electron conductive compound is preferably a non-conjugated polymer or conjugated polymer formed by connecting aromatic carbon rings or aromatic hetero rings with a single bond or a divalent or higher valent connecting group. The aromatic carbon ring in the non-conjugated polymer or conjugated polymer includes, for example, a benzene ring and the benzene ring may further form a condensed ring. The aromatic hetero ring in the non-conjugated polymer or conjugated polymer includes, for example, a pyridine ring, a pyrazine ring, a pyrimidine ring, a pyridazine ring, a triazine ring, an oxazole ring, a thiazole ring, an imidazole ring, an oxadiazole ring, thiadiazole ring, a triazole ring, a tetrazole ring, a furan ring, a thiophene ring, a pyrrole ring, an indole ring, a carbazole ring, a benzimidazole ring and an imidazopyridine ring. There rings may further form a condensed ring and may have a substituent.

The divalent or higher valent connecting group in the non-conjugated polymer or conjugated polymer includes a connecting group formed, for example, from a carbon atom, a silicon atom, a nitrogen atom, a boron atom, an oxygen atom, a sulfur atom, metal and a metal ion, and preferably a group formed from a carbon atom, a nitrogen atom, a silicon atom, a boron atom, an oxygen atom, a sulfur atom and a combination thereof. Examples of the group formed by combination include a substituted or unsubstituted methylene group, a carbonyl group, an imino group, a sulfonyl group, a sulfinyl group, an ester group, an amido group and a silyl group.

Specific examples of the electron conductive compound include conductive polyaniline, polyparaphenylene, polyparaphenylenevynylene, polythiophene, polyfuran, polypyrrole, polyselenophene, polyisothianaphthene, polyphenylene sulfide, polyacetylene, polypyridylvinylene, polyazine and derivatives thereof each of which may be substituted. The electron conductive compounds may be used individually or in combination of two or more thereof according to the purpose.

As far as the desired conductivity can be achieved, it may be used in the form of a mixture with other polymer having no conductivity, and a copolymer of a monomer capable forming the conductive polymer with other monomer having no conductivity may also be used.

The electron conductive compound is more preferably a conjugated polymer. Examples of the conjugated polymer include polyacethylene, polydiacetylene, poly(paraphenylene), polyfluorene, polyazulene, poly(paraphenylene sulfide), polypyrrole, polythiophene, polyisothianaphthene, polyaniline, poly(paraphenylenevinylene), poly(2,5-thienylenevinylene), a multiple chain type conjugated polymer (e.g., polyperinaphthalene), a metal phthalocyanine-type polymer, other conjugated polymer (e.g., poly(paraxylylene) or poly[α-(5,5′-bithiophenediyl)benzylidene]) and derivatives thereof.

Poly(paraphenylene), polypyrrole, polythiophene, polyaniline, poly(paraphenylenevinylene), poly(2,5-thienylenevinylene) and derivatives thereof are preferred, polythiophene, polyaniline, polypyrrole and derivative thereof are more preferred, and polythiophene and a derivative thereof are still more preferred.

A weight average molecular weight of the electron conductive compound for use in the invention is preferably from 1,000 to 1,000,000, more preferably from 10,000 to 500,000, and still more preferably from 10,000 to 100,000. The weight average molecular weight is a weight average molecular weight measured by gel permeation chromatography and calculated in terms of polystyrene.

The electron conductive compound for use in the invention is preferably soluble in an organic solvent from the standpoint of the coating property and imparting affinity with other components. The term “soluble” as used herein means a state where the compound is dissolved in the solvent as a single molecule state or as a association state of plural single molecules or state where the compound is dispersed in the solvent as a particle having particle diameter of 300 nm or less.

Since the electron conductive compound is ordinarily dissolved in a solvent mainly composed of water, the electron conductive compound per se has hydrophilicity. In order to solubilize the electron conductive compound in an organic solvent, a compound (for example, a solubilizing-aid agent) which increases affinity with the organic solvent, a dispersant in the organic solvent or the like is added to the composition containing the electron conductive compound or a polyanion dopant subjected to a hydrophobilizing treatment is used. Although the electron conductive compound is made soluble also in the organic solvent used in the invention using the method described above, it still has the hydrophilicity so that the localization of conductive compound can be formed using the method according to the invention.

In the case of using the compound having a quaternary ammonium salt group as the conductive compound, it is preferred that a nitrogen or sulfur atom content on the surface side of the antistatic layer according to elemental analysis (ESCA) is from 0.5 to 5% by mole. In the range described above, good antistatic property is easily obtained. The content is more preferably from 0.5 to 3.5% by mole, and still more preferably from 0.5 to 2.5% by mole.

The composition for forming the hardcoat layer according to the invention may or may not contain the conductive compound. When the conductive compound is contained, the content of the conductive compound is preferably from 5 to 20% by weight, more preferably from 10 to 15% by weight, based on the total solid content of the composition for forming the hardcoat layer.

### <Coating Method>

When plural layers are laminated on the one side of the transparent support in the optical film according to the invention, each layer can be formed by a method described below, but the invention should not be construed as being limited thereto.

First, a coating solution containing components for forming each layer is prepared. Then, the coating solution for forming each layer is coated on the transparent support by a dip coating method, an air-knife coating method, a curtain coating method, a roller coating method, a wire-bar coating method, a gravure coating method or a die coating method, and heated to dry. Of the coating methods, a gravure coating method, a wire-bar coating method or a die coating method is preferred, and a die coating method is particularly preferred. After the coating, the solvent is removed in a drying process. As to the drying process, it is preferred to provide a drying process in which a drying zone is provided immediately after the coating and the drying speed is adjusted by controlling the internal environment of the drying zone. It is more preferred to provide the drying process as described in JP-A-2003-106767 wherein a drying apparatus is arranged in which a condensation plate which is a plate-like member is placed in nearly parallel to the transport position just after the coating and the distance between the condensation plate and the coated layer and the temperature of the condensation plate are controlled to condense and recover the solvent in the coating solution.

Thereafter, the monomer for forming each layer is polymerized to cure by irradiation with light or application of heat. Thus, each layer is formed.

### <Plural Layers on Other Side of Transparent Support>

In the optical film according to the invention, plural layers are laminated on the one side of the transparent support and irregularity is formed on the surface of the outermost layer of the plural layers and in addition, plural layers are laminated on the other side of the transparent support. To the plural layers can be imparted various functions, but on the other side of the transparent support are laminated layers having the functions different from those imparted to the layers laminated on the one side of the transparent support. The functional layer includes, for example, a conductive layer, a brightness increasing layer, an optically anisotropic layer, a easy adherence layer, a refractive index controlling layer, a moisture-proof layer and an alignment film layer.

In the present invention, the farthest layer (so-called outermost layer) from the transparent support among the plurality of layers is an optically anisotropic layer formed of a curable resin composition.

Any of the layers on the one side and the layers on the other side may be laminated first in the optical film according to the invention. The optical film is prepared by laminating layers on the one side, forming irregularity and then laminating layers on the other side using a different method. The optical film is prepared by laminating layers on the one side and layers on the other side at the same time. The optical film according to the invention is preferably prepared by laminating layers on the other side first and then laminating layers on the one side, followed by forming irregularity.

With respect to the front side and rare side of the transparent support, there is no particular restriction. In the case where the transparent support has knurling provided thereon, the layers on the one side and layers on the other side are preferably laminated so that the layers on which the irregularity is not formed are laminated on the side of the transparent support having the knurling.

In the optical film according to the invention, a double bond reaction rate A of layers laminated on one side of the transparent support is preferably 60% or more, more preferably 70% or more, and most preferably 80% or more.

In the optical film according to the invention, a double bond reaction rate B of layers laminated on a side different from the one side, that is, on the other side of the transparent support is preferably 70% or more, more preferably 75% or more, and most preferably 80% or more.

It is not preferred when the double bond reaction rate A is too small, because the laminate on the one side may transfer to the other side when the optical film is wound up in roll form and stored in a bulk state. On the other hand, it is also not preferred when the double bond reaction rate B is too small, because the laminate on the other side may transfer to the one side when the optical film is wound up in roll form and stored in a bulk state.

As one preferred example of the layers laminated on the other side of the transparent support, an optically anisotropic layer and an alignment film are described in detail below.

As previously mentioned, the optically anisotropic layer may be an optically anisotropic layer that a film having a certain phase difference is in-plane uniformly formed, or an optically anisotropic layer that a direction of a slow axis or an amount of a phase difference is different from each other and a pattern is formed such that a phase difference region is regularly in-plane arranged. Here, the former optically anisotropic layer is explained in below.

Also, with respect to the later optically anisotropic layer, a technic that a photo-alignment film and a pattern exposure are combined is described in WO 2010/090429, and such an optically anisotropic layer is preferably used as an optical film.

### [Optically Anisotropic Layer]

In the invention, materials and production conditions can be selected according to various uses, and an optically anisotropic layer using a polymerizable liquid crystalline compound is one preferred embodiment.

First, a method of measuring an optical characteristic is described below. In the specification, Re (λ) and Rth (λ) indicate an in-plane retardation and an retardation in the thickness direction at a wavelength λ, respectively. The Re (λ) is measured by means of KOBRA 21ADH or KOBRA WR (produced by Oji Scientific Instruments) while applying light having a wavelength of λ nm in the normal line direction of the film. For the selection of the measuring wavelength λ, a wavelength-selecting filter is manually exchanged or the measured value is converted by a program or the like. In the case where the film to be measured is a film expressed by a uniaxial or biaxial refractive index ellipsoid, the Rth (λ) is calculated in the following manner. The measuring method is partly utilized in the measurement of the average tilt angle on the orientated film side of discotic liquid crystal molecule in the optically anisotropic layer as described hereinafter and the average tilt angle on the opposite side thereof.

The Rth (λ) is calculated by KOBRA 21ADH or KOBRA WR based on 6 retardation values, an assumed value of average refractive index and an inputted thickness value. The 6 retardation values are obtained by measuring the Re (λ) at a total of 6 points by applying light having a wavelength of λ nm to a film from 6 directions from the normal line direction of the film to a direction tilted at 50° from the normal line direction with 10° interval using an in-plane slow axis (determined by KOBURA 21ADH or KOBURA WR) as a tilt axis (rotation axis) (in the case where the film does not have the slow axis, any desired in-plane direction of the film may be used as the rotation axis). In the above calculation, when the film has a retardation value of zero at a certain tilt angle to the normal line using the in-plane slow axis as the rotation axis, positive sign of a retardation value at a tilt angle larger than the certain tilt angle is converted to negative sign and then the calculation is conducted by KOBRA 21ADH or KOBRA WR. Further, using the slow axis as the tilt axis (rotation axis) (in the case where the film does not have the slow axis, any desired in-plane direction of the film may be used as the rotation axis), a retardation value is determined in any desired two tilt directions and, based on the data obtained, the assumed value of average refractive index and the inputted film thickness value, Rth of the film can also be calculated according to formulae (A) and (III) shown below.

$$Re ( θ ) = [ nx - \frac{ny \times nz}{( \sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}} )} ] + \frac{d}{cos ( {sin}^{- 1} ( \frac{sin ( - θ )}{nx} ) )} \qquad Formula ( A )$$

In the formula (A), Re (θ) represents a retardation value in the direction tilted at an angle 0 from the normal line direction.

In the invention, the in-plane retardation means Re (θ) in formula (A) when measured at a wavelength of 550 nm and an angle 0 of 0 degree.

In the optical film according to the invention, the in-plane retardation is preferably from 80 to 200 nm, more preferably from 110 to 160 nm, still more preferably from 115 to 150 nm, and most preferably from 120 to 145 nm.

In the formula (A), nx represents a refractive index in the in-plane slow axis direction, ny represents a refractive index in the direction perpendicular to the slow axis direction of nx in the plane, and nz represents a refractive index in the direction perpendicular to the above directions of nx and ny. d represents a film thickness.

Rth=((nx+ny)/2−nz)×d Formula (III)

In the case where the film to be measure cannot be expressed as a uniaxial or biaxial refractive index ellipsoid, specifically, in the case where the film to be measure has no so-called optic axis, Rth (2) is calculated in the following manner. The Rth (λ) is calculated by KOBRA 21ADH or KOBRA WR based on 11 retardation values, an assumed value of average refractive index and an inputted thickness value. The 11 retardation values are obtained by measuring the Re (λ) at a total of 11 points by applying light having a wavelength of λ nm to a film from 11 directions tilted at −50° to +50° with 10° interval to the normal line direction of the film using an in-plane slow axis (determined by KOBURA 21 ADH or KOBURA WR) as a tilt axis (rotation axis). In the above measurement, as the assumed value of average refractive index, values described in Polymer Handbook (JOHN WILEY & SONS, INC.) and catalogs of various optical films can be used. In the case where a value of average refractive index is unknown, the value can be measured by an Abbe refractometer. The average refractive indexes of major optical films are shown below: cellulose acylate (1.48), cycloolefin polymer (1.52), polycarbonate (1.59), polymethyl methacrylate (1.49), and polystyrene (1.59). By inputting the assumed value of the average refraction index and thickness value, nx, ny and nz are calculated by KOBRA 21ADH or KOBRA WR. Further, Nz=(nx−nz)/(nx−ny) is calculated from the calculated nx, ny and nz.

The optical film of the present invention is preferably an optical film in a long roll shape, in which the slow axis of the in-plane retardation is inclined clockwise or anticlockwise at 5° to 85° with respect to the longitudinal direction (longer direction).

### [Optically Anisotropic Layer Containing Liquid Crystalline Compound]

The kind of the liquid crystalline compound used in the formation of optically anisotropic layer which the optical film according to the invention may have is not particularly restricted. For example, an optically anisotropic layer obtained by forming a low molecular liquid crystalline compound in the nematic alignment in a liquid crystal state and then fixing by photocrosslinking or thermal crosslinking or an optically anisotropic layer obtained by forming a high molecular liquid crystalline compound in the nematic alignment in a liquid crystal state and then cooling to fix the alignment can be used. In the invention, even when a liquid crystalline compound is used in the optically anisotropic layer, the optically anisotropic layer is a layer formed by fixing the liquid crystalline compound by polymerization or the like and thus does not need to show crystallinity once the layer is formed. A polymerizable liquid crystalline compound may be a multifunctional polymerizable liquid crystalline compound or a monofunctional polymerizable liquid crystalline compound. Also, the liquid crystalline compound may be a discotic liquid crystalline compound or a rod-shaped liquid crystalline compound.

In the optically anisotropic layer, a molecule of the liquid crystalline compound is preferably fixed in any alignment state of vertical alignment, horizontal alignment, hybrid alignment and inclined alignment. In order to prepare a retardation plate having symmetrical viewing angle dependence, it is preferred that a disc plane of the discotic liquid crystalline compound is substantially vertical to the film plane (optically anisotropic layer plane) or that a long axis of the rod-shaped liquid crystalline compound is substantially horizontal to the film plane (optically anisotropic layer plane). The term “discotic liquid crystalline compound is substantially vertical” as used herein means that an average value of angles between the film plane (optically anisotropic layer plane) and the disc plane of the discotic liquid crystalline compound is within a range from 70 to 90°. The average value of angles is more preferably from 80 to 90°, and still more preferably from 85 to 90°. The term “rod-shaped liquid crystalline compound is substantially horizontal” as used herein means that an average value of angles between the film plane (optically anisotropic layer plane) and the director of the rod-shaped liquid crystalline compound is within a range from 0 to 20°. The average value of angles is more preferably from 0 to 10°, and still more preferably from 0 to 5°.

In the case of preparing an optical compensation film having asymmetric viewing angle dependence by orienting a molecule of the liquid crystalline compound in a hybrid alignment, an average tilt angle of the director of the liquid crystalline compound is preferably from 5 to 85°, more preferably from 10 to 80°, and still more preferably from 15 to 75°.

The optical film has the optically anisotropic layer containing a liquid crystalline compound and the optically anisotropic layer may be composed of a single layer or may be a laminate of two or more optically anisotropic layers.

The optically anisotropic layer can be formed by coating on a support a coating solution containing a liquid crystalline compound, for example, a rod-shaped liquid crystalline compound or a discotic liquid crystalline compound and, if desired, a polymerization initiator, an alignment controlling agent and other additives described hereinafter. It is preferred to form the optically anisotropic layer by forming an alignment film on the support and then coating the above-described coating solution on the surface of the alignment film.

In the present invention, the optically anisotropic layer is preferably formed of a composition containing a liquid crystalline compound in a solid concentration of 80% by mass or more, preferably 85% by mass or more, and still more preferably 93% by mass or more. By setting the content within this range, it is preferred in that the optically anisotropic layer has a great improvement effect of the adhesion when combining with the low refractive index layer in the present invention.

### [Discotic Liquid Crystalline Compound]

In the invention, it is preferred to use a discotic liquid crystalline compound in the formation of the optically anisotropic layer of the optical film. The discotic liquid crystalline compound is described in various documents (C. Destrade, et al., Mol. Crysr. Liq. Cryst., Vol. 71, page 111 (1981), The Chemical Society of Japan, Kikan Kagaku Sousetu (Quarterly Journal of Chemistry Review), No. 22, Ekisho no Kagaku (Chemistry of Liquid Crystal), Chap. 5, Chap. 10, Sec. 2 (1994), B. Kohne, et al., Angew. Chem. Soc. Chem. Comm., page 1794 (1985), and J. Zhang, et al., J. Am. Chem. Soc., Vol. 116, page 2655 (1994)). Polymerization of the discotic liquid crystalline compound is described in JP-A-8-27284.

Specific examples of the discotic liquid crystalline compound which can be preferably used in the invention include compounds described in Paragraph Nos. [0038] to [0069] of JP-A-2009-97002. Also, a triphenylene compound which is a discotic liquid crystalline compound having a small wavelength dispersion includes, for example, compounds described in Paragraph Nos. [0062] to [0067] of JP-A-2007-108732.

### [Rod-Shaped Liquid Crystalline Compound]

In the invention, a rod-shaped liquid crystalline compound may be used. As the rod-shaped liquid crystalline compound, an azomethine, an azoxy, a cyano biphenyl, a cyano phenyl ester, a benzoic acid ester, a cyclohexanecarboxylic acid phenyl ester, a cyanophenylcyclohexane, a cyano-substituted phenylpyrimidine, an alkoxy-substituted phenylpyrimidine, a phenyldioxane, a tolane and an alkenylcyclohexylbenzonitrile are preferably used. Not only the low molecular liquid crystalline compound as described above, but also a high molecular liquid crystalline compound can be used. It is more preferred to fix the alignment by polymerization of the rod-shaped liquid crystalline compound. A liquid crystalline compound having a partial structure capable of undergoing polymerization or a crosslinking reaction with active light, an electron beam, heat or the like can be preferably used. The number of such partial structures is preferably from 1 to 6, and more preferably from 1 to 3. As a polymerizable rod-shaped liquid crystalline compound, compounds described, for example, in Makromol. Chem., Vol. 190, page 2255 (1989), Advanced Materials, Vol. 5, page 107 (1993), U.S. Pat. Nos. 4,683,327, 5,622,648 and 5,770,107, WO95/22586, WO95/24455, WO97/00600, WO98/23580, WO98/52905, JP-A-1-272551, J-A-6-16616, JP-A-7-110469, JP-A-11-80081 and JP-A-2001-328973 can be used.

### [Vertical Alignment Accelerating Agent]

In order to uniformly align molecules of the liquid crystalline compound vertically in the formation of the optically anisotropic layer, it is preferred to use an alignment controlling agent capable of vertically controlling alignment of the liquid crystalline compound both on an alignment film interface side and on an air interface side. For this purpose, it is preferred to form the optically anisotropic layer by using a composition containing a compound which exerts the action of vertically aligning the liquid crystalline compound on the alignment film upon an exclusion volume effect, an electrostatic effect or a surface energy effect together with the liquid crystalline compound. With respect to the control of the alignment on the air interface side, it is preferred to form the optically anisotropic layer by using a composition containing a compound which is localized on the air interface side at the time of alignment of the liquid crystalline compound and exerts the action of vertically aligning the liquid crystalline compound upon an exclusion volume effect, an electrostatic effect or a surface energy effect together with the liquid crystalline compound. As the compound (alignment film interface side vertical alignment agent) which accelerates vertical alignment of the molecules of the liquid crystalline compound on the alignment film interface side, a pyridinium derivative can be preferably used. As the compound (air interface side vertical alignment agent) which accelerates vertical alignment of the molecules of the liquid crystalline compound on the air interface side, a compound containing a fluoroaliphatic group which accelerates the localization of the compound on the air interface side and one or more hydrophilic groups selected from a carboxyl group (—COOH), a sulfo group (—SO₃H), a phosphonoxy group {—OP(═O)(OH)₂} and the salts thereof is preferably used. Further, for example, in the case of preparing a coating solution of the crystalline compound, by adding the compound a coating property of the coating solution is improved to inhibit the generation of unevenness and repelling. The vertical alignment agent will be described in detail below.

### [Alignment Film Interface Side Vertical Alignment Agent]

As the alignment film interface side vertical aligning agent for use in the invention, a pyridinium derivative (pyridinium salt) can be preferably used. Specific examples of the compound include compounds described in Paragraph Nos. [0058] to [0061] of JP-A-2006-113500.

The content of the pyridinium derivative in the composition for forming the optically anisotropic layer may be varied depending on its use and is preferably from 0.005 to 8% by weight, more preferably from 0.01 to 5% by weight, in the composition (a liquid crystalline composition excluding a solvent in the case of preparing the composition as a coating solution).

### [Air Interface Side Vertically Aligning Agent]

As the air interface side vertically aligning agent in the invention, a fluorine-based polymer (containing a repeating unit represented by formula (II) as a partial structure) or a fluorine-containing compounds represented by formula (III) is preferably used.

First, the fluorine-based polymer (containing a repeating unit represented by formula (II) as a partial structure) will be described. As for the air interface side vertically aligning agent in the invention, the fluorine-based polymer is preferably a copolymer containing a repeating unit derived from a fluoroaliphatic group-containing monomer and a repeating unit represented by formula (II) shown below.

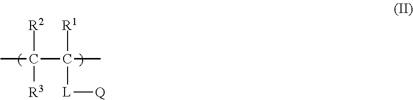

In formula (II), R¹, R², and R³ each independently represents a hydrogen atom or a substituent, L represents a divalent connecting group selected from Group of connecting groups shown below or a divalent connecting group formed by combining two or more groups selected from Group of connecting groups shown below,

### (Group of Connecting Groups):

[a single bond, —O—, —CO—, —NR⁴— (wherein R⁴ represents a hydrogen atom, an alkyl group, an aryl group or an aralkyl group), —S—, —SO₂—, —P(═O)(OR⁵)— (wherein R⁵ represents an alkyl group, an aryl group or an aralkyl group), an alkylene group and an arylene group]
Q represents a carboxyl group (—COOH) or its salt, a sulfo group (—SO₃H) or its salt or a phosphonoxy group {—OP(═O)(OH)₂} or its salt.

The fluorine-based polymer which can be used in the invention is characterized in that it contains a fluoroaliphatic group and one or more hydrophilic groups selected from the group consisting of a carboxyl group (—COOH), a sulfo group (—SO₃H), a phosphonoxy group {-OP(═O)(OH)₂} and salts thereof. As to the kind of the polymer, descriptions are made on pages 1 to 4 in Kaitei Kobunshi Gousei no Kagaku (Revised Chemistry of Polymer Synthesis) written by Takayuki Otsu, published by Kagaku-dojin Publishing Company, Inc (1968). Examples thereof include a polyolefin, a polyester, a polyamide, a polyimide, a polyurethane, a polycarbonate, a polysulfone, a polyether, a polyacetal, a polyketone, a polyphenylene oxide, a polyphenylene sulfide, a polyarylate, a PTFE, a polyvinylidene fluoride and a cellulose derivative. The fluorine-based polymer is preferably a polyolefin.

The fluorine-based polymer is a polymer having the fluoroaliphatic group in its side chain. The fluoroaliphatic group contains preferably from 1 to 12 carbon atoms, and more preferably from 6 to 10 carbon atoms. The aliphatic group may be a chain structure or a cyclic structure, and the chain structure may be straight-chain or branched. Among them, a straight-chain fluoroaliphatic group having from 6 to 10 carbon atoms is preferred. The substitution degree of the fluoroaliphatic group with fluorine atoms is not particularly limited and is preferably such that 50% or more of the hydrogen atoms in the aliphatic group are substituted with fluorine atoms, and more preferably such that 60% or more of the hydrogen atoms in the aliphatic group are substituted with fluorine atoms. The fluoroaliphatic group is included in side chain connected to the main chain through, for example, an ester bond, an amido bond, an imido bond, a urethane bond, a urea bond, an ether bond, a thioether bond or an aromatic ring.

Specific examples of the fluoroaliphatic group-containing copolymer preferably used in the invention as the fluorine-based polymer include compounds described in Paragraph Nos. [0110] to [0114] of JP-A-2006-113500, but the invention should not be construed as being limited thereto.

The weight average molecular weight of the fluorine-based polymer for use in the invention is preferably 1,000,000 or less, more preferably 500,000 or less, and still more preferably 100,000 or less. In the range described above, alignment control of the liquid crystalline compound is effectively achieved while maintaining sufficient solubility. The weight average molecular weight can be determined as a value in terms of polystyrene (PS) using gel permeation chromatography (GPC).

It is also preferred that the fluorine-based polymer according to the invention has a polymerizable group as a substituent for fixing the alignment state of a discotic liquid crystalline compound.

A preferred range of the content of the fluorine-based polymer in the composition may vary depending on its use, and in the case of using for forming the optically anisotropic layer, the content (composition excluding a solvent in the case of preparing the composition as a coating solution) is preferably from 0.005 to 8% by weight, more preferably from 0.01 to 5% by weight, and still more preferably from 0.05 to 3% by weight. When the content of the fluorine-based polymer is less than 0.005% by weight, the effect is insufficient whereas, when the content exceeds 8% by weight, drying of the coated film becomes insufficient and detrimental influences are exerted on performance as the optical film (for example, uniformity of retardation).

The fluorine-containing compound represented by formula (III) shown below will be described.

(R⁰)ₘ-L⁰-(W)ₙ Formula (III)

In formula (III), R⁰ represents an alkyl group, an alkyl group having a CF₃ group at the terminal or an alkyl group having a CF₂H group at the terminal, and m represents an integer of 1 or more. When m is 2 or more, two or more R⁰ may be the same or different from each other, provided that at least one represents an alkyl group having a CF₃ group or a CF₂H group at the terminal. L⁰ represents an (m+n) valent connecting group, W represents a carboxyl group (—COOH) or its salt, a sulfo group (—SO₃H) or its salt or a phosphonoxy group {—OP(═O)(OH)₂} or its salt, and n represents an integer of 1 or more.

Specific examples of the fluorine-containing compound represented by formula (III) which can be used in the invention include compounds described in Paragraph Nos. [0136] to [0140] of JP-A-2006-113500, but the invention should not be construed as being limited thereto.

It is also preferred that the fluorine-containing compound according to the invention has a polymerizable group as a substituent for fixing the alignment state of a discotic liquid crystalline compound.

A preferred range of the content of the fluorine-containing compound in the composition may vary depending on its use, and in the case of using for forming the optically anisotropic layer, the content (composition excluding a solvent in the case of preparing the composition as a coating solution) is preferably from 0.005 to 8% by weight, more preferably from 0.01 to 5% by weight, and still more preferably from 0.05 to 3% by weight.

### [Polymerization Initiator]

The aligned (preferably vertically aligned) liquid crystalline compound is fixed while maintaining the alignment state. Fixation is preferably conducted by a polymerization reaction of a polymerizable group (P) introduced into the liquid crystalline compound. The polymerization reaction includes a thermal polymerization reaction using a thermal polymerization initiator and a photopolymerization reaction using a photopolymerization initiator. The photopolymerization reaction is preferred. Examples of the photopolymerization initiator include an α-carbonyl compound (described in U.S. Pat. Nos. 2,367,661 and 2,367,670), an acyloin ether (described in U.S. Pat. No. 2,448,828), an α-hydrocarbon-substituted aromatic acyloin compound (described in U.S. Pat. No. 2,722,512), a polynuclear quinone compound (described in U.S. Pat. Nos. 3,046,127 and 2,951,758), a combination of triarylimidazole dimer and p-aminophenyl ketone (described in U.S. Pat. No. 3,549,367), an acridine or phenazine compound (described in JP-A-60-105667 and U.S. Pat. No. 4,239,850) and an oxadiazole compound (described in U.S. Pat. No. 4,212,970).

The amount of the photopolymerization initiator used is preferably from 0.01 to 20% by weight, more preferably from 0.5 to 5% by weight, based on the solid content of the coating solution. Light irradiation for the polymerization of liquid crystalline molecule is preferably conducted using an ultraviolet ray. The irradiation energy is preferably from 20 mJ/cm² to 50 J/cm², and more preferably from 100 to 800 mJ/cm². In order to accelerate the photopolymerization reaction, the light irradiation may be conducted under heating condition or at a low oxygen concentration of 0.1% or less. The thickness of the optically anisotropic layer containing the liquid crystalline compound is preferably from 0.1 to 10 μm, more preferably from 0.5 to 5 μm, and most preferably from 1 to 5 μm.

### [Other Additives to Optically Anisotropic Layer]

A plasticizer, a surfactant, a polymerizable monomer or the like may be used together with the liquid crystalline compound described above to improve uniformity of the coated film, film strength, alignment property of the liquid crystalline compound or the like. The materials preferably have compatibility with the liquid crystalline compound so as not to inhibit alignment.

The polymerizable monomer includes a radical polymerizable or cation polymerizable compound. A polyfunctional radical polymerizable monomer is preferred, and the monomer which is copolymerizable with the polymerizable group-containing liquid crystalline compound described above is preferred. For example, those described in Paragraph Nos. [0018] to [0020] of JP-A-2002-296423 are exemplified. The amount of the polymerizable monomer added is ordinarily in a range from 1 to 50% by weight, preferably in a range from 5 to 30% by weight, based on the weight of the liquid crystalline compound.

The surfactant includes conventionally known compounds and is preferably a fluorine-based compound. Specifically, for example, compounds described in Paragraph Nos. [0028] to [0056] of JP-A-2001-330725 and Paragraph Nos. [0069] to [0126] of Japanese Patent Application No. 2003-295212 are exemplified.

The polymer used together with the liquid crystalline compound preferably can thicken the coating solution. Examples of the polymer include a cellulose ester. Preferred examples of the cellulose ester include those described in Paragraph No. [0178] of JP-A-2000-155216. The amount of the polymer added is preferably in a range from 0.1 to 10% by weight, more preferably in a range from 0.1 to 8% by weight, based on the weight of the liquid crystalline compound so as not to inhibit alignment of the liquid crystalline compound.

The discotic nematic liquid crystal phase-solid phase transition temperature of the liquid crystalline compound is preferably from 70 to 300° C., and more preferably from 70 to 170° C.

### [Coating Solvent]

As a solvent for use in the preparation of the coating solution, an organic solvent is preferably used. Examples of the organic solvent include an amide (for example, N,N-dimethylformamide), a sulfoxide (for example, dimethylsulfoxide), a heterocyclic compound (for example, pyridine), a hydrocarbon (for example, benzene or hexane), an alkyl halide (for example, chloroform or dichloromethane), an ester (for example, methyl acetate, ethyl acetate or butyl acetate), a ketone (for example, acetone or methyl ethyl ketone) and an ether (for example, tetrahydrofuran or 1,2-dimethoxyethane). Among them, an alkyl halide and a ketone are preferred. Two or more organic solvents may be used in combination.

### [Coating Method]

Coating of the coating solution can be conducted according to a known method (for example, a wire bar coating method, an extrusion coating method, a direct gravure coating method, a reverse gravure coating method or a die coating method).

### [Alignment Film]

In the invention, it is preferred to coat the composition described above on the surface of an alignment film to align molecules of the liquid crystalline compound. Since the alignment film has the function of regulating alignment direction of the liquid crystalline compound, it is preferred to utilize the alignment film to realize a preferred embodiment of the invention. However, after fixing the alignment state of the liquid crystalline compound, the alignment film is not always necessary as a constituent element of the invention since the alignment film has already served its purpose. Specifically, it is possible to transfer only the optically anisotropic layer in which the alignment state has been fixed on the alignment film to a different transparent support to prepare an optical base material for the optical film according to the invention.

The alignment film can be prepared, for example, by means of a rubbing treatment of an organic compound (preferably a polymer), oblique evaporation of an inorganic compound, formation of a layer having microgroove or accumulation of organic compound (for example, ω-tricosanic acid, dioctadecylmethylammonium chloride or methyl stearate) by a Langmuir-Blodgett method (LB film). Further, an alignment film which exhibits an alignment function upon application of electric field, application of magnetic field or light irradiation is also known.

The alignment film is preferably formed by a rubbing treatment of a polymer.

Examples of the polymer include a methacrylate copolymer, a styrene copolymer, a polyolefin, polyvinyl alcohol and a modified polyvinyl alcohol, poly(N-methylolacrylamide), a polyester, a polyimide, a vinyl acetate copolymer, carboxymethyl cellulose and a polycarbonate described in Paragraph No. [0022] of JP-A-8-338913. It is possible to use a silane coupling agent as the polymer. A water-soluble polymer (for example, poly(N-methylolacrylamide), carboxymethyl cellulose, gelatin, polyvinyl alcohol or a modified polyvinyl alcohol) is preferred, gelatin, polyvinyl alcohol or a modified polyvinyl alcohol is more preferred, and polyvinyl alcohol or a modified polyvinyl alcohol is most preferred.

The saponification degree of polyvinyl alcohol is preferably from 70 to 100%, and more preferably from 80 to 100%. The polymerization degree of polyvinyl alcohol is preferably from 100 to 5,000.

In the alignment film, it is preferred to connect a side chain having a crosslinkable functional group (for example, a double bond) to a main chain or to introduce into a side chain a crosslinkable functional group having the function of aligning the liquid crystalline molecule. As the polymer used in the alignment film, either of a polymer which itself can undergo crosslinking and a polymer which can be crosslinked with a crosslinking agent can be used, and a combination of plural of them can be used.

It is possible to copolymerize the polymer in the alignment film and the polyfunctional monomer in the optically anisotropic layer, when the polymer in the alignment film has a main chain connecting to a side chain containing a crosslinkable functional group or when a crosslinkable functional group is introduced into a side chain having a function of aligning liquid crystalline molecule. In such a case, not only between the polyfunctional monomer and the polyfunctional monomer but also between the polymer in the alignment film and the polymer in the alignment film and between the polyfunctional monomer and the polymer in the alignment film, strong covalent bonds are formed. Thus, the strength of the optical compensation film can be remarkably improved by introducing a crosslinkable functional group into the polymer in the alignment film.

The crosslinkable functional group of the polymer in the alignment film preferably has a polymerizable group as in the polyfunctional monomer. Specific examples thereof include those described in Paragraph Nos. [0080] to [0100] of JP-A-2000-155216.

The polymer in the alignment film may be crosslinked using a crosslinking agent apart from the crosslinkable functional group. Examples of the crosslinking agent include an aldehyde, an N-methylol compound, a dioxane derivative, a compound to act when its carboxyl group is activated, an active vinyl compound, an active halogen compound, an isoxazole and a dialdehyde starch. Two or more crosslinking agents may be used in combination. Specific examples of the crosslinking agent include compounds described in Paragraph Nos. [0023] to [0024] of JP-A-2002-62426. An aldehyde having a high reactivity is preferred, and glutaraldehyde is particularly preferred.

The amount of the crosslinking agent added is preferably from 0.1 to 20% by weight, more preferably from 0.5 to 15% by weight, based on the weight of the polymer. The amount of the unreacted crosslinking agent remaining in the alignment film is preferably 1.0% by weight or less, and more preferably 0.5% by weight or less. When the amount is controlled within the range described above, the alignment film has sufficient durability without the occurrence of reticulation even when the alignment film is used in a liquid crystal display device for a long period of time or is left under a high temperature and high humidity atmosphere for a long period of time.

The alignment film can be fundamentally formed by coating a solution containing the polymer, the crosslinking agent and the additives described above which are the materials for forming the alignment film on the transparent support, drying with heating (to crosslink) and performing a rubbing treatment. The crosslinking reaction may be conducted at any time after coating the coating solution on the transparent support as described above. In the case of using a water-soluble polymer, for example, polyvinyl alcohol as the material for forming the alignment film, the coating solution is preferably prepared by using a mixed solvent of an organic solvent having a defoaming action (for example, methanol) and water. The weight ratio of water/methanol is preferably from 0/100 to 99/1, and more preferably from 0/100 to 91/9. By using such a mixed solvent, the generation of bubble is prevented and defects in the surface of the alignment film and further the optically anisotropic layer can be remarkably reduced.

The coating method utilized at the formation of the alignment film is preferably a spin coating method, a dip coating method, a curtain coating method, an extrusion coating method, a rod coating method or a roll coating method. The rod coating method is particularly preferred. The thickness of the alignment film after drying is preferably from 0.1 to 10 μm. The drying with heating can be conducted at 20 to 110° C. In order to form sufficient crosslinkage, the drying is preferably conducted at 60 to 100° C., and particularly preferably at 80 to 100° C. The drying may be conducted from 1 minute to 36 hours, preferably from 1 to 30 minutes. The pH is preferably set in an optimum range for the crosslinking agent used, and in case of using glutaraldehyde, the pH is preferably from 4.5 to 5.5.

The alignment film is preferably provided on the transparent support. The alignment film can be obtained by crosslinking the polymer layer as described above and then conducting a rubbing treatment on the surface of the polymer layer.

The rubbing treatment can be conducted according to a treating method widely used in a liquid crystal alignment step of LCD. Specifically, a method of attaining alignment by rubbing the surface of the alignment film with paper, gauze, felt, rubber, nylon fiber, polyester fiber or the like in a definite direction can be used. Ordinarily, the rubbing treatment is conducted by rubbing several times with a fabric in which fibers having a uniform length and diameter are implanted averagely.

The composition described above is coated on the rubbing-treated surface of the alignment film to align the molecules of the liquid crystalline compound. Then, if desired, the polymer in the alignment film and the polyfunctional monomer contained in the optically anisotropic layer are reacted or the polymer in the alignment film is crosslinked using a crosslinking agent to form the optically anisotropic layer.

### [Polarizing Plate]

The polarizing plate according to the invention is preferably a polarizing plate having a polarizing film and two protective films for protecting both surfaces of the polarizing film, wherein at least one of the protective films is the optical film according to the invention.

The polarizing film includes an iodine-based polarizing film, a dye-based polarizing film using a dichromatic dye and a polyene-based polarizing film. The iodine-based polarizing film and the dye-based polarizing film can be produced ordinarily using a polyvinyl alcohol film.

A configuration of the polarizing plate wherein the side of the anisotropic layer containing liquid crystalline compound of the optical film is adhered to one side of the polarizing film through an adhesive agent or other base material and a protective film is also provided on the other side of the polarizing film is preferred. A configuration of the polarizing plate wherein the anisotropic layer side of the optical film is adhered to one side of the polarizing film through an adhesive layer is more preferred. In order to improve an adhesion property between the optically anisotropic layer and the polarizing film, the surface of the optically anisotropic layer is preferably subjected to a surface treatment (for example, glow discharge treatment, corona discharge treatment, plasma treatment, ultraviolet ray (UV) treatment, flame treatment, saponification treatment or solvent washing). Also, an adhesive layer (undercoat layer) may be provided on the optically anisotropic layer.

Also, a sticky agent layer may be provided on the side of the other protective film constituting the polarizing plate opposite to the polarizing film.

Use of the optical film according to the invention as a protective film for polarizing plate enables preparation of a polarizing plate having excellent physical strength, antistatic property and durability in addition to the optical performance expected for a λ/4 film or the like.

Also, the polarizing plate according to the invention may have an optical compensation function. In such a case, it is preferred that of the two surface protective films of the polarizing plate, the protective film on only one side of front side and rear side of the polarizing plate is formed using the optical film described above and the protective film on the side opposite to the side having the optical film is the optical compensation film.

### [Image Display Device]

The optical film and polarizing plate according to the invention can be used on the surface of image display device in the use, for example, of organic EL, touch panel, 3D display device or glasses for viewing 3D display device. In particular, it is preferred to use in the 3D display device and it is especially preferred to use in a transmission type liquid crystal display device of field-sequential two eyes stereoscopic vision.

The present invention preferably relates to a liquid crystal display device having the optical film of the present invention, a polarizing film and a liquid crystal cell in this order from the viewing side, in which the optical film is disposed such that a low refractive index layer is at the viewing side, and the optically anisotropic layer is at the polarizing film side.

### EXAMPLES

The characteristics of the invention will be more specifically described with reference to the examples and comparative examples below. The materials, amounts of use, proportions, contents of treatments, treating procedures and the like can be appropriately altered as long as the gist of the invention is not exceeded. Therefore, the scope of the invention should not be construed as being limited to the specific examples described below.

### Example 1

### Preparation of Optical film 101

### <<Formation of Optically Anisotropic Layer Containing Liquid Crystalline Compound>>

(Saponification Treatment with Alkali)

As a transparent support used, TD80UL (produced by FUJIFILM Corp., thickness is 80 μm) was passed between induction heating rolls having a temperature of 60° C. to raise the temperature of the film surface to 40° C., and then an alkali solution having the composition shown below was coated on the band surface of the film in a coating amount of 14 ml/m² using a bar coater. The film was then conveyed for 10 seconds under a steam type far-infrared heater (produced by Noritake Co., Ltd.) heated at 110° C. Then, pure water was coated in an amount of 3 ml/m² using the bar coater. Subsequently, after repeating 3 times the procedures of washing with water by a fountain coater and removing water by an air knife, the film was conveyed through a drying zone of 70° C. for 10 seconds to dry, thereby preparing a cellulose acylate film subjected to the saponification treatment with alkali.

### [Composition of Alkali Solution]

| | |
|---|---|
| Potassium hydroxide | 4.7 parts by weight |
| Water | 15.8 parts by weight |
| Isopropanol | 63.7 parts by weight |
| Surfactant SF-1: C₁₄H₂₉O(CH₂CH₂O)₂₀H | 1.0 parts by weight |
| Propylene glycol | 14.8 parts by weight |

### (Formation of Alignment Film)

A coating solution for alignment film having the composition shown below was continuously coated on the cellulose acetate film of a long-shape subjected to the saponification treatment as described above using a wire bar of #14. The coated film was dried for 60 seconds with hot air of 60° C. and then for 120 seconds with hot air of 100° C.

### [Composition of Coating Solution for Alignment Film]

| | | |
|---|---|---|
| Modified polyvinyl alcohol shown below | 10 | parts by weight |
| Water | 371 | parts by weight |
| Methanol | 119 | parts by weight |
| Glutaraldehyde | 0.5 | parts by weight |
| Photopolymerization initiator | 0.3 | parts by weight |
| (Irgacure 2959 produced by Ciba Japan Co., Ltd.) | | |

Modified polyvinyl alcohol

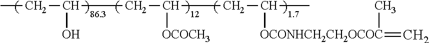

In the above formula, a ratio of repeating units, “86.3”, “12”, and “1.7” is a molar ratio.

Weight average molecular weight (Mw) is 10,000.

### (Formation of Optically Anisotropic Layer Containing Discotic Liquid Crystalline Compound)

The alignment film prepared above was continuously subjected to a rubbing treatment. In the treatment, the longitudinal direction of the film of a long-shape and the conveying direction were parallel and the rotation axis of the rubbing roller was tilted at 45° in the counterclockwise direction with respect to the longitudinal direction of the film.

Coating solution (A) for optically anisotropic layer containing a discotic crystalline compound having the composition shown below was continuously coated on the alignment film prepared above using a wire bar of #3.6. The conveying velocity (V) of the film was adjusted to 36 m/min. The film was heated for 90 seconds with hot air of 120° C. for drying the solvent of the coating solution and alignment ripening of the discotic liquid crystalline compound. Successively, UV irradiation was conducted at 80° C. to fix alignment of the liquid crystalline compound to form an optically anisotropic layer having a thickness of 1.6 μm, and the film was wound up in roll form, thereby obtaining Transparent support 1 having optically anisotropic layer.

Transparent support 1 having optically anisotropic layer thus-prepared had the Re at 550 nm of 125 nm and the Nz value of 0.9. The direction of slow axis was at right angle with the rotation axis of the rubbing roller. That is, the slow axis was in the direction of 45° clockwise with respect to the longitudinal direction of the film. The average tilt angle of the disc plane of the discotic liquid crystalline molecule with respect to the film plane was 90° and it was confirmed that the discotic liquid crystal was vertically aligned with respect to the film plane.

### [Composition of Coating Solution (A) for Optically Anisotropic Layer]

| | | |
|---|---|---|
| Discotic liquid crystalline compound shown below | 91 | parts by weight |
| Acrylate monomer shown below | 5 | parts by weight |
| Photopolymerization initiator | 3 | parts by weight |
| (Irgacure 907, produced by Ciba-Geigy Corp.) | | |
| Sensitizer | 1 | part by weight |
| (KAYACURE DETX, produced by Nippon Kayaku Co., Ltd.) | | |
| Pyridinium salt shown below | 0.5 | parts by weight |
| Fluorine-based polymer (FP1) shown below | 0.2 | parts by weight |
| Fluorine-based polymer (FP3) shown below | 0.1 | parts by weight |
| Methyl ethyl ketone | 252 | parts by weight |

Discotic liquid crystalline compound 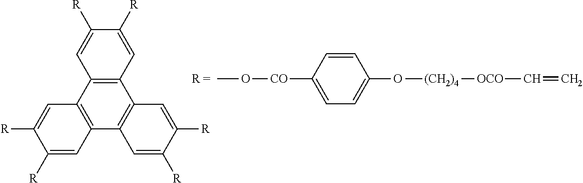
Acylate monomer
Ethyleneoxide-modified trimethylolpropane triacrylate
(Viscoat #360, produced by Osaka Organic Chemical Industry Ltd.)
Pyridinium salt 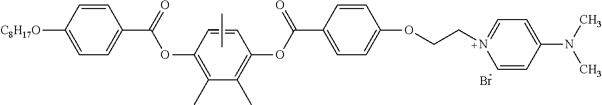
Fluorine-based polymer (FP1) 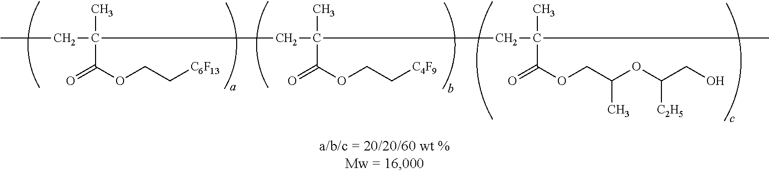
Fluorine-based polymer (FP3)

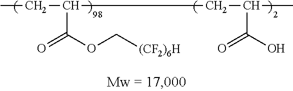

In the above formula, a ratio of the repeating units, “98:2” is a mass ratio.

### <Formation of Antireflective Layer>

### (Preparation of Composition (A) for Hardcoat Layer)

The composition shown below was charged into a mixing tank and the mixture was stirred and filtered through a filter made of polypropylene having a pore size of 0.4 μm to prepare Composition (A) for hardcoat layer (solid content concentration: 58% by weight).

| | | |
|---|---|---|
| Methyl acetate | 36.2 | parts by weight |
| Methyl ethyl ketone | 36.2 | parts by weight |
| (a) Monomer: PETA | 77.0 | parts by weight |
| (b) Monomer: Urethane acrylate monomer | 20.0 | parts by weight |
| Photopolymerization initiator | 3.0 | parts by weight |
| (Irgacure 184, produced by Ciba Specialty | | |
| Chemicals Inc.) | | |
| Leveling agent (SP-13) | 0.02 | parts by weight |

The compounds used above are described below.
Leveling agent (SP-13)

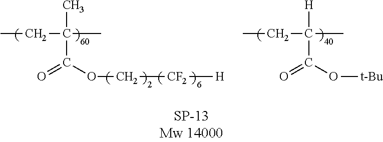

In the above formula, a ratio of the repeating units, “60:40” is a mass ratio.

PETA: Compound having the structure shown below, weight average molecular weight: 325, number of functional groups per molecule: 3.5 (average value), produced by Shin-Nakamura Chemical Co., Ltd.

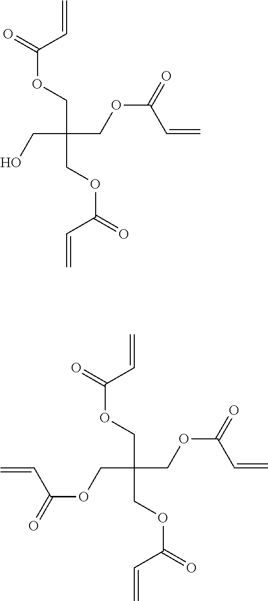

Urethane acrylate monomer: Compound having the structure shown below, weight average molecular weight: 596, number of functional groups per molecule: 4

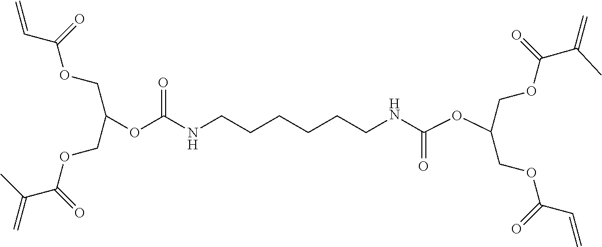 [SMILES: C=CC(=O)OCC(COC(=O)C(=C)C)OC(=O)NCCCCCCNC(=O)OC(COC(=O)C=C)COC(=O)C(=C)C]

### <Preparation of Composition for Low Refractive Index Layer>

### (Synthesis of Fluorine-Containing Polymer A (Methacryl-Modified Fluorine Polymer) Having Ethylenically Unsaturated Group)

First, synthesis of a fluorine polymer having hydroxy group was conducted. After thoroughly purging a 2.0 liter content stainless steel autoclave equipped with an electromagnetic stirrer with nitrogen gas, 400 g of ethyl acetate, 53.2 g of perfluoro(propyl vinyl ether), 36.1 g of ethyl vinyl ether, 44.0 g of hydroxyethyl vinyl ether, 1.00 g of lauroyl peroxide, 6.0 g of azo group-containing polydimethylsiloxane represented by formula (7) shown below (VPS 1001 (trade name), produced by Wako Pure Chemical Industries, Ltd.) and 20.0 g of a nonionic reactive emulsifier (NE-30 (trade name), produced by ADEKA Corp.) were charged therein. The mixture was cooled to −50° C. with dry ice-methanol, and the autoclave was again purged with nitrogen gas to remove oxygen from the system.

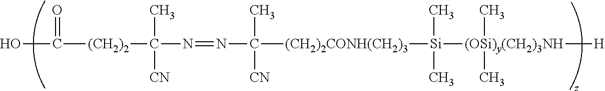

(7)

In formula (7), y represents from 10 to 500, and z represents from 1 to 50.

Next, 120.0 g of hexafluoropropylene was charged in the autoclave, and the temperature of the autoclave was raised. When the inner temperature of autoclave reached 60° C., the pressure was 5.3×10⁵ Pa. The reaction was continued at 70° C. for 20 hours with stirring. When the pressure decreased to 1.7×10⁵ Pa, the autoclave was cooled with water to cease the reaction. After the temperature reached room temperature, the unreacted monomers were released, and the autoclave was opened to collect a polymer solution having a solid content concentration of 26.4% by weight. The polymer solution obtained was poured into methanol to precipitate the polymer, and the polymer was washed with methanol and dried in vacuo at 50° C. to obtain 220 g of a fluorine polymer having hydroxy group. The monomers and solvent used are shown in Table 1.

TABLE 1

| | Fluorine-containing polymer |
|---|---|
| | containing hydroxyl group |
| Monomer and Solvent | (Amount Used (g)) |
| Hexafluoropropylene | 120.0 |
| Perfluoro(propyl vinyl ether) | 53.2 |
| Ethyl vinyl ether | 36.1 |
| Hydroxyethyl vinyl ether | 44.0 |
| Lauroyl peroxide | 1.0 |
| VPS 1001 | 6.0 |
| NE-30 | 20.0 |
| Ethyl acetate | 400.0 |

With the fluorine polymer having hydroxy group, a number average molecular weight was determined by gas permeation chromatography and calculated in terms of polystyrene. Also, the ratio of the monomer units constituting the fluorine polymer having hydroxy group was determined based on the NMR analysis results of ¹H-NMR and ¹³C-NMR. The results obtained are shown in Table 2.

TABLE 2

| | Fluorine-containing |
|---|---|
| | polymer |
| | containing hydroxyl group |
| Monomer | (% by mole) |
| Hexafluoropropylene | 41.1 |
| Perfluoro(propyl vinyl ether) | 10.0 |
| Ethyl vinyl ether | 20.9 |
| Hydroxyethyl vinyl ether | 24.8 |
| NE-30 | 0.8 |
| Polydimethylsiloxane skeleton (% by mole) | 2.4 |
| Number average molecular weight | 34,000 |

VPS 1001 was an azo group-containing polydimethylsiloxane represented by formula (7) shown above having a number average molecular weight of about 60,000 and a molecular weight of polysiloxane portion of about 10,000.

Then, using the fluorine polymer having hydroxy group thus-obtained, Fluorine-containing polymer A having ethylenically unsaturated group was synthesized. In a one-liter content separable flask equipped with an electromagnetic stirrer, a glass condenser and a thermometer were charged 50.0 g of the fluorine polymer having hydroxy group, 0.01 g of 2,6-di-tert-butylmethylphenol as a polymerization inhibitor and 370 g of methyl isobutyl ketone (MIBK), and the mixture was stirred at 20° C. until the fluorine polymer having hydroxy group dissolved in MIBK to provide a transparent and uniform solution.

Next, to the solution was added 15.1 g of 2-methacryloyloxyethyl isocyanate and stirred until the solution became uniform. Then, 0.1 g of dibutyltin dilaurate was added thereto to initiate the reaction. The stirring was continued for 5 hours while maintaining the temperature of system at 55 to 65° C. to obtain an MIBK solution of Fluorine-containing polymer A having ethylenically unsaturated group.

On an aluminum dish was weighed 2 g of the resulting solution and the solution was dried on a hot plate of 150° C. for 5 minutes and weighed. The solid content determined was 15.2% by weight. The compounds and solvent used and the solid content are shown in Table 3.

TABLE 3

| | Fluorine-containing polymer |
|---|---|
| | containing ethylenically |
| | unsaturated group |
| Compound and Solvent | Amount Used (g) |
| Fluorine polymer having hydroxy group | 50.0 |
| 2-Methacryloyloxyethyl isocyanate | 15.1 |
| 2,6-Di-tert-butylmethylphenol | 0.01 |
| Dibutyltin dilaurate | 0.1 |
| Methyl isobutyl ketone | 370 |
| Amount of 2-methacryloyloxyethyl | 1.1 |
| isocyanate to content of hydroxy group | |
| in fluorine polymer having hydroxy group | |
| Solid content (% by weight) | 15.2 |

Preparation of Hollow Silica Dispersion

(Preparation of Dispersion R-1)

Silica fine particles having a cavity therein were prepared in the same manner as in Preparative Example 4 of Japanese Patent Application Laid-Open No. 2002-79616, except that some of the preparation conditions were changed. In the final step, the hollow silica fine particles in the state of an aqueous dispersion were solvent exchanged with methanol to prepare 20% by mass of a silica dispersion containing the silica particles having an average particle size of 45 nm, a shell thickness of about 7 nm and a refractive index of 1.30. This is referred to as a silica dispersion (A-1).

20 parts by mass of acryloyloxypropyltrimethoxysilane and 1.5 parts by mass of diisopropoxy aluminum ethyl acetate were added to and mixed with 500 parts by mass of the dispersion (A-1), and 9 parts by weights of ion-exchanged water was added thereto. The mixture was allowed to react at 60° C. for 8 hours. The reaction mixture was cooled to room temperature, and 1.8 parts by mass of acetyl acetone was added. The mixture was solvent exchanged by distillation under reduced pressure while continuously adding MEK (methyl ethyl ketone) in such an amount that the total amount of the solution was maintained almost constant. The final solids content were adjusted to 20% by mass to obtain a dispersion R-1.

(Preparation of Dispersion R-5)

A hollow silica dispersion R-5 having an average particle size of 25 nm and a refractive index of 1.41 was obtained in the same manner as in the dispersion R-1, except that the particle size was changed.

(Preparation of Dispersion R-6)

A hollow silica dispersion R-6 having an average particle size of 60 nm and a refractive index of 1.25 was obtained in the same manner as in the dispersion R-1, except that the particle size was changed.

TABLE 4

| Compo- | Fluorine- | Monomer 1 | | Monomer 2 | | Initiator | | Inorganic fine particles A | | | Inorganic fine particles B | | | Antifoulant | | |
|---|---|---|---|---|---|---|---|---|---|---|---|---|---|---|---|---|
| sition | containing | | Con- | | Con- | | Con- | | | Con- | | | Con- | | Con- | |
| for low | polymer A | | tent | | tent | | tent | | Average | tent | | Average | tent | | tent | |
| refractive | (% | | (% | | (% | | (% | | particle | (% | | particle | (% | | (% | |
| index | by | | by | | by | | by | | size | by | | size | by | | by | |
| layer | mass) | Kind | mass) | Kind | mass) | Kind | mass) | Kind | (nm) | mass) | Kind | (nm) | mass) | Kind | mass) | Remark |
| LL-1 | 26 | PET-30 | 8 | B-1 | 15 | Irg. | 3 | R-1 | 45 | 40 | R-2 | 85 | 5 | A/B/C | 1/1/1 | Ex. |
| | | | | | | 127 | | | | | | | | | | |
| LL-2 | 21 | PET-30 | 8 | B-1 | 15 | Irg. | 3 | R-1 | 45 | 40 | R-2 | 85 | 10 | A/B/C | 1/1/1 | Ex. |
| | | | | | | 127 | | | | | | | | | | |
| LL-3 | 30 | PET-30 | 8 | B-1 | 15 | Irg. | 3 | R-1 | 45 | 40 | R-2 | 85 | 1 | A/B/C | 1/1/1 | Comp. |
| | | | | | | 127 | | | | | | | | | | Ex. |
| LL-4 | 31 | PET-30 | 8 | B-1 | 15 | Irg. | 3 | R-1 | 45 | 40 | R-2 | 85 | 0 | A/B/C | 1/1/1 | Comp. |
| | | | | | | 127 | | | | | | | | | | Ex. |
| LL-5 | 11 | PET-30 | 8 | B-1 | 15 | Irg. | 3 | R-1 | 45 | 40 | R-2 | 85 | 20 | A/B/C | 1/1/1 | Comp. |
| | | | | | | 127 | | | | | | | | | | Ex. |
| LL-6 | 21 | PET-30 | 8 | B-1 | 15 | Irg. | 3 | R-1 | 45 | 40 | R-3 | 150 | 10 | A/B/C | 1/1/1 | Comp. |
| | | | | | | 127 | | | | | | | | | | Ex. |
| LL-7 | 21 | PET-30 | 8 | B-1 | 15 | Irg. | 3 | R-1 | 45 | 40 | R-4 | 50 | 10 | A/B/C | 1/1/1 | Comp. |
| | | | | | | 127 | | | | | | | | | | Ex. |
| LL-8 | — | DPHA | 44 | — | — | Irg. | 3 | R-1 | 45 | 40 | R-2 | 85 | 10 | A/B/C | 1/1/1 | Ex. |
| | | | | | | 127 | | | | | | | | | | |
| LL-9 | — | DPHA | 44 | — | — | Irg. | 3 | R-1 | 45 | 40 | R-2 | 85 | 10 | D | 3 | Ex. |
| | | | | | | 127 | | | | | | | | | | |
| LL-10 | — | DPHA | 44 | — | — | Irg. | 3 | R-5 | 25 | 40 | R-2 | 85 | 10 | A/B/C | 1/1/1 | Comp. |
| | | | | | | 127 | | | | | | | | | | Ex. |
| LL-11 | — | DPHA | 74 | — | — | Irg. | 3 | R-1 | 45 | 10 | R-2 | 85 | 10 | A/B/C | 1/1/1 | Comp. |
| | | | | | | 127 | | | | | | | | | | Ex. |
| LL-12 | 21 | PET-30 | 8 | B-1 | 15 | Irg. | 3 | R-6 | 60 | 40 | R-2 | 85 | 10 | A/B/C | 1/1/1 | Ex. |
| | | | | | | 127 | | | | | | | | | | |
| LL-13 | 26 | PET-30 | 8 | B-1 | 15 | Irg. | 3 | R-1 | 45 | 40 | R-7 | 98 | 5 | A/B/C | 1/1/1 | Ex. |
| | | | | | | 127 | | | | | | | | | | |
| LL-14 | 16 | PET-30 | 8 | B-2 | 20 | Irg. | 3 | R-1 | 45 | 40 | R-2 | 85 | 10 | A/B/C | 1/1/1 | Ex. |
| | | | | | | 127 | | | | | | | | | | |
| LL-15 | 16 | PET-30 | 8 | B-3 | 20 | Irg. | 3 | R-1 | 45 | 40 | R-2 | 85 | 10 | A/B/C | 1/1/1 | Ex. |
| | | | | | | 127 | | | | | | | | | | |
| LL-16 | 16 | PET-30 | 8 | B-4 | 20 | Irg. | 3 | R-1 | 45 | 40 | R-2 | 85 | 10 | A/B/C | 1/1/1 | Ex. |
| | | | | | | 127 | | | | | | | | | | |

Each material was mixed as shown in Table 4, and a solvent of MEK/PGMEA (propylene glycol monomethyl ether acetate) (molar ratio: 8/2) was added until the solid concentration becomes 5% by mass. The resulting solution was introduced into a glass separable flask equipped with a stirrer, stirred at room temperature for 1 hour, and then, filtrated by a depth filter of polypropylene having a pore size of 0.5 μm to obtain coating liquids (LL-1 to LL16) for a low refractive index layer.

Hereinafter, materials used in Examples will be described.

R-2: MEK-ST-ZL (Colloidal silica, average particle size: about 85 nm, manufactured by Nissan Chemical Industries, Ltd.)

R-3: Silica sol (MEK-ST-ZL having different average particle sizes, average particle size: 150 nm)

R-4: Silica sol (MEK-ST-ZL having different average particle sizes, average particle size: 50 nm)

R-7: Silica sol (MEK-ST-ZL having different average particle sizes, average particle size: 98 nm)

The average particle size of the inorganic fine particles was determined by observing and photographing the cross-section of the optical film by a transmission electron microscope, determining the particle size distribution of 400 particles in the low refractive index layer, and taking the particle size in which the number of particles is a peak.

Antifoulant A: Rad2600 (manufactured by EVONIK Industries, number average molecular weight: 16,000, composed of the structural unit represented by the following Formula (17) and the structural unit represented by the following Formula (18), and having 6 structural units represented by the following Formula (18))

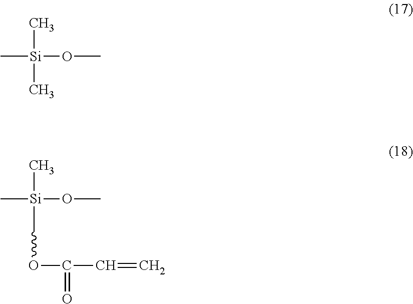

Antifoulant B: Rad2500 (manufactured by EVONIK Industries, number average molecular weight: 1,500, composed of the structural unit represented by Formula (17) and the structural unit represented by Formula (18), and having 2 structural units represented by the Formula (18))

PET-30: a mixture of pentaerythritol triacrylate and pentaerythritol tetraacrylate, manufactured by NIPPON KAYAKU Co., Ltd.

DPHA: a mixture of dipentaerythritol pentaacrylate and dipentaerythritol hexaacrylate, manufactured by NIPPON KAYAKU Co., Ltd.

B-1: acrylic modified perfluoropropylene oxide: a compound wherein R^{b}═H in the following Formula

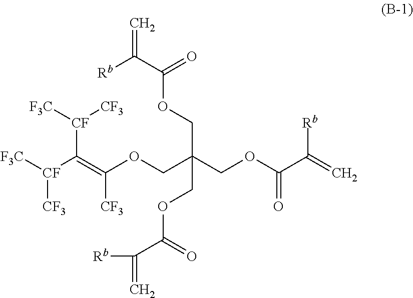

B-2: the following compound M-1 described in Japanese Patent Application Laid-Open No. 2006-284761

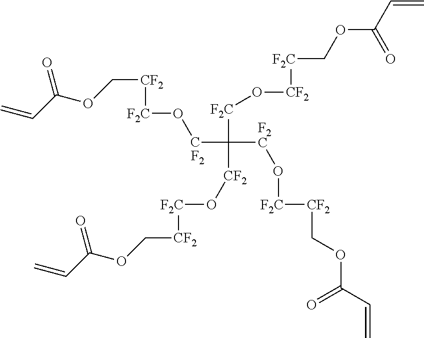

B-3: a compound MA13 described in the specification

B-4: the following compound X-22 described in Japanese Patent Application Laid-Open No. 2006-28409

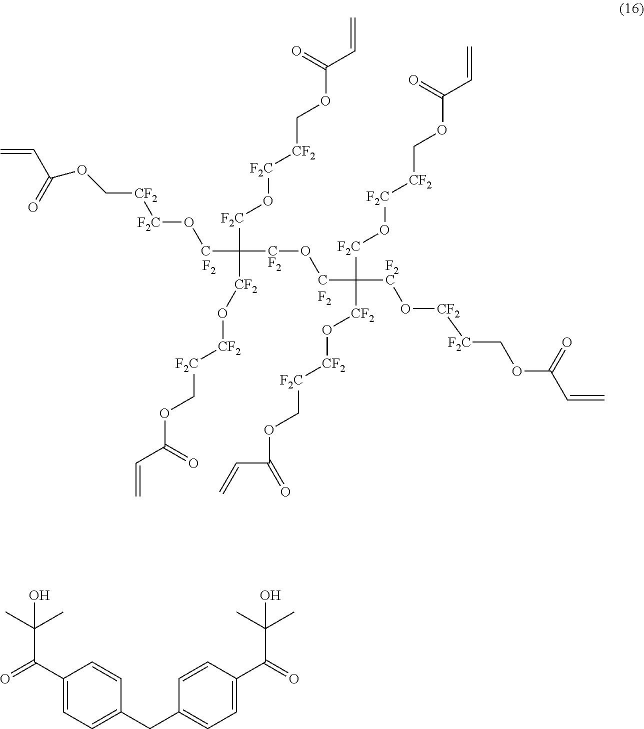

Irg. 127: IRGACURE 127: a compound represented by Formula (16), manufactured by Ciba Specialty Chemicals Inc.

Antifoulant C: Silaplane FM-0725 (a silicone compound represented by the following Formula (24), manufactured by CHISSO CORPORATION, number average molecular weight: 10,000)

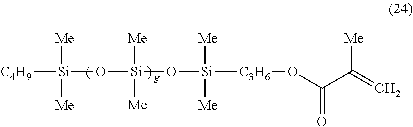

[In Formula (24), g is an integer in which the number average molecular weight becomes 10,000]

Antifoulant D: X-22-164C (Reactive silicone oil, manufactured by Shin-Etsu Chemical Co., Ltd.)

[Formation of Hardcoat Layer and Low Refractive Layer by Coating]

A transparent support 1 having an optically anisotropic layer formed by coating a liquid crystalline compound using a slot die coater as described in FIG. 1 of Japanese Patent Application Laid-Open No. 2003-211052 and wound in a roll shape, was unwound. A coating solution was coated at a flow rate of 13 cc/m² on a surface opposite to the surface on which the optically anisotropic layer was coated, and dried at 25° C. for 15 seconds, then 60° C. for 30 seconds. Further, the coating layer was cured under a nitrogen purge by irradiation with an ultraviolet ray at a dose of 120 mJ/cm² using a 160 W/cm high pressure mercury lamp manufactured by Dr. honle AG to fabricate a hardcoat layer having a film thickness of 10 μm.

Thereafter, the composition LL-1 for a low refractive index layer was wet-coated on the hardcoat layer using a slot die coater as described in FIG. 1 of Japanese Patent Application Laid-Open No. 2003-211052 such that the dry film thickness of the low refractive index layer is 90 nm, dried at 25° C. for 15 seconds, then 60° C. for 30 seconds, and further, irradiated with an ultraviolet ray at a dose of 300 mJ/cm² using a 240 W/cm high pressure mercury lamp (manufactured by Dr. honle AG) at an oxygen concentration of 100 ppm under a nitrogen purge to form a hardcoat layer, and wound on a 168 Φ winding core in a 1000 m roll shape at a tension of 250 N such that the low refractive index layer is disposed outward, thereby fabricating the optical film (101). Coating of each layer is performed in a clean room of Class 100. The in-plane retardation of the optical film (101) was 125 nm.

The optical films (102 to 116) were fabricated in the same manner, except that the composition for a low refractive index layer was changed from LL-1 to LL-2 to 16 in the optical film (101) fabricated.

The optical films (117 to 120) were fabricated in the same manner, except that the composition for a low refractive index layer was changed from LL-1 to LL-2 or LL-4, and the transparent support was TD60UL (manufactured by Fujifilm Corporation, thickness: 60 μm) or TD40UL (manufactured by Fujifilm Corporation, thickness: 40 μm) in the optical film (101) fabricated.

The optical film (121) was fabricated in the same manner, except that an optically anisotropic layer was not formed in the optical film (104) fabricated.

The optical films (122 to 125) were fabricated in the same manner, except that the coating amount of the low refractive index layer was adjusted such that the film thickness of the low refractive index layer was 45 nm, 70 nm, 110 nm or 130 nm in the optical film (101) fabricated.

The optical film (126) was fabricated in the same manner, except that an optically anisotropic layer was not formed in the optical film (101) fabricated.

<Evaluation of Optical Film>

(1) Evaluation of Adhesion Vestige

A roll-shaped optical film was left standing under an environment of 23° C. and 60% for two weeks, approximately 2 m of the outer circumferential portion of the roll-shaped optical film was suspended, and the shape change (=adhesion vestige) of the film was observed by naked eyes under a reflected light.

A: No adhesion vestige.

B: There is adhesive vestige, but a slight shape change.

C: There is adhesive vestige to the extent that the shape change is confirmed at a glance.

D: There is remarkable adhesive vestige, and the deformation becomes more remarkable, or the film is torn during unwinding from the roll shape.

(2) Transfer

A roll-shaped optical film was left standing under an environment of 23° C. and 60% for two weeks, and then, unwound. Approximately 1 m of the winding core portion was observed by naked eyes under a reflected light, and it was confirmed by naked eyes whether the film was changed in color or whitened by transfer.

A: No transfer.

B: Transfer is seen slightly when observed using a reflected light of a fluorescent lamp under a dark room environment.

C: Transfer occurred.

(3) Scratch Resistance

The test was performed by rubbing using a rubbing tester under the following conditions.

Conditions of evaluation environment: 25° C., 60% RH, Rubbing material: Steel wool (manufactured by Nihon Steel Wool Co., Ltd. No. 0000) was wound at the rubbing tip (1 cm×1 cm) of the tester in contact with a sample, and fixed by a band so as not to move.

Moving distance (one-way): 13 cm, Rubbing speed: 13 cm/sec, Loading: 500 g/cm², Tip contact area: 1 cm×1 cm, Rubbing times: reciprocating 10 times.

An oil-based black ink was applied on the rear surface (at a side having an optical anisotropic layer) of the sample after the rubbing was completed, and observed by naked eyes with a reflected light. Abrasion in the rubbed portion was evaluated by the following criteria.

A: No abrasion is seen even though very careful attention was paid.

B: Abrasion is seen slightly when very careful attention was paid.

C: Moderate abrasion is seen, or there is abrasion that is noticed at a glance.

(4) Measurement of Haze

The haze of the optical film was measured by using a hazemeter, MODEL 1001DP (manufactured by NIPPON DENSHOKU INDUSTRIES Co., Ltd.).

(5) Measurement of Reflectance

The transparent support was laminated with an antireflection layer, but not with an optically anisotropic layer, and then, mounted on an integrating sphere (manufactured by JASCO Corporation). The integrating sphere reflectance was measured at a wavelength region of 380 nm to 780 nm, and the reflectance at 450 nm to 650 nm was averaged, thereby evaluating the antireflectivity.

(6-1) Arithmetic Mean Surface Roughness Ra by AMF

With respect to a surface at the side on which an antireflection layer is formed (a side having a hardcoat layer and low refractive index layer), the arithmetic mean surface roughness Ra was calculated as an average of each value determined from an image obtained by measuring five fields-of-view having 10 μm square in a measurement point of 256×256 with an atomic force microscope (AFM: SPI 3800N manufactured by Seiko Instruments Inc.).

(6-2) Arithmetic Mean Surface Roughness Ra in Accordance with JIS B0601

The center-line mean roughness (Ra) of the surface (a side having a hardcoat layer and low refractive index layer) of the sample was measured using Surfcorder MODELSE-3F manufactured by Kosaka Laboratory Ltd., in accordance with JIS-B0601-2001. The measurement was performed under conditions of an evaluation length of 1.25 mm and a cut-off of 0.25 mm.

(7) White Turbidity

An A4-sized sample which suppresses light from being reflected from the rear surface (a side having an optical anisotropic layer) was fabricated by applying an oil-based black ink on the rear surface of the sample. The sample was observed under a sun light by naked eyes in a room whose surrounding is entirely black by shielding all the light, and evaluated by the following criteria.

A: Not recognized that the film surface is whitened even though careful attention was paid

B: Recognized that the film surface is whitened when careful attention was paid, but not bothered.

C: Bothered because the film surface is whitened.

D: Bothered very much because it is recognized that the film surface is whitened at a glance.

The evaluation results in each of the above-mentioned criteria are shown in Table 5.

TABLE 5

| | | | Compo- | | Characteristics | | | Ra in | | | | | | |
|---|---|---|---|---|---|---|---|---|---|---|---|---|---|---|
| | | | sition | | of low refractive | | | accor- | | | | | | |
| | Optically | | for low | | index layer | | | dance | | | | | White | |
| Op- | aniso- | Thick- | refractive | | Re- | Thick- | Ra by | with JIS | | | Scratch | | turbidity | |
| tical | tropic | ness of | index | Re- | fractive | ness | AFM | B0601 | Adhesion | | resis- | | of coating | |
| film | layer | support | layer | flectance | index | [nm] | [nm] | [μm] | vestige | Transfer | tance | Haze | film | Remark |
| 101 | A | 80 μm | LL-1 | 1.52% | 1.381 | 90 | 2.8 | 0.018 | B | B | B | 0.20% | B | Ex. |
| 102 | A | 80 μm | LL-2 | 1.53% | 1.383 | 90 | 4.5 | 0.018 | A | A | B | 0.25% | C | Ex. |
| 103 | A | 80 μm | LL-3 | 1.51% | 1.38 | 90 | 1.8 | 0.018 | C | B | B | 0.20% | B | Comp. |
| | | | | | | | | | | | | | | Ex. |
| 104 | A | 80 μm | LL-4 | 1.51% | 1.38 | 90 | 1.8 | 0.018 | C | B | B | 0.20% | B | Comp. |
| | | | | | | | | | | | | | | Ex. |
| 105 | A | 80 μm | LL-5 | 1.60% | 1.386 | 90 | 6.2 | 0.019 | A | A | C | 1.10% | D | Comp. |
| | | | | | | | | | | | | | | Ex. |
| 106 | A | 80 μm | LL-6 | 1.53% | 1.383 | 90 | 7.2 | 0.021 | A | B | C | 1.30% | D | Comp. |
| | | | | | | | | | | | | | | Ex. |
| 107 | A | 80 μm | LL-7 | 1.53% | 1.383 | 90 | 1.7 | 0.018 | C | B | B | 0.20% | B | Comp. |
| | | | | | | | | | | | | | | Ex. |
| 108 | A | 80 μm | LL-8 | 2.16% | 1.42 | 90 | 4.1 | 0.018 | A | A | A | 0.20% | C | Ex. |
| 109 | A | 80 μm | LL-9 | 2.16% | 1.42 | 90 | 4.1 | 0.018 | A | A | A | 0.20% | C | Ex. |
| 110 | A | 80 μm | LL-10 | 3.12% | 1.468 | 90 | 2.3 | 0.018 | B | B | A | 0.20% | B | Comp. |
| | | | | | | | | | | | | | | Ex. |
| 111 | A | 80 μm | LL-11 | 3.83% | 1.499 | 90 | 1.9 | 0.018 | B | B | A | 0.20% | B | Comp. |
| | | | | | | | | | | | | | | Ex. |
| 112 | A | 80 μm | LL-12 | 1.27% | 1.362 | 90 | 4.6 | 0.018 | A | A | B | 0.30% | C | Ex. |
| 113 | A | 80 μm | LL-13 | 1.52% | 1.381 | 90 | 4.2 | 0.018 | A | A | B | 0.25% | C | Ex. |
| 114 | A | 80 μm | LL-14 | 1.54% | 1.382 | 90 | 2.6 | 0.018 | A | A | A | 0.20% | A | Ex. |
| 115 | A | 80 μm | LL-15 | 1.54% | 1.382 | 90 | 2.6 | 0.018 | A | A | A | 0.20% | A | Ex. |
| 116 | A | 80 urn | LL-16 | 1.54% | 1.382 | 90 | 2.6 | 0.018 | A | A | A | 0.20% | A | Ex. |
| 117 | A | 60 μm | LL-2 | 1.53% | 1.383 | 90 | 4.5 | 0.018 | A | A | B | 0.25% | C | Ex. |
| 118 | A | 40 μm | LL-2 | 1.53% | 1.383 | 90 | 4.5 | 0.018 | A | A | B | 0.25% | C | Ex. |
| 119 | A | 60 μm | LL-4 | 1.51% | 1.38 | 90 | 1.8 | 0.018 | D | B | B | 0.20% | B | Comp. |
| | | | | | | | | | | | | | | Ex. |
| 120 | A | 40 μm | LL-4 | 1.51% | 1.38 | 90 | 1.8 | 0.018 | D | B | B | 0.20% | B | Comp. |
| | | | | | | | | | | | | | | Ex. |
| 121 | None | 80 μm | LL-4 | 1.51% | 1.38 | 90 | 1.8 | 0.018 | B | B | B | 0.20% | B | Comp. |
| | | | | | | | | | | | | | | Ex. |
| 122 | A | 80 μm | LL-1 | 3.16% | 1.381 | 45 | 7.4 | 0.022 | A | C | C | 0.40% | D | Comp. |
| | | | | | | | | | | | | | | Ex. |
| 123 | A | 80 μm | LL-1 | 2.03% | 1.381 | 70 | 3.8 | 0.018 | B | B | B | 0.20% | B | Ex. |
| 124 | A | 80 μm | LL-1 | 1.60% | 1.381 | 110 | 2.2 | 0.018 | B | B | B | 0.20% | B | Ex. |
| 125 | A | 80 μm | LL-1 | 2.19% | 1.381 | 130 | 1.4 | 0.018 | C | B | B | 0.20% | A | Comp. |
| | | | | | | | | | | | | | | Ex. |
| 126 | A | 80 μm | — | 4.47% | — | — | 1.5 | 0.018 | C | B | A | 0.20% | A | Comp. |
| | | | | | | | | | | | | | | Ex. |
| 201 | B | 80 μm | LL-1 | 1.52% | 1.381 | 90 | 2.8 | 0.018 | A | B | B | 0.20% | B | Ex. |
| 301 | C | 80 μm | LL-1 | 1.52% | 1.381 | 90 | 2.8 | 0.018 | A | B | B | 0.20% | B | Ex. |
| 401 | D | 80 μm | LL-1 | 1.52% | 1.381 | 90 | 2.8 | 0.018 | B | B | B | 0.20% | B | Ex. |

As seen clearly from the results in Table 5, it is understood that in all the optical film (103 and 104) in which the content of the particles (particles B) having the largest average particle size deviates from the range of 1.5% by mass to 15% by mass, or are not contained at all in the low refractive index layer, adhesion vestige occurs. Further, it is understood that in the optical film (105) in which the content of the particles is greater than 15% by mass, the adhesion vestige becomes better, but the scratch resistance and the white turbidity of the coating film deteriorate, and the haze worsens as well. It is understood that in the film (106) in which the average particle size of the inorganic fine particles B is greater than 130 nm, the scratch resistance and the white turbidity of the coating film deteriorate, and the haze worsens as well. It is understood that in the film (107) in which the average particle size of the inorganic fine particles B is smaller than 65 nm, adhesion vestige occurs.

Further, it is understood that the optical film (110) in which the average particle size of the inorganic fine particles is smaller than 30 nm has a refractive index of greater than 1.45 and high reflectance. It is understood that the optical film (111) does not satisfy the refractive index for the low refractive index layer because the refractive index exceeds 1.45, and has high reflectance. It is understood that even in the optical films (119 and 120) which do not contain the inorganic fin particles B, adhesion vestige occurs. Further, in the optical film (121) which dose not have an optically anisotropic layer on a surface opposite to the surface having the hardcoat layer of the transparent support, adhesion vestige does not occur, and the scratch resistance and the like are good, but unless the optical film has an optically anisotropic layer on a surface opposite to the surface having the hardcoat layer of the transparent support, a thin film type polarizing plate suitable for thinning a stereoscopic image display device cannot be formed. Further, it is understood that in the optical film (122) in which the film thickness of the low refractive index layer is less than 50 nm, transfer occurs, and the scratch resistance worsens. Further, it is understood that in the optical film (125) in which the film thickness of the low refractive index layer exceeds 120 nm and the optical film (126) not having the low refractive index layer of the present invention, adhesion vestige occurs.

Meanwhile, it is understood that optical films (101, 102, 108, 109, 112 to 118, 123 and 124) in which the refractive index of the low refractive index layer is 1.20 to 1.45, the film thickness is 50 to 120 nm, the average particle size of the inorganic fine particles A is 30 nm to 65 nm, the content of the particles having the largest average particle size in the low refractive index layer (inorganic fine particles B) is 1.5% by mass to 15% by mass based on the solid, and Ra is 0.030 μm or less, have no adhesion vestige and transfer, have excellent scratch resistance, and less haze and whitening of the coating film. Specifically, it is understood that the optical films (114 to 116) in which a specific fluorine-containing monomer is used in combination with inorganic fine particles having a specific size, are excellent in all the above-mentioned performances.

[Fabrication of Polarizing Plate and Image Display Device]

A polyvinyl alcohol film having a thickness of 80 μm in a roll shape was continuously stretched 5-fold in an aqueous iodine solution, and dried to obtain a polarizing film having a thickness of 20 μm. By using a 3% by mass aqueous solution of polyvinyl alcohol (PVA-117H manufactured by Kuraray Co. Ltd.) as an adhesive, a phase difference film for VA (manufactured by Fujifilm Co., Ltd., Re/Rth at wavelength of 550 nm=50/125) subjected to alkali saponification treatment was prepared, and a polarizing film was adhered such that the saponification-treated surface is disposed at the polarizing film side. Further, a polarizing plate was prepared by attaching the optically anisotropic layer of the optical film through an adhesive to the polarizing film side. At this time, the angle between the slow axis of the optical film and the transmission axis of the polarizer was set to be 45°.

Likewise, instead of the optical film, TD80UL (manufactured by Fujifilm Corporation) was attached through an adhesive to the polarizing film side of the polarizing plate having the prepared VA phase difference film.

(Mounting)

TV: A polarizing plate on the viewing side of a TV (UN46C7000 (3D-TV) manufactured by SAMSUNG Corporation) was peeled off, and the phase difference film for VA of the polarizing plate fabricated above was adhered on the LC cell with an adhesive to manufacture a stereoscopic display device.

LC shutter spectacles: A polarizing plate of SSG-2100AB (LC shutter spectacles) manufactured by SAMSUNG Corporation on the side opposite to the eye (panel side) was peeled off, and the support side of the optical film fabricated above was adhered thereon with an adhesive to prepare LC shutter spectacles. Here, the slow axis of the optical film adhered on the spectacles was set to be orthogonal to the slow axis of the optical film included in the polarizing plate adhered on the TV.

(Evaluation of Display Device)

A 3D image was viewed while the LC shutter spectacles fabricated above were worn in a room with a fluorescent lamp under an environment that illuminance on the panel surface was approximately 200 lux. 3D-TVs including the optical film of the present invention had little crosstalk (double image) when viewed with the face inclined or when viewed from an inclined direction, and also had little change in display tint. Further, it was possible to obtain a low reflective screen and an impression having an excellent stereoscopic effect in which black did not fade to be hazy and the contrast was high. On the contrary, 3D-TVs using a commonly used TAC film (TD80UL) had much crosstalk or change in display tint, compared to those including the optical film of the present invention, and crosstalk was shown remarkably even when viewed with the face slightly inclined. Further, since black faded to be hazy, the stereoscopic effect was insufficient.

### <Fabrication of Optical Film (201) Having Another Optically Anisotropic Layer>

Instead of coating the optically anisotropic layer coating solution (A) in the optical film (101) fabricated above, the optically anisotropic layer coating solution (B) containing a discotic liquid crystal compound having the following composition was continuously coated on the alignment film fabricated above by using a wire bar #2.7. The conveying speed (V) of the film was set to 36 m/min. For the drying of the solvent of the coating solution and the alignment aging of the discotic liquid crystal compound, the film was heated with warm air at 80° C. for 90 seconds. Subsequently, the film was irradiated with UV light at 80° C. to fix the alignment of the liquid crystal compound to form an optically anisotropic layer having a thickness of 1 μm, which was wound in a roll shape to fabricate a transparent support having an optically anisotropic layer. Thereafter, a hardcoat layer and a low refractive index layer were laminated in the same as in Example 1 to fabricate an optical film (201). The in-plane retardation of the optical film (201) was 145 nm.

Composition of Optically Anisotropic Layer Coating Solution (B)

| | | |
|---|---|---|
| The following discotic liquid crystal compound | 100 | parts by mass |
| Photopolymerization initiator | 3 | parts by mass |
| (Irgacure 907, manufactured by Ciba-Geigy Corporation) | | |
| Sensitizer | 1 | part by mass |
| (KAYACURE DETX, manufactured by Nippon Kayaku Co., Ltd.) | | |
| The following pyridinium salt | 1 | part by mass |
| The following fluorine-based polymer (FP2) | 0.4 | parts by mass |
| Methyl ethyl ketone | 252 | parts by mass |

Discotic liquid crystalline compound 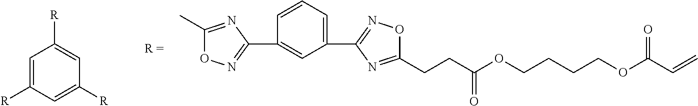
Pyridinium salt 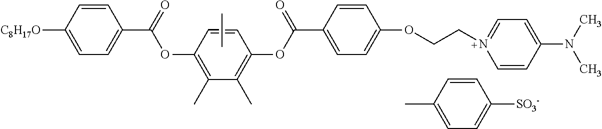
Fluroine-based polymer (FP2)

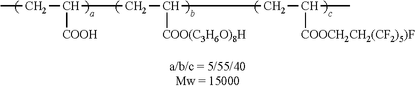

In the formula, a/b/c=5/55/40 is a mass ratio.

<Fabrication of Optical Film (301) Having a Different Optically Anisotropic Layer>

Instead of coating the optically anisotropic layer coating solution (B) in the optical film (201) fabricated above, the optically anisotropic layer coating solution (C) containing a discotic liquid crystal compound having the following composition was continuously coated on the alignment film fabricated above by using a wire bar #3.0.

The conveying speed (V) of the film was set to 36 m/min. For the drying of the solvent of the coating solution and the alignment aging of the discotic liquid crystal compound, the film was heated with warm air at 80° C. for 90 seconds. Subsequently, the film was irradiated with UV light at 80° C. to fix the alignment of the liquid crystal compound to form an optically anisotropic layer having a thickness of 1.1 μm, which was wound in a roll shape to fabricate a transparent support having an optically anisotropic layer. Thereafter, an optically anisotropic layer was formed in the same manner as in Example 1, and then, a hardcoat layer and a low refractive index layer were laminated to fabricate an optical film (301). The in-plane retardation of the optical film (301) was 135 nm.

Meanwhile, among the materials used in the optically anisotropic layer coating solution (C), the materials other than the acrylate monomer are the same as those used in the optically anisotropic layer coating solution (B), and the acrylate monomer is the same as that used in the optically anisotropic layer coating solution (A).

Composition of Coating Solution (C) for Optically Anisotropic Layer

| | | |
|---|---|---|
| The above discotic liquid crystal compound | 97 | parts by mass |
| Acrylate monomer | 3 | parts by mass |
| Photopolymerization initiator (Irgacure 907, | 3 | parts by mass |
| manufactured by Ciba-Geigy Corporation) | | |
| Sensitizer (KAYACURE DETX, manufactured | 1 | part by mass |
| by Nippon Kayaku Co., Ltd.) | | |
| The above pyridinium salt | 1 | part by mass |
| The above fluorine-based polymer (FP2) | 0.4 | parts by mass |
| Methyl ethyl ketone | 252 | parts by mass |

<Fabrication of Optical Film (401) Having a Different Optically Anisotropic Layer>

Instead of coating the optically anisotropic layer coating solution (B) in the optical film (201) fabricated above, the optically anisotropic layer coating solution (D) containing a discotic liquid crystal compound having the following composition was continuously coated on the alignment film fabricated above by using a wire bar #3.3.

The conveying speed (V) of the film was set to 36 m/min. For the drying of the solvent of the coating solution and the alignment aging of the discotic liquid crystal compound, the film was heated with warm air at 80° C. for 90 seconds. Subsequently, the film was irradiated with UV light at 80° C. to fix the alignment of the liquid crystal compound to form an optically anisotropic layer having a thickness of 1.2 μm, which was wound in a roll shape to fabricate a transparent support having an optically anisotropic layer. Thereafter, a hardcoat layer and a low refractive index layer were laminated in the same manner as in Example 1 to fabricate an optical film (401). The in-plane retardation of the optical film (401) was 125 nm.

Meanwhile, the materials used in the optically anisotropic layer coating solution (D) are the same as those used in the optically anisotropic layer coating solution (C).

Composition of Coating Solution (D) for Optically Anisotropic Layer

| | | |
|---|---|---|
| The above discotic liquid crystal compound | 91 | parts by mass |
| Acrylate monomer | 5 | parts by mass |
| Photopolymerization initiator (Irgacure 907, | 3 | parts by mass |
| manufactured by Ciba-Geigy Corporation) | | |
| Sensitizer (KAYACURE DETX, manufactured | 1 | part by mass |
| by Nippon Kayaku Co., Ltd.) | | |
| The above pyridinium salt | 1 | part by mass |
| The above fluorine-based polymer (FP2) | 0.4 | parts by mass |
| Methyl ethyl ketone | 252 | parts by mass |

The optical films (201, 301 and 401) fabricated above were evaluated in the same manner as Examples. The evaluation results are shown in Table 5.

Almost the same results as in Examples were obtained. In addition, the polymerizable compound using an acrylate monomer in an amount of 97% or more had more excellent adhesive property.

Further, a polarizing plate was fabricated in the same manner as in Examples with the optical films (201, 301 and 401), and attached to a 3D-TV. A 3D image was viewed while the LC shutter spectacles fabricated above were worn. The 3D-TV including the optical film of the present invention had little crosstalk (double image) when viewed with the face inclined or when viewed from an inclined direction, and also had little change in display tint.

<Preparation of Composition (B) for a Hardcoat Layer>

The following composition was introduced into a mixing tank, stirred and filtered by a filter of polypropylene having a pore size of 0.4 μm to obtain a composition (B) for a hardcoat layer (solid concentration: 58% by mass).

| | |
|---|---|
| Dimethyl carbonayte | 29.0 parts by mass |
| Methyl ethyl ketone | 43.4 parts by mass |
| (a) Monomer: A-400 | 9.0 parts by mass |
| (b) Monomer: A-TMMT | 78.0 parts by mass |
| The above compound IP-9 | 10.0 parts by mass |
| Photopolymerization initiator (Irgacure 184, | 3.0 parts by mass |
| manufactured by Ciba Specialty Chemicals Inc.) | |
| The above leveling agent (SP-13) | 0.02 parts by mass |

Each of the compounds uses are shown below.

A-400: manufactured by Shin-Nakamura Chemical Co., Ltd. The number of functional groups in one molecule is 2.

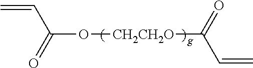

Average molecular weight 538

A-TMMT: NK ester manufactured by Shin-Nakamura Chemical Co., Ltd. The mass average molecular weight is 304, and the number of functional groups in one molecule is 4.

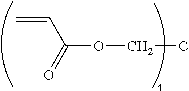

<Fabrication of Optical Film Having Another Hardcoat Layer>

A hardcoat layer was formed in the same manner as the optical films (101 to 126), except that, in the optical films (101 to 126) fabricated in Example 1, after forming an optically anisotropic layer, a composition (B) for a hardcoat layer was coated instead of the composition (B) for a hardcoat layer. Thereafter, a low refractive index layer was laminated in the same manner as in Example 1 to fabricate optical films (501 to 526). The in-plane retardations of the optical films (501 to 526) were all the same as those of the optical films (101 to 126).

Next, an embodiment having an optically anisotropic layer in which a pattern is formed is explained in below while pointing out an optically anisotropic layer having a photo-radical-curable alignment film, which in a pattern is formed.

### [Coating of Hardcoat Layer and Low Refractive Index Layer]

FUJITAC TD60 (manufactured by FUJIFILM Corporation, width is 1340 mm and thickness is 60 μm) was wound from a roll form, and the above coating solution for forming hardcoat layer was acted thereon in a flow amount of 13 cc/m² with a slot dicoater disclosed in FIG. 1 of JP-A-2003-211052, and dried at 25° C. for 15 seconds and 60° C. for 30 seconds. Then, the coated layer was cured by irradiating ultraviolet in irradiating amount of 120 mJ/cm² with a high pressure mercury lamp at 160 W/cm (manufactured by Dr. Honle AG Company) under a nitrogen purge to form a hardcoat layer with a thickness of 10 p.m.

Then, the composition for low refractive index layer LL-15 was wet-coated on the hardcoat layer with the slot dicoater disclosed in FIG. 1 of JP-A-2003-211052 such that a film formed by drying the composition for low refractive index layer was 90 nm, followed by drying at 25° C. for 15 seconds and at 60° C. for 30 seconds. Thereafter, ultraviolet was irradiating thereto in irradiating amount of 300 mJ/cm² with a high pressure mercury lamp at 240 W/cm (manufactured by Dr. Honle AG Company) under oxygen concentration of 100 ppm by a nitrogen purge to form a low refractive index layer. The obtained laminate was wound to a center core having a diameter of 168 mm by tension of 250 N in a roll form with 1000 m such that one side of the laminate while making the low refractive index layer outside.

In reference to the paragraph [0193] of US 2012/0076954 A1, a polymerization reaction of 5-norbornene-2-methyl-(4-methoxycinnamate) was performed, polynorbornene (Weight average molecular weight (Mw): 150,000) having the cinnamate group represented by the following chemical formula was obtained.

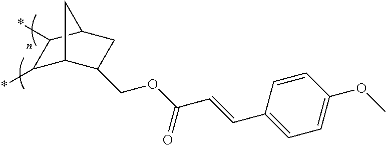

<Formulation of Composition for Alignment Film Containing Polynorbornene>

| | |
|---|---|
| Polynorbornene having a cinnamate group represented by | 20.0 g |
| the above chemical formula | |
| Pentaerythritol acrylate | 10.0 g |
| IRGACURE 907 | 5.0 g |
| Cyclohexanone | 980.0 g |

An alignment film containing the polynorbornene was formed on a surface of the above laminate, the surface on which the hardcoat layer is not formed, by using the above composition for alignment film containing polynorbornene in reference to the examples of JP-T-2012-517024. The thickness of the alignment film after drying was 1000 Å.

A pattern mask (100 mm×100 mm) that a pattern of an optical transparent region whose width is 500 μm and a pattern an optical blocking region was alternately arranged in up and down, and right to left was positioned on or above the alignment film containing the polynorbornene.

A UV polarization film having two regions capable of transmitting different polarization respectively was positioned on the pattern mask so as to be parallel to a movement direction of the film. Then, ultraviolet was continuously irradiated for 30 seconds in irradiation intensity of 300 mW/cm² from the above the UV polarization film while moving the transparent support to the movement direction by 3 m/minute so as to obtain an alignment film having a first alignment region and a second alignment region, where alignment directions of the polymers of the first and second alignment region were different from each other, and the first and second alignment region were alternately arranged along the longitudinal direction of the transparent support.

On the above alignment film, JC242™ (manufactured by BASF) as a crystalline compound was coated to be a thickness after drying of about 1 μm, followed by irradiating ultraviolet for 10 seconds in irradiation intensity of 300 mW/cm² to form a phase difference film by curing the crystalline compound, and then an optical film 601 was obtained, the optical film in which an optical axis of the crystalline compound of the first alignment region and an optical axis of the crystalline compound of the second alignment region were different from each other.

<Evaluation of Optical Film 601>

The optical film 601 was evaluated in the same manner of the optical film 115. The evaluations are shown as the followings.

Reflectance: 1.54%

Adhesion vestige: A

Transfer: A

Scratch resistance: A

Haze: 0.20%

White turbidity of coating film: A

The above results clarifies that it can be obtained a similar advantageous to the case of the optically anisotropic layer having a certain phase difference even if the optically anisotropic layer according to the present invention has a pattern form.

While the present invention has been shown and described with reference to certain exemplary embodiments thereof, it will be understood by those skilled in the art that various changes modifications may be made therein without departing from the spirit and scope of the present invention as defined by the appended claims.

1. An optical film comprising:
a transparent support;
an optically anisotropic layer formed from a curable resin composition on the outermost surface at one side of the transparent support;
a hardcoat layer; and
a low refractive index layer,
wherein
the hardcoat layer and the low refractive index layer are provided at the other side of the transparent support,
the transparent support, the hardcoat layer, and the low refractive index layer are positioned in this order,
the low refractive index layer has a refractive index of 1.20 to 1.40 and average film thickness of 50 nm to 120 nm,
the low refractive index layer contains an organic fine particles A having an average particle size of 30 nm to 65 nm, an organic fine particles B having an average particle size of more than 65 nm and 130 nm or less and a binder,
a content of the inorganic fine particles B is 1.5% by mass to 15% by mass based on the total solid of the low refractive index layer, and
arithmetic mean roughness Ra of the optical film surface at a side having the low refractive index layer is 0.030 μm or less as measured in accordance with JIS B0601-2001.

2. The optical film according to claim 1,
wherein the content of the inorganic fine particles B is 3.0% by mass to 10% by mass based on the total solid of the low refractive index layer.

3. The optical film according to claim 1,
wherein an average particle size of the inorganic fine particles B is 70 nm to 100 nm.

4. The optical film according to claim 1,
wherein the inorganic fine particles B are silica particles.

5. The optical film according to claim 1,
wherein the inorganic fine particles A are hollow silica particles.

6. The optical film according to claim 1,
wherein an average particle size of the inorganic fine particles A is 40 nm to 60 nm.

7. The optical film according to claim 1,
wherein the arithmetic mean surface roughness Ra of the optical film surface at the side having the low refractive index layer is 2 nm to 6 nm as measured by an atomic force microscope.

8. The optical film according to claim 1,
wherein the arithmetic mean roughness Ra of the optical film surface at the side having the low refractive index layer is 2.5 nm to 4 nm as measured by an atomic force microscope.

9. The optical film according to claim 1,
wherein at least one kind of the binder contained in the low refractive index layer is a fluorine containing polyfunctional monomer represented by the following Formula (I): 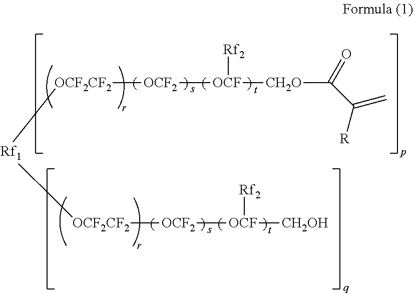
wherein Rf₁ represents a (p+q)-valent perfluoro saturated hydrocarbon group which may have an ether bond,
Rf₂ represents a chained or cyclic monovalent fluorohydrocarbon group which at least contains a carbon atom and a fluorine atom, and may contain an oxygen atom or a hydrogen atom,
p represents an integer of 3 to 10, q represents an integer of 0 to 7, and (p+q) represents an integer of 3 to 10,
r represents an integer of 0 to 100, and each of s and t represents 0 or 1,
R represents a hydrogen atom, a methyl group or a fluorine atom, and
an arrangement order of (OCF₂CF₂), (OCF₂), and (OCFRf₂) is not particularly limited.

10. The optical film according to claim 1,
wherein an in-plain retardation of the optical film at 550 nm is 80 nm to 200 nm.

11. The optical film according to claim 1,
wherein the optically anisotropic layer is formed from a composition containing a liquid crystalline compound.

12. The optical film according to claim 11,
wherein the liquid crystalline compound is a discotic liquid crystalline compound.

13. The optical film according to claim 11,
wherein a solid content of the liquid crystalline compound in the composition is 93% by mass or more.

14. The optical film according to claim 1,
wherein the optical film is in a shape of a long roll, and
a slow axis of an in-plane retardation is inclined clockwise or anti-clockwise at 5° to 85° with respect to a longitudinal direction of the optical film.

15. A polarizing plate comprising:
at least one protective film; and
a polarizing film,
wherein the at least one protective film is the optical film according to claim 1, and
a surface of the optical film at a side having the optically anisotropic layer and the polarizing film are bonded.

16. An image display device comprising at least one of the optical film according to claim 1.

17. An image display device comprising the polarizing plate according to claim 15.

18. A liquid crystal display device comprising;
the optical film according to claim 1;
a polarizing film;
and a liquid crystal cell in this order from a viewing side,
wherein the optical film is disposed such that the low refractive index layer is at the viewing side and the optically anisotropic layer is at the polarizing film side.
